(19) United States
(12) Patent Application Publication
(10) Pub. No.: US 2022/0196312 A1
(43) Pub. Date: Jun. 23, 2022

(54) REFRIGERATOR

(71) Applicant: WINIA ELECTRONICS CO., LTD., Gwangju (KR)

(72) Inventors: Chang-Min KIM, Gwangju (KR); Sung-Ik CHANG, Gwangju (KR)

(73) Assignee: WINIA ELECTRONICS CO., LTD., Gwangju (KR)

(21) Appl. No.: 17/603,784

(22) PCT Filed: Oct. 16, 2019
(86) PCT No.: PCT/KR2019/013562

§ 371 Date: Jan. 20, 2022

(30) Foreign Application Priority Data
Sep. 3, 2019 (KR) 10-2019-0109202
Sep. 3, 2019 (KR) 10-2019-0109203
Sep. 3, 2019 (KR) 10-2019-0109206

(51) Int. Cl. F25D 11/02; F25D 23/06

(52) U.S. Cl. CPC F25D 11/02; F25C 2400/10; F25D 2201/12; F25D 23/06

(57) ABSTRACT

The present invention relates to a refrigerator and, in particular, to a refrigerator characterized by comprising: a main body including an outer case and an inner case provided inside the outer case so as to provide an ice-making chamber and a refrigerating chamber in the upper part and a freezing chamber in the lower part; and a partition wall coupled to the inner case so as to form the ice-making chamber, wherein a bead portion is formed in the inner case, and a concave portion fitting the bead portion is formed in the partition wall, and thus, the assembly position of the partition wall coupled to the inner case can be more easily identified and set through the fitting of the bead portion and the concave portion.

### TECHNICAL FIELD

The present disclosure relates to a refrigerator, and more particularly to a refrigerator capable of more easily grasping and setting an assembly position of a partition wall coupled to an inner case through matching between a bead portion and a concave portion.

### BACKGROUND ART

In general, a refrigerator is a home appliance for storing food in a refrigerated or frozen state in a storage compartment opened and closed by a door. The refrigerator generally includes a refrigerator compartment for storing food in a refrigerated state at a low temperature and a freezer compartment for freezing and storing food in a frozen state.

The refrigerator may additionally include an ice making compartment that creates and stores ice for the convenience of a user, and a dispenser may also be provided to the refrigerator so that the user can take the ice stored in the ice making compartment out of the refrigerator. [4] Refrigerators that have been recently released have a tendency to provide a refrigerator compartment, that is used relatively more frequently than a freezer compartment, at an upper part of a main body and to provide the freezer compartment, that is used relatively less than the refrigerator compartment, at a lower part of the main body. In particular, French door refrigerators, in which a refrigerator compartment is opened and closed by two pivot doors that are respectively hinged and coupled to the left and right sides of a main body and are arranged side by side from left to right, and a freezer compartment is opened and closed by a drawer door slidably installed, have been recently in the spotlight.

Wall bodies are coupled to form the ice making compartment in the refrigerator, and a related art related to this is disclosed in Korean Patent Application Publication No. 10-2016-0085638.

A related art refrigerator includes a main body, a storage compartment that is formed inside the main body to store food, an ice making compartment that is formed at one corner of an upper part of the storage compartment to generate ice, and a cold air supply device that generates a cold air and supplies the cold air to the storage compartment and the ice making compartment. The main body includes an inner case forming the storage compartment and the ice making compartment therein, an outer case that is coupled to the outside of the inner case and forms an appearance of the refrigerator, and a thermal insulation member that is provided between the inner case and the outer case and thermally insulates the storage compartment and the ice making compartment. A front wall, a side wall, and a bottom wall of the ice making compartment may be integrally formed, and an inner thermal insulation material for thermally insulating the ice making compartment may be provided inside each of the front wall, the side wall, and the bottom wall of the ice making compartment. In the related art refrigerator, the side wall and the bottom wall of the ice making compartment are generally mounted on the main body through a mounting means, and thus is installed detachably.

However, the related art refrigerator has a problem in that it is not easy to grasp and set an accurate assembly position of the side wall and the bottom wall of the ice making compartment with respect to the main body.

The related art refrigerator also has a problem in that a thermal insulation ability of the ice making compartment may be deteriorated due to a joint, as the front wall, the side wall, and the bottom wall of the ice making compartment are assembled to the inside of the main body.

### PRIOR ART DOCUMENT

(Patent Document 0001) Korean Patent Application Publication No. 10-2016-0085638

### DISCLOSURE

### Technical Problem

An object of the present disclosure is to address the above-described and other problems. Another object of the present disclosure is to provide a refrigerator capable of more easily grasping and setting an assembly position of a partition wall coupled to an inner case through matching between a bead portion and a concave portion.

### Technical Solution

In order to achieve the above-described and other objects, in one aspect of the present disclosure, there is provided a refrigerator comprising a main body including an outer case and an inner case provided inside the outer case, wherein an upper part of the inner case provides an ice making compartment and a refrigerator compartment, and a lower part of the inner case provides a freezer compartment; and a partition wall coupled to the inner case and configured to form the ice making compartment, wherein a bead portion is formed in the inner case, and wherein a concave portion matched with the bead portion is formed on the partition wall.

The bead portion includes a first bead portion formed on one side of an inner surface of the inner case and a second bead portion formed on other side of the inner surface of the inner case. The concave portion includes a first concave portion formed on one side of the partition wall and a second concave portion formed on other side of the partition wall. The first concave portion is matched with the first bead portion, and the second concave portion is matched with the second bead portion.

A first protrusion having a first through hole is formed on one of the first bead portion and the first concave portion, and a first inlet port into which the first protrusion is inserted is formed on the other. A second protrusion having a second through hole is formed on one of the second bead portion and the second concave portion, and a second inlet port into which the second protrusion is inserted is formed on the other.

A space portion is provided between the outer case and the inner case. A thermal insulation material accommodating space is provided inside the partition wall. A thermal insulation material is injected into the space portion, is injected into the thermal insulation material accommodating space through the first inlet port and the first through hole, and is injected into the thermal insulation material accommodating space through the second inlet port and the second through hole.

The thermal insulation material is integrally foamed in the space portion and the thermal insulation material accommodating space such that the ice making compartment is partitioned as a separate thermal insulation space from the refrigerator compartment.

The refrigerator further comprises an entrance wall fitted and coupled to a front side of the partition wall; and an installation wall fitted and coupled to one side and other side of the partition wall and the entrance wall. The partition wall, the entrance wall, and the installation wall that are fitted and coupled to each other are fastened to each other by a fastening member, and then are fastened to one wall and other wall of the inner case by a fastening member.

The partition wall includes an outer partition wall and an inner partition wall. The outer partition wall and the inner partition wall are fitted and coupled to constitute the partition wall.

When the second bead portion and the second concave portion are matched, one side of the installation wall is interposed between the second bead portion and the second concave portion.

The refrigerator further comprises an entrance wall disposed between the outer partition wall and the inner partition wall; a first sealing member disposed along a front inner perimeter of the outer partition wall; and a second sealing member disposed on an inner surface of a rear right side of the outer partition wall to elongate in an up-down direction. The partition wall includes the outer partition wall and the inner partition wall. The inner partition wall is coupled to the outer partition wall in a state in which a front end and a rear end of the inner partition wall are in close contact with the first sealing member and the second sealing member. The entrance wall is coupled to the outer partition wall in a state in which a rear end of the entrance wall is in close contact with the first sealing member.

An installation wall is further coupled to the partition wall. The refrigerator further comprises a third sealing member that is disposed on and attached to an upper surface of the installation wall, an upper surface of the partition wall, a rear surface of the partition wall, and a left side surface of the installation wall.

The third sealing member is disposed in a state of being interposed between the partition wall and the inner case and between the installation wall and the inner case and is in close contact with an upper wall inner surface, a rear wall inner surface, and a left wall inner surface of the inner case to thereby seal a contact joint between the partition wall, the installation wall, and the inner case that are coupled to each other.

The first sealing member, the second sealing member, and the third sealing member are made of a sponge.

### Advantageous Effects

A refrigerator according to the present disclosure has the following advantages.

A refrigerator according to the present disclosure has an advantage of more easily grasping and setting an assembly position of a partition wall coupled to an inner case through matching between a bead portion and a concave portion.

A refrigerator according to the present disclosure has an advantage of improving a thermal insulation capability of an ice making compartment since a joint between a main body and a partition wall is removed by integrally foaming a thermal insulation material injected into a space portion of the main body and a thermal insulation material accommodating space of the partition wall after matching between a bead portion and a concave portion.

A refrigerator according to the present disclosure has an advantage of easily performing a foaming process by integrally foaming a plurality of walls constituting an ice making compartment.

A refrigerator according to the present disclosure has an advantage of fixing more firmly a main body and a partition wall by integrally foaming a thermal insulation material in a state where a protrusion is inserted into an inlet port and attaching the foamed thermal insulation material to the protrusion.

A refrigerator according to the present disclosure has an advantage in that a partition wall is inseparably fixed to a main body by doubly fixing the partition wall to the main body through fastening using a fastening member and integral foaming of a thermal insulation material.

A refrigerator according to the present disclosure has an advantage in that a partition wall fixed to a main body does not shake and the partition wall is not detached even under a strong external force.

A refrigerator according to the present disclosure has an advantage of preventing a leakage of a cold air in an ice making compartment by sealing a contact joint between an outer partition wall, an inner partition wall, an entrance wall, and an installation wall.

A refrigerator according to the present disclosure has an advantage of preventing a leakage of a cold air in an ice making compartment by sealing a contact joint between an inner case and an outer partition wall, an inner partition wall, and an installation wall that are coupled to each other.

### DESCRIPTION OF DRAWINGS

FIG. 1 is a perspective view illustrating a refrigerator according to an embodiment of the present disclosure.

FIG. 2 is a perspective view illustrating a state in which a pivot door of a refrigerator according to an embodiment of the present disclosure is open.

FIG. 3 is a rear perspective view illustrating a pivot door of a refrigerator according to an embodiment of the present disclosure.

FIG. 4 is a rear perspective view illustrating a state in which a door pocket of FIG. 3 is separated.

FIG. 5 is a cross-sectional view taken along A-A of FIG. 3.

FIG. 6 is a horizontal cross-sectional view illustrating a state in which a catching member is separated in a door of a refrigerator according to an embodiment of the present disclosure.

FIG. 7 is a perspective view illustrating a state in which a drawer door is pulled out from an inner case of a refrigerator according to an embodiment of the present disclosure.

FIG. 8 is an exploded rear perspective view of FIG. 7.

FIG. 9 is a perspective view illustrating a basket of a refrigerator according to an embodiment of the present disclosure.

FIG. 10 is an exploded perspective view of FIG. 9.

FIG. 11 is a plan view illustrating that a side cover of FIG. 9 is removed.

FIG. 12 is a cross-sectional view taken along a center of a guide roller of FIG. 9 in a front-rear direction.

FIG. 13 is a bottom perspective view of FIG. 9.

FIG. 14 is a bottom perspective view enlargedly illustrating a portion in which an ice making compartment of a refrigerator according to an embodiment of the present disclosure is formed.

FIG. 15 is a cross-sectional view taken along B-B of FIG. 14.

FIG. 16 is a cross-sectional view taken along C-C of FIG. 14.

FIG. 17 is a cross-sectional view taken along D-D of FIG. 14.

FIG. 18 is a bottom perspective view illustrating that components constituting an ice making compartment of FIG. 14 are removed.

FIG. 19 is a perspective view illustrating an outer partition wall of a refrigerator according to an embodiment of the present disclosure.

FIG. 20 is a bottom perspective view illustrating an outer partition wall of a refrigerator according to an embodiment of the present disclosure.

FIG. 21 is a perspective view illustrating an inner partition wall of a refrigerator according to an embodiment of the present disclosure.

FIG. 22 is a bottom perspective view illustrating an inner partition wall of a refrigerator according to an embodiment of the present disclosure.

FIG. 23 is a perspective view illustrating an entrance wall of a refrigerator according to an embodiment of the present disclosure.

FIG. 24 is a perspective view illustrating an installation wall of a refrigerator according to an embodiment of the present disclosure.

FIGS. 25 to 30 are perspective views illustrating processes of assembling a partition wall, an entrance wall, an installation wall, and an inner case of a refrigerator according to an embodiment of the present disclosure.

FIG. 31 schematically illustrates an integral foaming process of a refrigerator according to an embodiment of the present disclosure.

FIG. 32 schematically illustrates an integral foaming process of a refrigerator according to another embodiment of the present disclosure.

FIG. 33 is a perspective view illustrating an upper part of a refrigerator according to an embodiment of the present disclosure.

FIG. 34 is a front view illustrating a state in which a shelf of an ice making compartment of a refrigerator according to an embodiment of the present disclosure is removed.

FIG. 35 is a front view illustrating a state in which a shelf of an ice making compartment of a refrigerator according to an embodiment of the present disclosure is mounted on a partition wall.

FIG. 36 is a use state diagram illustrating a process of mounting a shelf of an ice making compartment of a refrigerator according to an embodiment of the present disclosure on a partition wall.

FIG. 37 is a perspective view illustrating an ice maker of a refrigerator according to an embodiment of the present disclosure.

FIG. 38 is a separate perspective view illustrating a state in which an ice maker of a refrigerator according to an embodiment of the present disclosure is separated.

FIG. 39 is a perspective view illustrating an ice storage bucket of a refrigerator according to an embodiment of the present disclosure.

FIG. 40 is a bottom perspective view illustrating an ice storage bucket of a refrigerator according to an embodiment of the present disclosure at a rear side.

FIG. 41 is a perspective view illustrating a driver fan duct assembly of a refrigerator according to an embodiment of the present disclosure.

FIG. 42 is a separate perspective view illustrating a state in which a driver fan duct assembly of a refrigerator according to an embodiment of the present disclosure is separated.

FIG. 43 is a separate rear perspective view of FIG. 42 at the rear side.

FIG. 44 is a vertical cross-sectional view taken along a center of a handle provided on an ice making compartment door of a refrigerator according to an embodiment of the present disclosure.

FIG. 45 is a separate rear perspective view illustrating a state in which an evaporator case is separated from an outer case and an inner case of a refrigerator according to an embodiment of the present disclosure.

FIG. 46 is a rear perspective view illustrating a state in which an evaporator case is mounted on an inner case of FIG. 45.

FIG. 47(a) is a perspective view illustrating an evaporator case of a refrigerator according to an embodiment of the present disclosure, and FIG. 47(b) is a rear perspective view of FIG. 47(a).

FIG. 48(a) is a front view of FIG. 47(a), and FIG. 48(b) is rear view of FIG. 47(a).

FIG. 49 is a separate rear perspective view illustrating a state in which a thermal insulation cover of a refrigerator according to an embodiment of the present disclosure is separated from a main body.

FIG. 50 is a separate rear perspective view illustrating a state in which a thermal insulation cover, an evaporator assembly, and a guide portion of a refrigerator according to an embodiment of the present disclosure is separated from a main body.

FIG. 51 is an exploded rear perspective view illustrating an evaporator assembly of a refrigerator according to an embodiment of the present disclosure.

FIG. 52 is an exploded rear perspective view illustrating a guide portion of a refrigerator according to an embodiment of the present disclosure.

FIG. 53 is an exploded perspective view illustrating FIG. 52 at a front side.

FIG. 54 is a horizontal cross-sectional view illustrating a state in which a refrigerator is disassembled into an outer cover and an inner cover by cutting a refrigerator according to an embodiment of the present disclosure based on the center of a thermal insulation cover.

FIG. 55 is a separate perspective view illustrating a state in which a first packing and a second packing are separated from a thermal insulation cover of a refrigerator according to an embodiment of the present disclosure.

### MODE FOR INVENTION

Reference will now be made in detail to embodiments of the disclosure, examples of which are illustrated in the accompanying drawings.

For reference, in embodiments of the present disclosure to be described below, reference for the same structure and components as those of a related art is made to the related art, and a detailed description thereof is omitted.

The technical terms disclosed herein are used to merely refer to a specific embodiment and does not intend to limit the present disclosure. A singular expression used in embodiments can include a plural expression as long as it does not have an apparently different meaning in context. In the present disclosure, terms “include” and “comprise” should be understood to be intended to designate that illustrated features, areas, numbers, steps, operations, components, parts and/or combinations thereof are present and not to preclude the existence of one or more different features, areas, numbers, steps, operations, components, parts and/or combinations thereof, or the possibility of the addition thereof.

When any component is described as “being connected” or “being coupled” to other component, this should be understood to mean that another component may exist between them, although any component may be directly connected or coupled to the other component.

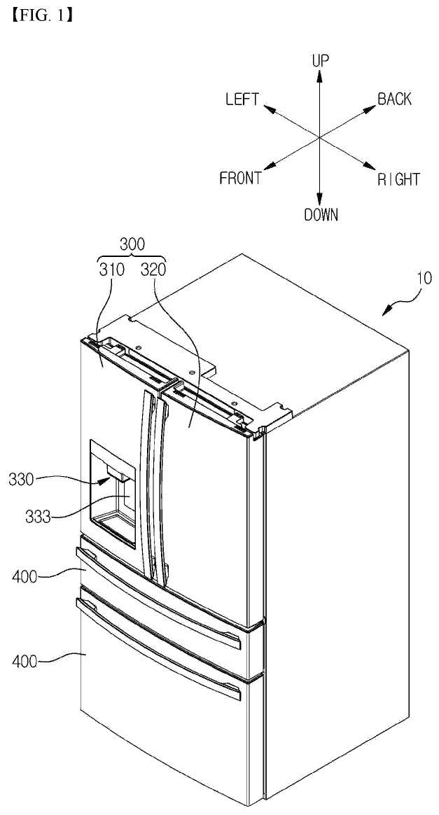

In embodiments of the present disclosure to be described below, all of front, back, left, right, up, and down directions are based on directions illustrated in FIG. 1.

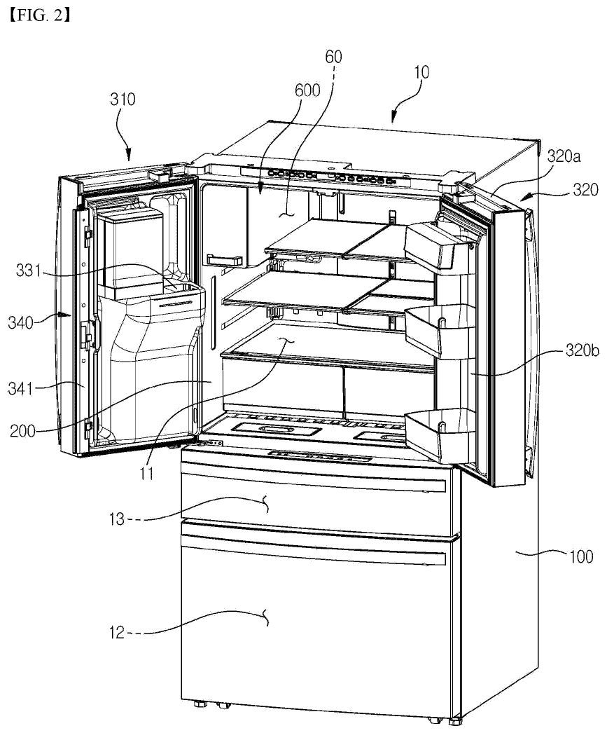

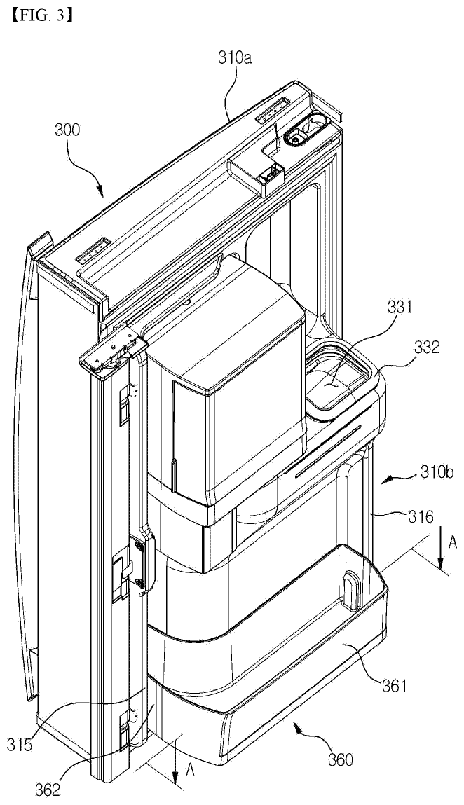

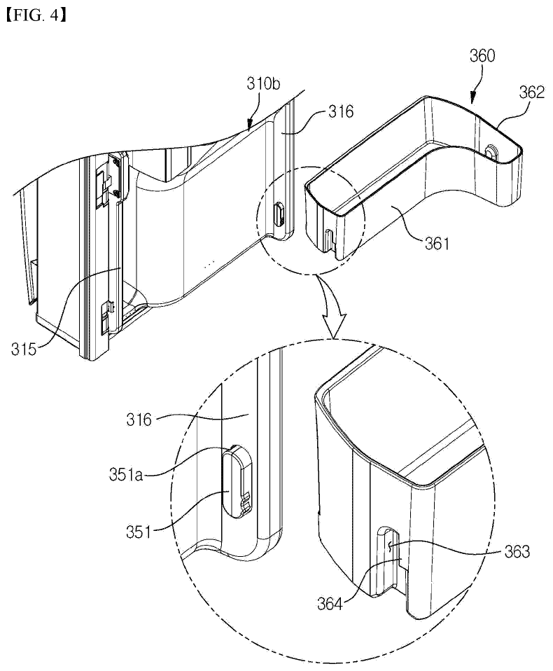

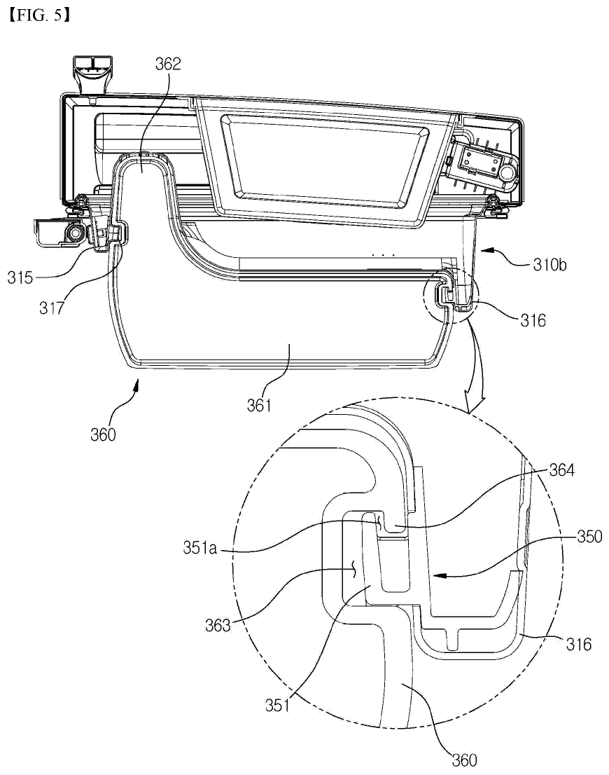

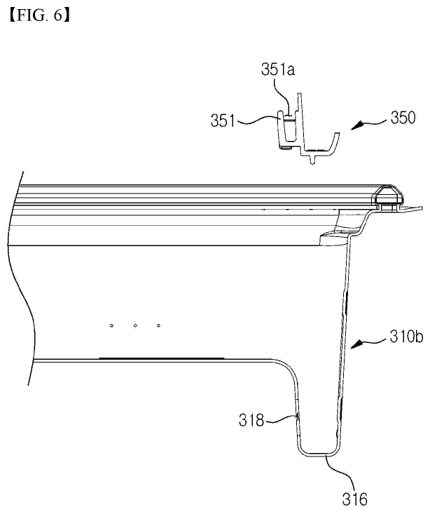

Referring to FIGS. 1 to 6, a main body 10 may be configured to form an appearance of a refrigerator according to an embodiment of the present disclosure. The main body 10 may be formed in a rectangular parallelepiped box shape. The main body 10 may include an outer case 100 and an inner case 200.

The outer case 100 may be configured to form an appearance of the main body 10. The outer case 100 is formed in a rectangular parallelepiped shape with an opened front and a space formed therein.

An opening 101 may be formed at an upper end of one side of a rear wall of the outer case 100.

The opening 101 may be a hole penetrating the rear wall of the outer case 100 in the front-rear direction. The opening 101 may be formed in a substantially rectangular shape.

The opening 101 is formed adjacent to an upper left edge of the rear side wall of the outer case 100 and may allow an evaporator assembly 1100 for supplying a cold air to an ice making compartment 60 to be described later to be assembled and installed at the rear side of the rear wall of the outer case 100.

The opening 101 may be formed to communicate with an installation space 1010 of an evaporator case 1000 to be described later disposed in front of the outer case 100.

The inner case 200 may be coupled to the outer case 100.

The inner case 200 may be combined with the outer case 100 by being accommodated and assembled in an inner space of the outer case 100. The inner case 200 may be combined with the outer case 100 while providing a space portion 102 between the outer case 100 and the inner case 200 so that various wires can be accommodated and a thermal insulation material 110 to be described later can be injected and foamed.

The inner case 200 has an opened front and may include a plurality of storage compartments provided therein. Each of the plurality of storage compartments can be selectively shielded by a door.

The refrigerator according to an embodiment of the present invention may be a French door refrigerator with an upper refrigerator compartment and a lower freezer compartment. The plurality of storage compartments may include a refrigerator compartment 11 provided at the upper part of the inner case 200 and a freezer compartment 12 provided at the lower part of the inner case 200 to be disposed below the refrigerator compartment 11.

A door is installed on the front side of each of the plurality of storage compartments, and thus the storage compartment can be selectively opened and closed by the door.

Some of the plurality of storage compartments may be opened and closed by a pivoting door 300. The rest of the plurality of storage compartments may be opened and closed by a drawer door 400.

For example, the refrigerator compartment 11 disposed at the upper part of the main body 10 may be opened and closed by the pivoting door 300. For example, a specialized compartment 13 disposed under the refrigerator compartment 11 and the freezer compartment 12 disposed under the specialized compartment 13 each may be opened and closed by the drawer door 400.

A first pivoting door 310 and a second pivoting door 320 may be respectively installed on the left and right sides of the main body 10 and may be arranged side by side in the left-right direction.

The first pivoting door 310 may include a first door outer case 310a forming an appearance of the first pivoting door 310 and a first door inner case 310b coupled to a rear end of the first door outer case 310a.

The second pivoting door 320 may include a second door outer case 320a forming an appearance of the second pivoting door 320 and a second door inner case 320b coupled to a rear end of the second door outer case 320a.

A dispenser 330 may be installed in the pivoting door 300.

The dispenser 330 may be configured to take water stored in a water supply tank (not shown) or ice stored in the ice making compartment 60 out of the refrigerator through an outlet port without opening the pivoting door 300 in a state in which the pivoting door 300 is closed. For example, the dispenser 330 may be provided in the first pivoting door 310 installed on the left side of the main body 10.

The dispenser 330 may include an ice transfer duct 331 that is formed at the first pivoting door 310 in the up-down direction, and a lower end of the ice transfer duct 331 communicates with the outlet port. When the first pivoting door 310 is closed, an upper end of the ice transfer duct 331 communicates with the ice making compartment 60, and thus the outlet port of the dispenser 330 and the ice making compartment 60 communicate with each other. Hence, even when the first pivoting door 310 is closed, the ice stored in the ice making compartment 60 may be taken out of the refrigerator through the outlet port of the dispenser 330.

A gasket 332 may be installed around an upper perimeter of the ice transfer duct 331 and may maintain airtightness between the ice making compartment 60 and the refrigerator compartment 11 when the ice transfer duct 331 and the ice making compartment 60 communicate with each other.

The gasket 332 may be formed such that an upper surface has an inclination with a decreasing height as it goes from the front to the rear.

For example, the gasket 332 may be entirely formed in an obliquely inclined shape so that a front end of the upper surface is positioned higher than a rear end.

The gasket 332 is formed to have an inclination with a gradually decreasing height as it goes from the entire perimeter of the upper surface to the outside of the center of the gasket 332.

The inclination formed in the gasket 332 may allow a smooth contact with a contact portion 6119 to be described later when the first pivoting door 310 is closed.

The dispenser 330 may be provided with an operation unit 333 such as a button, a lever, and the like. The user may take out the water stored in the water supply tank (not shown) or the ice stored in the ice making compartment 60 through the dispenser 330 by manipulating the operation unit 333, if necessary or desired.

A sealing bar 340 may be installed at a right end of a rear surface of the first pivoting door 310.

The sealing bar 340 may be formed such that a sealing surface 341 is provided on one surface of a bar elongated in the up-down direction. The sealing bar 340 may seal a separation space between the first pivoting door 310 and the second pivoting door 320 when the first pivoting door 310 and the second pivoting door 320 are closed.

The sealing surface 341 may be made of a steel material and may be in close contact with a magnet of a door gasket (not shown). In addition, the sealing surface 341 itself may be formed of a magnet.

A pair of catching protrusions 317 and 351 may be provided on the door inner cases 310b and 320b of the pivoting door 300.

The pair of catching protrusions 317 and 351 may be provided on the door inner cases 310b and 320b at a lower end of the dispenser 330 of the pivoting door 300.

A left protruding wall 316 and a right protruding wall 315 that protrude rearward may be formed on both sides of the first door inner case 310b. The pair of catching protrusions 317 and 351 may include a first catching protrusion 317 protruding to the left from an outer left surface of the right protruding wall 315 and a second catching protrusion 351 protruding to the right from an outer right surface of the left protruding wall 316.

The left protruding wall 316 protrudes further to the rear side than the right protruding wall 315. The second catching protrusion 351 provided on the left protruding wall 316 may be disposed more rearward than the first catching protrusion 317 provided on the right protruding wall 315.

The first catching protrusion 317 among of the pair of catching protrusions may be formed integrally with the right protruding wall 315 of the first door inner case 310b.

The second catching protrusion 351 among of the pair of catching protrusions may be provided separately from the first door inner case 310b and may be formed integrally with a catching member 350 coupled to the left protruding wall 316. The second catching protrusion 351 may be provided to protrude to the right side of the left protruding wall 316 through a catching protrusion accommodation hole 318 formed in the left protruding wall 316. Alternatively, the second catching protrusion 351 may be formed integrally with the first door inner case 310b.

The pair of catching protrusions 317 and 351 may elongate in the up-down direction. An upper surface of each of the pair of catching protrusions 317 and 351 is formed to be round.

At least one of the pair of catching protrusions 317 and 351 may include a cutting groove 351a elongating in the up-down direction. For example, the cutting groove 351a may be formed in the second catching protrusion 351.

The cutting groove 351a may be a groove that is cut across the front surface and the upper surface of the second catching protrusion 351. A front side and an upper side of the cutting groove 351a may be open.

A door pocket 360 may be installed in the rear surface of the pivoting door 300. The door pocket 360 may be installed in the first door inner case 310b of the first pivoting door 310.

The door pocket 360 may be configured to accommodate and store various kinds of bottles, plastic-packed foods, frequently used foods, and the like. The door pocket 360 may be formed in the form of a container with a space formed therein and an open top surface.

The door pocket 360 may be formed in a form in which one side is bent.

For example, the door pocket 360 may include a first pocket portion 361 elongating in the left-right direction and a second pocket portion 362 that is bent from the right side to the front side of the first pocket portion 361.

The door pocket 360 may be mounted at the lower end of the dispenser 330 provided in the first pivoting door 310. The first pocket portion 361 may be supported on the rear side of the dispenser 330. The second pocket portion 362 may be accommodated and mounted in a space between the dispenser 330 and the right protruding wall 315.

A pair of pocket grooves 363 corresponding to the pair of catching protrusions 317 and 351 may be formed on both side walls of the door pocket 360.

The pocket grooves 363 may be fitted to the catching protrusions 317 and 351 and allow the door pocket 360 to be mounted on the first pivoting door 310.

The pocket grooves 363 may be a groove that is formed to be concave in an inner horizontal direction on the left and right walls of the door pocket 360, respectively, and has an open lower part and a closed upper part. One pocket groove 363 may be formed in each of the left and right walls of the door pocket 360. For example, one pocket groove 363 may be formed on each of the left side wall of the first pocket portion 361 and the right side wall of the second pocket portion 362 to form a pair.

A pair of pocket grooves 363 may be fitted to correspond to the pair of catching protrusions 317 and 351.

For example, the pocket groove 363 formed on the left wall of the first pocket portion 361 may be fitted into the second catching protrusion 351. The pocket groove 363 formed on the right wall of the second pocket portion 362 may be fitted into the first catching protrusion 317.

The pocket groove 363 may elongate in the up-down direction. The pocket groove 363 may be formed to be rounded so that its inner upper surface corresponds to a shape of the upper surfaces of the catching protrusions 317 and 351.

The catching protrusions 317 and 351 may be inserted into the pocket grooves 363 through the open lower parts of the pocket grooves 363. The rounded upper surfaces of the catching protrusions 317 and 351 may support the rounded inner upper surfaces of the pocket grooves 363. The front and rear surfaces of the catching protrusions 317 and 351 may be caught on the inside front and rear surfaces of the pocket grooves 363. Through such a coupling structure, the door pocket 360 may be mounted on the first pivoting door 310.

A detachment prevention portion 364 elongating in the up-down direction may be integrally formed so that one side inside the pocket groove 363 is inserted into the cutting groove 351a.

The rear and the lower part of the door pocket 360 can be prevented from be detached by coupling the pocket grooves 363 and the catching protrusions 317 and 351. In addition, the catching protrusions 317 and 351 can be prevented from be detached from the pocket grooves 363 due to an external impact by coupling the detachment prevention portion 364 and the cutting groove 351a. Hence, the door pocket 360 can be firmly fixed.

The drawer door 400 may be installed at the storage compartment.

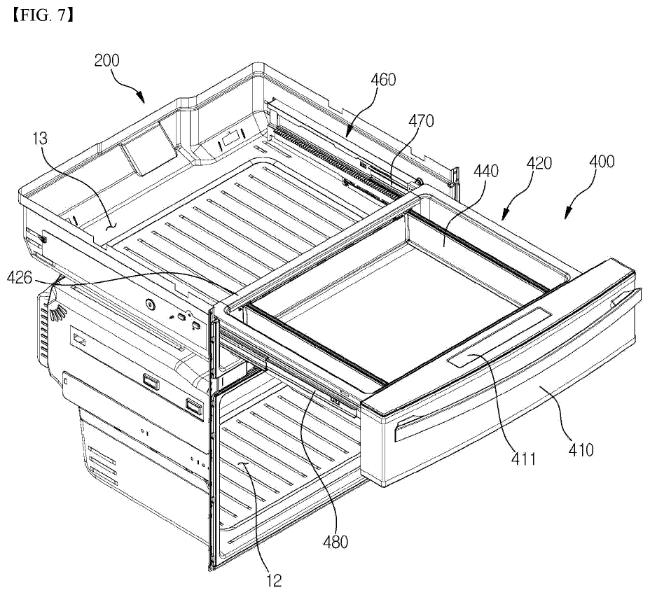

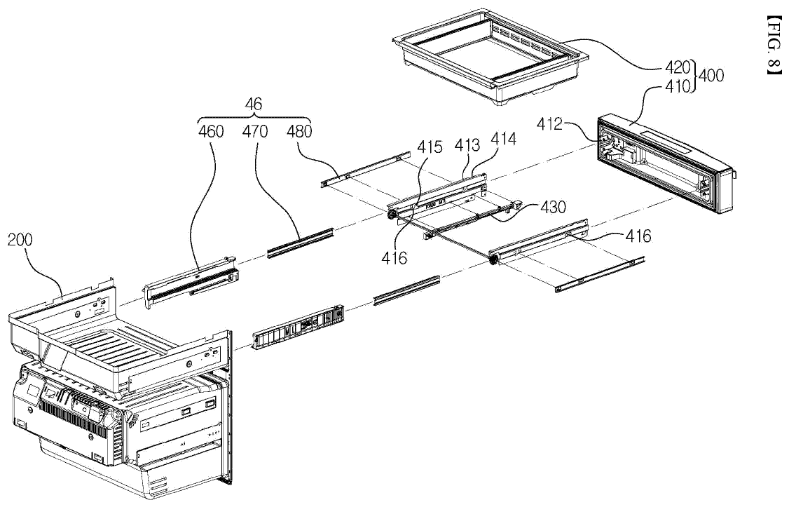

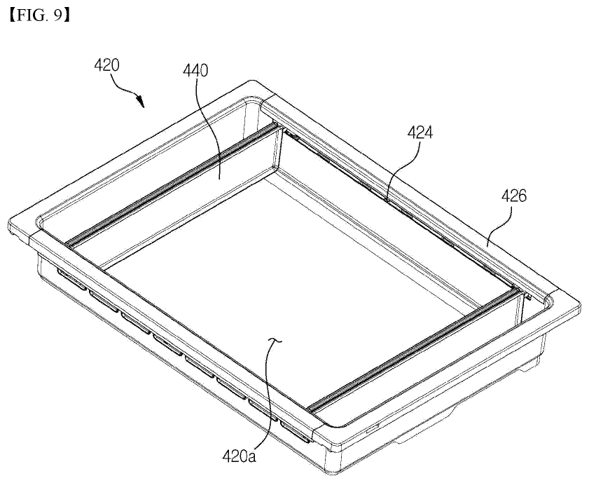

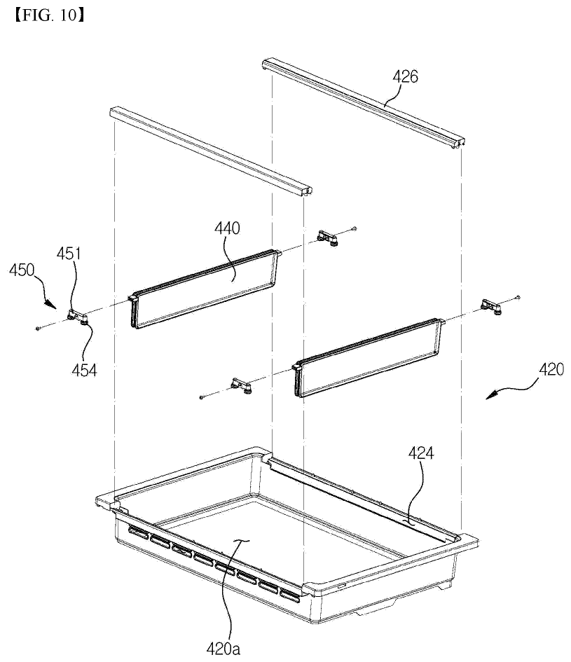

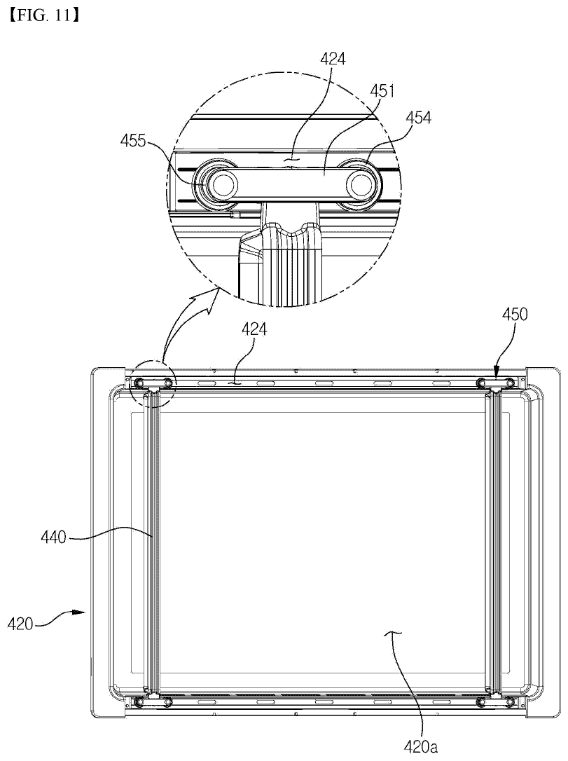

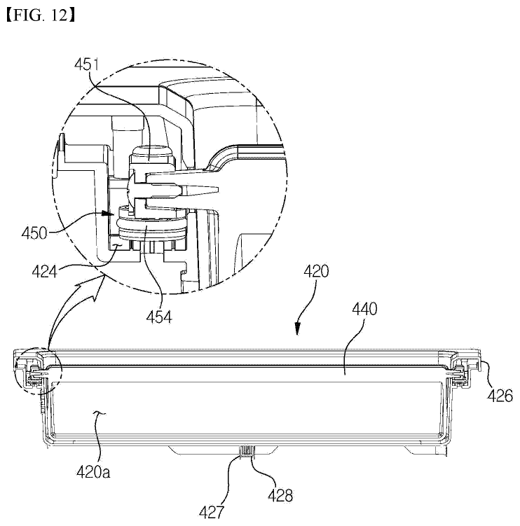

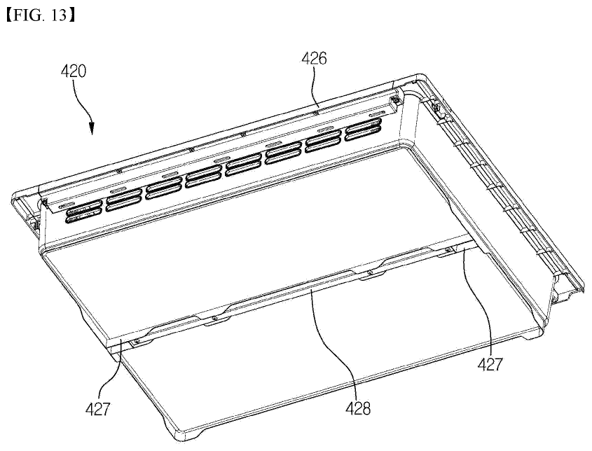

Referring to FIGS. 7 to 13, the drawer door 400 may be configured to selectively open and close the opened front surface of the storage compartment, in particular, the specialized compartment 13 and the freezer compartment 12. The drawer door 400 may be slidably installed in the inner case 200 of the main body 10 in the front-rear direction.

The drawer door 400 may include a door portion 410 and a basket portion 420.

A control panel 411 may be provided on an upper surface of the door portion 410.

The control panel 411 may be a configuration that can be set by the user to store certain goods such as vegetables, fruits, meat, fish, drinks, and wine in the storage compartment in an appropriate state. The control panel 411 may be provided on the upper surface side of the door portion 410 of the drawer door 400 installed in the specialized compartment 13. The control panel 411 may be provided on the drawer door 400 installed in the freezer compartment 12.

The control panel 411 is electrically connected to an inner case electric wire (not shown) of the main body 10, and thus the storage compartments can be controlled according to a setting by a user's operation.

A first connection frame 412 may be installed in the door portion 410.

The first connection frame 412 may be configured to connect the door portion 410, a second connection frame 413, and a rail assembly 46. The first connection frame 412 may be an “L”-shaped frame. The first connection frames 412 may be respectively fastened and fixed to both ends of a rear surface of the door portion 410 in a symmetrical form.

The second connection frame 413 may be coupled to the first connection frame 412.

The second connection frame 413 may be configured to provide the basket portion 420 at the rear side of the door portion 410. The second connection frame 413 may be formed to elongate in the front-rear direction. The second connection frames 413 may be respectively fastened and fixed to the rear ends of the two first connection frames 412 of which the front ends are fixed to the door portion 410.

A constraint groove 414 that is penetrated in the up-down direction and is opened outward in the horizontal direction may be formed at an upper end of a front side of the second connection frame 413.

Through portions 415 may be present at the front side and the rear side of the second connection frame 413, respectively. A fixing piece 416 may be formed at an inner upper end of the through portion 415 and may protrude downward.

The fixing piece 416 formed at the rear side of the second connection frame 413 may be formed in a form in which a lower end is bent to the rear side.

A connection member 430 may be coupled to the inner surface of the second connection frame 413.

The connection member 430 may be configured to connect a control panel electric wire (not shown) connected to the control panel 411 and an inner case electric wire (not shown) drawn from the outside of the inner case 200 to the inside of the specialized compartment 13. The connection member 430 may be fitted and coupled to the lower part of the inner surface of the second connection frame 413 and may be fixed through screwing.

A connection line (not shown) for connecting a control panel electric wire (not shown) and an inner case electric wire (not shown) of the main body 10 may be provided inside the connection member 430. Both ends of the connection line may be connected to a first connector (not shown) and a second connector (not shown) provided at the front and rear ends of the connection member 430.

The basket portion 420 may be provided on the rear surface of the door portion 410.

The basket portion 420 may be a storage portion having a storage space 420a for storing food, etc. therein. The basket portion 420 may be formed in a box shape with an opened top surface.

Roller grooves 424 elongating in the horizontal direction may be formed on both side walls of the basket portion 420.

The roller grooves 424 may be respectively formed at upper ends of front and rear walls of the basket portion 420, and may be grooves in which guide rollers 450 fixed to a partition 440 to be described later are accommodated.

The upper part of the basket portion 420, in which the roller grooves 424 are formed, is of made of a separate side wall cover 426, and may be fastened to and fixed to each of the upper ends of the front and rear walls of the basket portion 420.

A reinforcing support portion 427 may be formed on the lower surface of the basket portion 420.

The reinforcing support portion 427 may be configured to support a load of food, etc. stored in the storage space 420a by reinforcing the lower surface of the basket portion 420. Two reinforcing support portions 427 may protrude to be spaced apart from each other in the front-rear direction at the center of the lower surface of the basket portion 420. The reinforcing support portion 427 may elongate in the left-right direction.

A reinforcing member 428 may be installed in the basket portion 420 to support a load of food, etc. stored in the storage space 420a.

The reinforcing member 428 may be interposed and fixed between the reinforcing support portions 427.

The partition 440 for partitioning the storage space 420a may be provided inside the basket portion 420.

The partition 440 may be installed in the storage space 420a to elongate in the front-rear direction. The partition 440 may be disposed in a vertically standing shape. The partition 440 may be formed of a transparent or opaque material.

Guide rollers 450 may be installed on one side and the other side of the partition 440, that is, the front side and the rear side, respectively.

The guide rollers 450 may be accommodated and guided in the roller grooves 424 so that the partition 440 is slidable in the storage space 420a in the left-right direction. One guide roller 450 may be installed on the upper side of the front end of the partition 440, and one guide roller 450 may be installed on the upper side of the rear end of the partition 440.

That is, the pair of guide rollers 450 may be fixed to the upper parts of both ends of the partition 440 so that they are symmetrical in the front-rear direction.

The guide roller 450 may include a roller bracket 451 and a roller 454.

The roller bracket 451 may be fixed to intersect perpendicularly the partition 440.

The roller 454 may be installed on the roller bracket 451.

The roller 454 may be configured to move according to the guide of the roller groove 424 while being accommodated in the roller groove 424.

At least one roller 454 may be installed at the lower part of the roller bracket 451 so that it is rotatable about a vertical axis 455. When a plurality of rollers 454 are installed, they may be installed on the roller bracket 451 so as to be disposed along the longitudinal direction of the roller groove 424.

In this instance, the roller 454 may be installed to contact an inner surface of an entrance side of the roller groove 424 (an inner rear surface of the roller groove at the front side and an inner front surface of the roller groove at the front side).

For example, two rollers 454 may be installed on the roller bracket 451.

One of the two rollers 454 may be rotatably installed on the lower left side of the roller bracket 451. The other one of the two rollers 454 may be rotatably installed on the lower right side of the roller bracket 451. The two rollers 454 may be spaced apart from each other in the left-right direction.

When the guide roller 450 fixed to the partition 440 is accommodated in the roller groove 424, the two rollers 454 may contact the inner surface of the entrance side of the roller groove 424. Further, when the user applies a force to the partition 440 in this state, the two rollers 454 may ride on the inner surface of the entrance side of the roller groove 424 according to a direction of the applied force and may move inside the roller groove 424 in the left-right direction.

Even if the force applied to the partition 440 by the user is biased or strongly applied to either side of the partition 440, the roller 454 of the guide roller 450 that is rotatable about the vertical axis 455 may slide very easily inside the storage space 420a of the basket portion 420 without distortion, since the rolling surface always maintains a state of contacting the inner surface of the entrance side of the roller groove 424.

Both ends of the rear side of the drawer door 400 may be respectively connected to both side walls of the main body 10 by a rail assembly 46.

The rail assembly 46 may be configured to slidably connect the drawer door 400 to the inner case 200 of the main body 10 so that the drawer door 400 can be drawn into and drawn out of the storage compartment, and to support the drawer door 400.

The rail assembly 46 may include a door rail 480 fixed to the drawer door 400, a fixed rail 460 fixed to the inner case 200 of the main body 10, and a connection rail 470 connecting the door rail 480 to the fixed rail 460.

A first bead portion 210 may be formed on one side of an inner surface of the inner case 200, and a second bead portion 220 may be formed on other side of the inner surface of the inner case 200.

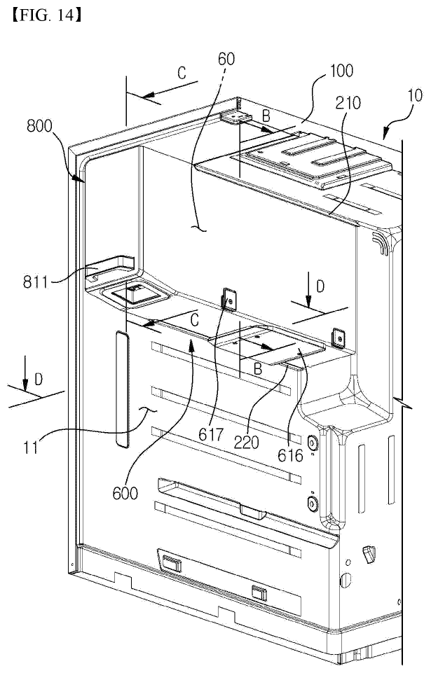

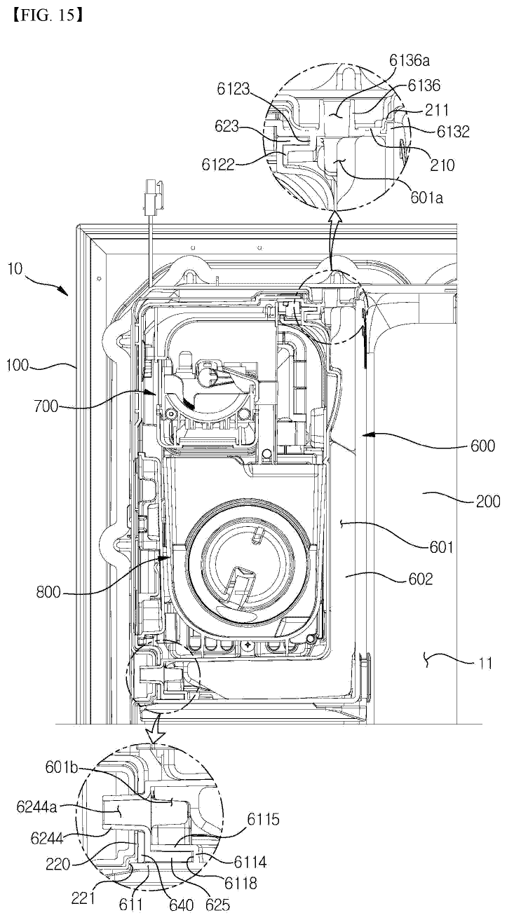

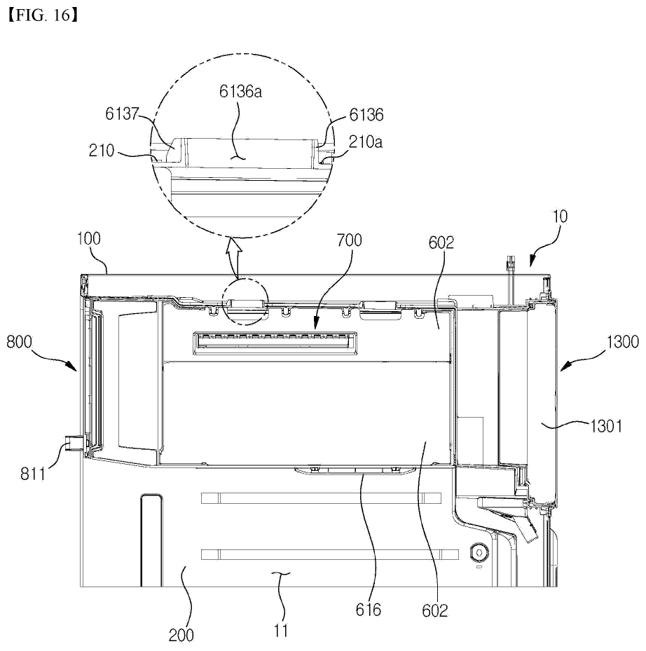

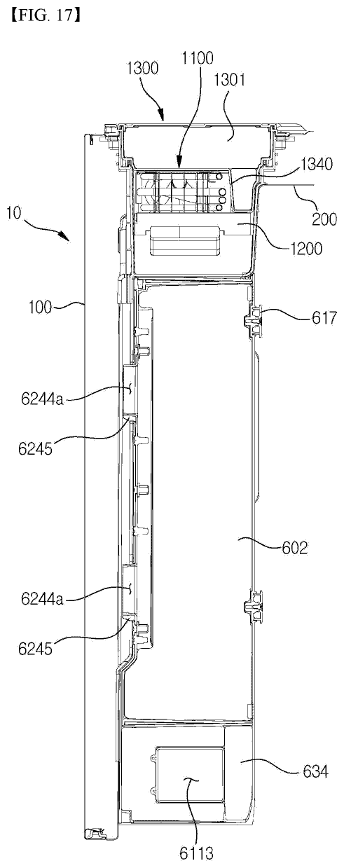

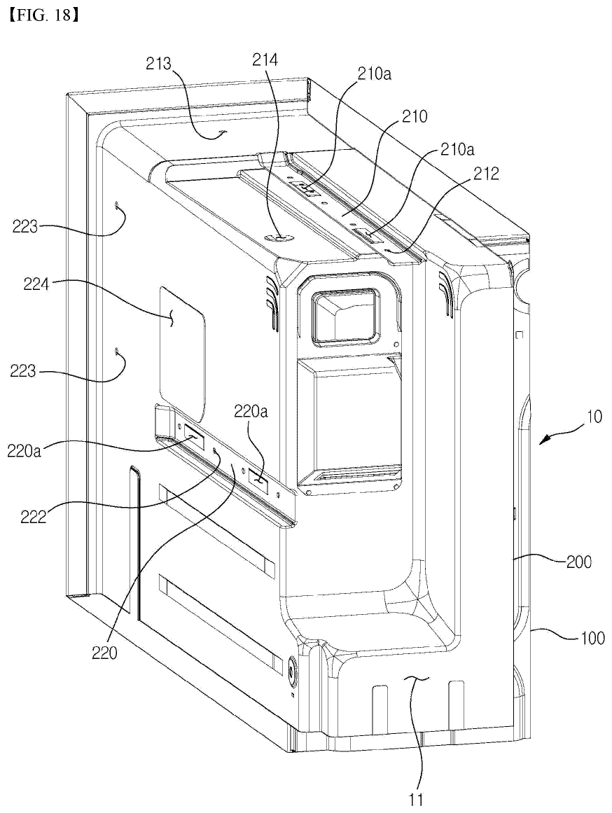

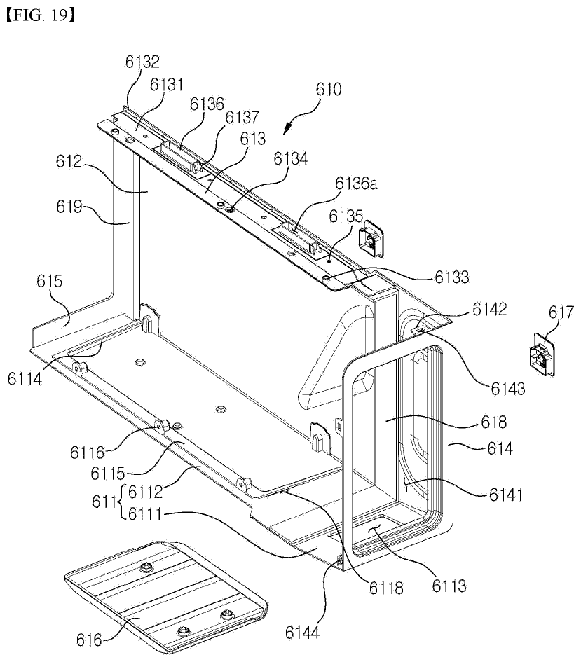

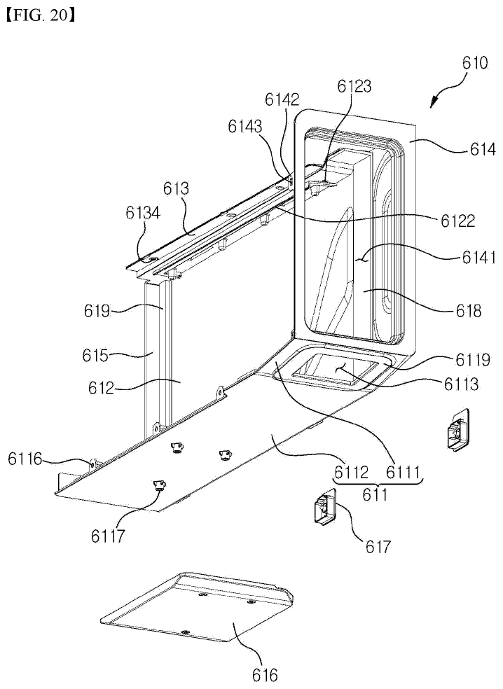

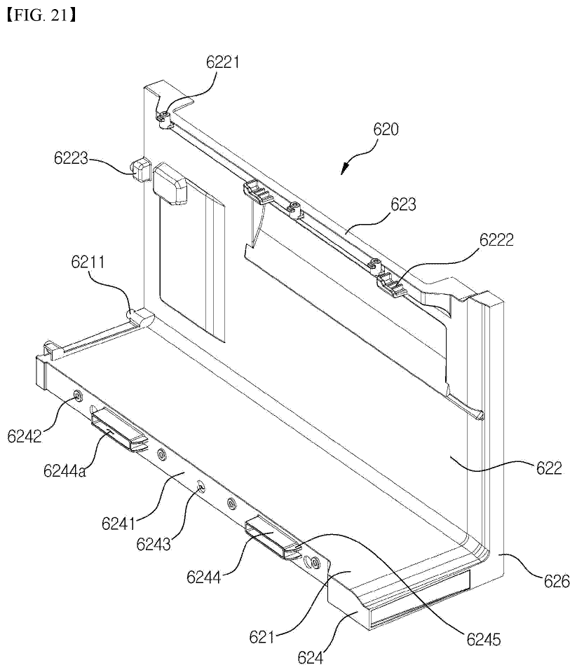

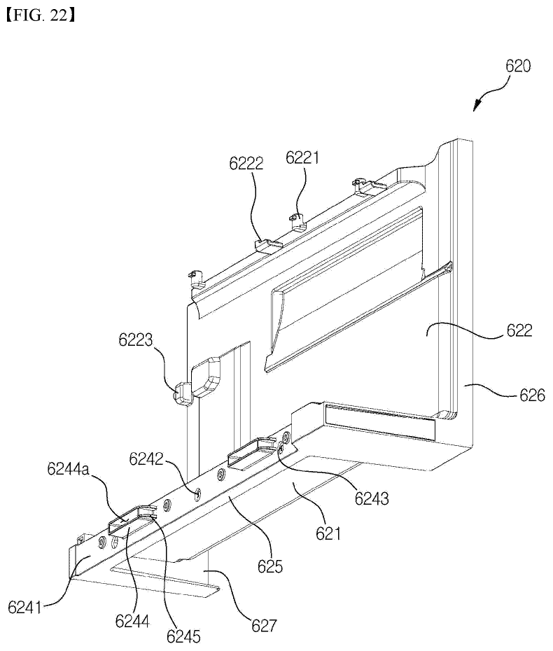

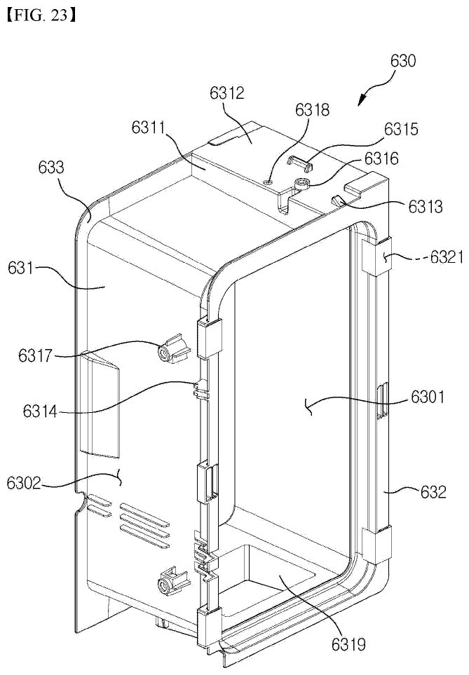

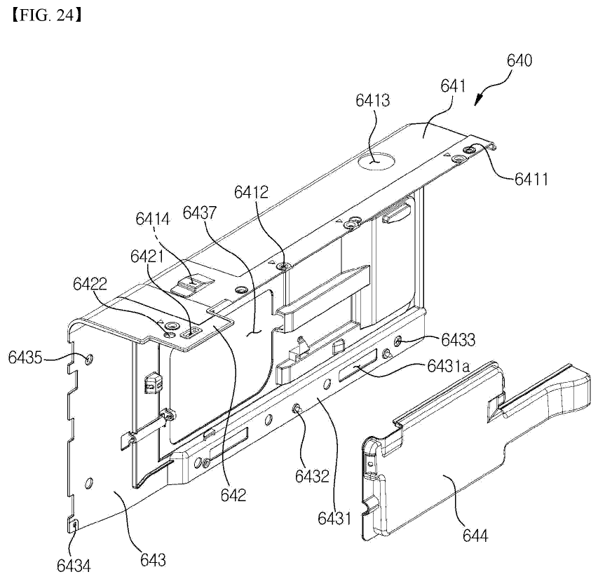

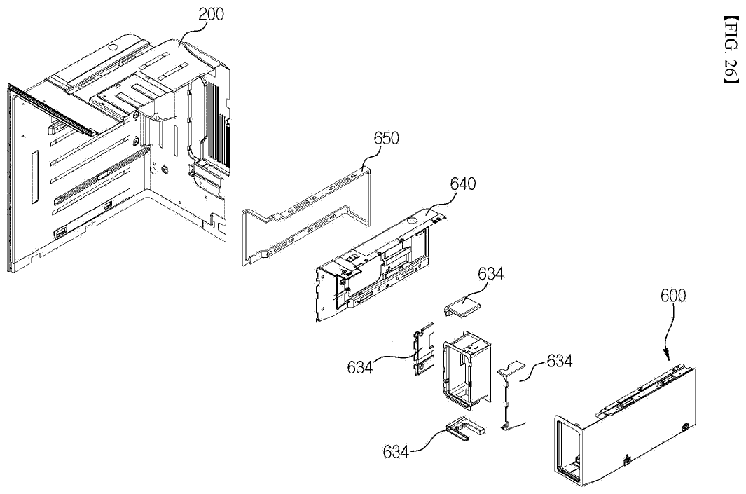

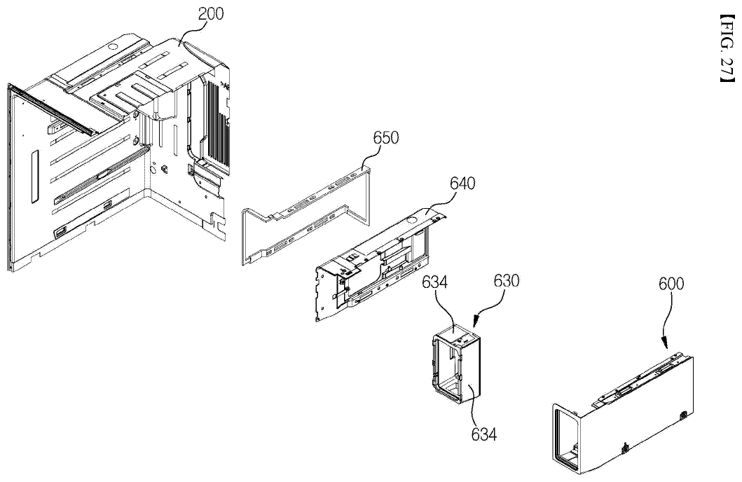

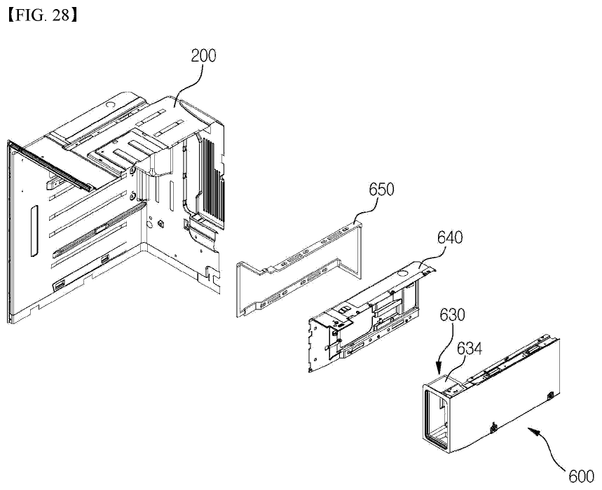

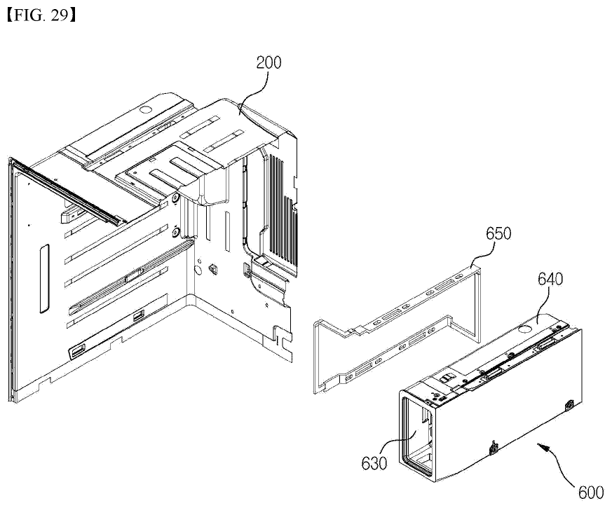

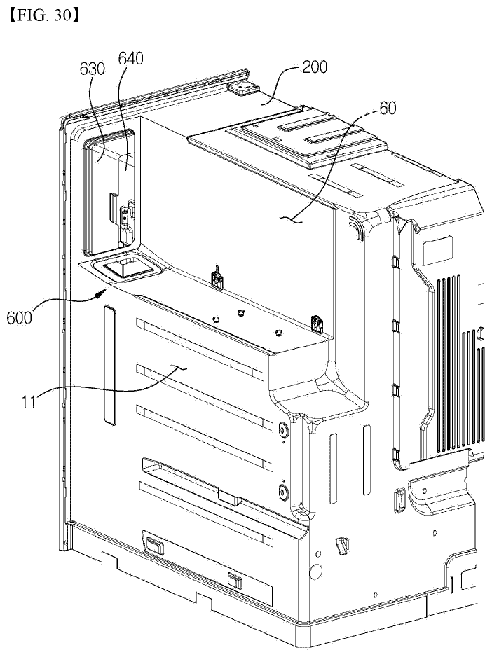

Referring to FIGS. 14 to 30, the first bead portion 210 may be formed to convexly protrude downward from the inner surface of the upper wall of the inner case 200, and at the same time, to extend forward from the inner surface of the rear wall of the inner case 200. The second bead portion 220 may be formed to convexly protrude from the inner surface of the left wall of the inner case 200 to the right, and at the same time, to extend forward from the inner surface of the rear wall of the inner case 200 to the front side.

In this case, each of the first bead portion 210 and the second bead portion 220 may be formed integrally at the inner case 200. The first bead portion 210 may be formed to have a longer length than the second bead portion 220.

The first bead portion 210 and the second bead portion 220 may have a convex shape when viewed from the inside of the inner case 200, but may have a concave shape when viewed from the outside of the inner case 200.

That is, the first bead portion 210 and the second bead portion 220 may have a shape of protruding convexly with respect to the inner surface of the inner case 200 and being recessed concavely with respect to the outer surface of the inner case 200.

A front end of the first bead portion 210 may be inclined in an upward direction. A front end of the second bead portion 220 may be inclined in a left direction.

In addition, a first stepped portion 211 may be formed on the right side of the first bead portion 210 to support a stepped portion 6132 to be described later. A second step portion 221 is formed on the lower part of the second bead portion 220 to support a left end of a first lower plate 611 of an outer partition wall 610 to be described later.

The first bead portion 210 may form a part of a thermal insulation wall on the right side of the ice making compartment 60 together with a right part of a partition wall 600 to be described later forming the ice making compartment 60. The second bead portion 220 may form a part of a thermal insulation wall below the ice making compartment 60 together with a lower part of the partition wall 600 to be described later forming the ice making compartment 60.

The partition wall 600 may be installed at an upper corner of one side of the inner case 200.

A first concave portion 6131 matched with the first bead portion 210 may be formed on one side of the partition wall 600, and a second concave portion 6241 matched with the second bead portion 220 may be formed on other side of the partition wall 600.

The partition wall 600 may be a wall that is coupled to an upper corner of the left side of the inner case 200 to serve as a right thermal insulation wall and a lower thermal insulation wall for forming the ice making compartment 60. In the partition wall 600, the first concave portion 6131 formed at an upper right side may be matched and coupled with the first bead portion 210 of the inner case 200. In the partition wall 600, the second concave portion 6241 formed at the lower left end may be matched and coupled with the second bead portion 220 of the inner case 200. The partition wall 600 may form the ice making compartment 60 therein through the above-described coupling.

That is, the partition wall 600 may be configured to partition the ice making compartment 60 as a thermal insulation space separate from the refrigerator compartment 11. The partition wall 600 may serve as an ice making compartment case surrounding the ice making compartment 60 together with the upper wall and the left wall of the inner case 200.

A thermal insulation material accommodating space 601 may be provided inside the partition wall 600.

The thermal insulation material 110 may be injected and integrally foamed into at least a part of the space portion 102 between the outer case 100 and the inner case 200 and the thermal insulation material accommodating space 601 of the partition wall 600. This is described later.

In addition, when forming the ice making compartment 60 by the partition wall 600, an entrance wall 630 and an installation wall 640 may be further provided in addition to the partition wall 600. This is described later.

The partition wall 600 may include the outer partition wall 610 and an inner partition wall 620 coupled to the inside of the outer partition wall 610.

The outer partition wall 610 may be configured to form an appearance of the ice making compartment 60. The outer partition wall 610 may include a first lower plate 611, a first side plate 612 extending upward over an entire right end of the first lower plate 611, a first coupling plate 613 extending to the left over a part of an upper end of the first side plate 612, a first front plate 614 that has a rectangular shape and is formed such that a lower end and a right end of the first front plate 614 are respectively formed integrally at an entire front end of the first lower plate 611 and an entire front end of the first side plate 612, and a first rear plate 615 formed integrally over rear ends of the first lower plate 611, the first side plate 612, and the first coupling plate 613.

The first lower plate 611 may be configured to form the bottom of the outer partition wall 610. The first lower plate 611 may elongate in the front-rear direction.

A left end of the first lower plate 611 may be recessed to the right from the rear end to one front side so that it corresponds to the shape of the second bead portion 220. The left end of the first lower plate 611 may be supported by the second step portion 221 when the inner case 200 and the partition wall 600 are coupled.

The first lower plate 611 may include an inclination plate 6111 having an inclination with a gradually decreasing height as its front side goes from the front to the rear. The first lower plate 611 may further include a horizontal plate 6112 formed as the rear side of the inclination plate 6111.

An ice discharge port 6113 penetrated in the up-down direction may be formed on the front side of the first lower plate 611, i.e., the inclination plate 6111 to be spaced apart from a front surface of the first front plate 614 to be described later.

The ice discharge port 6113 may be a hole through which ice generated by an ice maker 700 to be described later and stored in an ice storage bucket 800 is discharged. The ice discharge port 6113 may be provided at the lower part of the partition wall 600 to be spaced apart from the rear side of an ice making compartment door 810 to be described later.

As the ice discharge port 6113 is provided at the lower part of the partition wall 600, a joint between the ice making compartment door 810 and the partition wall 600, i.e., a detachable portion for opening and closing between the ice making compartment door 810 and the partition wall 600 is positioned to be spaced apart from the ice discharge port 6113 at the front side of the ice discharge port 6113. Hence, a loss of cool air on the movement path of ice stored in the ice storage bucket 800 can be minimized.

A contact portion 6119 convexly protruding downward may be formed at an edge of a lower end of the ice discharge port 6113.

The contact portion 6119 may be formed on the lower surface of the partition wall 600, i.e., on a lower surface of the inclination plate 6111 of the first lower plate 611. The contact portion 6119 may be formed in a ring shape along the edge of the lower end of the ice discharge port 6113.

The contact portion 6119 may be inclined to have an inclination with a decreasing height as it goes from the front to the rear.

The contact portion 6119 may be a portion that is in close contact with the gasket 332 provided at the upper end of the ice transfer duct 331 formed in the dispenser 330. The contact portion 6119 may allow the pressure to be intensively applied to gasket 332.

The contact portion 6119 may smoothly pressurize the entire perimeter of the upper end of the gasket 332 along the inclination formed in the gasket 332 when the first pivoting door 310 closes the main body 10, and at the same time, may be in close contact with the entire perimeter of the upper end of the gasket 332, thereby maintaining airtightness between the ice making compartment 60 and the refrigerator compartment 11.

In addition, due to the inclination of the gasket 332, the gasket 332 can be prevented from being twisted or pushed without adding a separate lubricating material to the gasket 332.

A first protruding jaw 6114 may be formed on the upper surface of the first lower plate 611, more specifically, on the upper surface of the horizontal plate 6112 and may protrude upward to have a “⊏”-shape when viewed from the plan. A flange 6115 bending outward along an edge of the first protruding jaw 6114 may be formed at an upper end of the first protruding jaw 6114.

The first protruding jaw 6114 and the flange 6115 may be positioned inside the front, rear, and left edges of the first lower plate 611.

A first fastening portion 6116 may be integrally formed on the left side of the flange 6115.

The first fastening portion 6116 may be formed for the coupling between the outer partition wall 610, the inner partition wall 620, and the installation wall 640 to be described later.

In this embodiment, three first fastening portions 6116 may be formed to be spaced apart from each other in the front-rear direction.

A second fastening portion 6117 may be formed on the lower surface of the first lower plate 611.

A shelf holder 616 may be fastened to the second fastening portion 6117.

A clearance space 6162 may be formed between the shelf holder 616 and the first lower plate 611. In the clearance space 6162, adjacent ice making compartment shelves 250 may be mounted by being fitted and coupled in a standing state. Hence, a high-height good can be accommodated on a left shelf 230 disposed below the ice making compartment shelf 250.

The first coupling plate 613 may be integrally formed at the upper end of the first side plate 612.

The first coupling plate 613 may be formed to elongate in the front-rear direction. The first coupling plate 613 may be formed to extend from the upper end of the first side plate 612 to the left and may face the first lower plate 611.

A left-right width of the first coupling plate 613 may be less than a left-right width of the first lower plate 611. A length in the front-rear direction of the first coupling plate 613 may be less than a length in the front-rear direction of each of the first lower plate 611 and the first side plate 612.

That is, the first coupling plate 613 may be formed to have the length in the front-rear direction substantially similar to that of the horizontal plate 6112 of the first lower plate 611. The front end of the first coupling plate 613 may be spaced apart from the first front plate 614 to be described later.

The first concave portion 6131 matched with the first bead portion 210 of the inner case 200 may be formed on the right side of the first coupling plate 613.

The first concave portion 6131 may be formed in a downward concave shape on the right side of the first coupling plate 613 so that the first bead portion 210 can be accommodated and matched, and may be elongate in the front-rear direction.

When the first concave portion 6131 couples the partition wall 600 to the inner case 200, the first concave portion 6131 allows the partition wall 600 to be assembled to a correct position through the match with the first bead portion 210.

A front end of the first concave portion 6131 may protrude upward with respect to the first concave portion 6131.

The stepped portion 6132 may be formed at a right end of the first concave portion 6131.

The stepped portion 6132 may be a portion in which the upper end of the first side plate 612 protrudes upward with respect to the first concave portion 6131. When the inner case 200 and the partition wall 600 are coupled, the stepped portion 6132 may be supported by the first stepped portion 211.

A plurality of insertion protrusions 6133 and a plurality of fourth insertion holes 6134 may be formed in the first coupling plate 613.

The insertion protrusion 6133 may be integrally formed on the left side of the upper surface of the first coupling plate 613. The insertion protrusion 6133 may be formed to protrude upward.

A third fastening hole 6135 may be formed in the right side of the first coupling plate 613, i.e., the first concave portion 6131.

The first front plate 614 may be integrally formed at the front end of the first lower plate 611 and the first side plate 612.

The first front plate 614 may be formed in a rectangular shape when viewed from the front. The lower end and the right end of the first front plate 614 may be integrally formed at the front end of the first lower plate 611 and the front end of the first side plate 612, respectively.

In this instance, the first front plate 614 is spaced apart from the first coupling plate (613).

The first front plate 614 may include a first opening 6141 penetrated in the front-rear direction so that the ice storage bucket 800 to be described later can be drawn into or drawn out of the ice making compartment 60.

The first opening 6141 communicates with a second opening 6301 of the entrance wall 630 to be described later, and thus the front of the ice making compartment 60 is opened.

Protrusion pieces 6142 protruding to the rear may be formed at the upper end and the left end of the first front plate 614, respectively. A first fitting hole 6143 penetrated in the up-down direction may be formed in the protruding piece 6142.

A fastening piece 6144 may be formed on the rear surface of the lower left side of the first front plate 614.

The first rear plate 615 may be formed integrally at the rear ends of the first lower plate 611, the first side plate 612, and the first coupling plate 613.

The first rear plate 615 may be formed in an “L”-shape when viewed from the rear. The lower end, the right end, and the upper end of the first rear plate 615 may be integrally formed at the rear ends of the first lower plate 611, the first side plate 612, and the first coupling plate 613, respectively.

A bent plate 6122 extending from the first side plate 612 to the left may be formed at the lower part of the first coupling plate 613.

A left end of the bent plate 6122 may be bent downward. The left end of the bent plate 6122 may protrude less to the left with respect to the first side plate 612 than the left end of the first coupling plate 613.

A first fitting groove 6123 may be formed between the first coupling plate 613 and the bent plate 6122.

The first fitting groove 6123 is formed over the front side, the left side, and the rear side between the first coupling plate 613 and the bending plate 6122, and the front side, the left side, and the rear side of the first fitting groove 6123 are opened.

In addition, a second fitting groove 6118 may be formed between the first lower plate 611 and the flange 6115.

The second fitting groove 6118 is formed over the front side, the left side, and the rear side between the first lower plate 611 and the flange 6115, and the front side, the left side, and the rear side of the second fitting groove 6118 are opened.

A first fitting portion 623 and a second fitting portion 625 of the inner partition wall 620 to be described later may be fitted into the first fitting groove 6123 and the second fitting groove 6118.

A first sealing member 618 may be provided on the first lower plate 611, the first side plate 612, and the first coupling plate 613.

The first sealing member 618 is disposed to surround the front upper surface of the first lower plate 611, the front left surface of the first side plate 612, and the lower surface of the front end of the first coupling plate 613. When the inner partition wall 620 to be described later and the entrance wall 630 to be described later are coupled to the outer partition wall 610, an outer edge of a second front plate 626 of the inner partition wall 620 and an outer edge of a rear edge plate 633 of the entrance wall 630 may be in close contact with the first sealing member 618.

The first sealing member 618 may be made of a sponge and may be attached to the first lower plate 611, the first side plate 612, and the first coupling plate 613.

The first sealing member 618 may be interposed between the outer partition wall 610 and the inner partition wall 620 and between the outer partition wall 610 and the entrance wall 630 to seal a joint between the front of the outer partition wall 610, the front end of the inner partition wall 620, and the rear end of the entrance wall 630.

A second sealing member 619 may be provided on the first side plate 612.

The second sealing member 619 may be disposed on the left side of the rear end of the first side plate 612 to elongate in the up-down direction. When the inner partition wall 620 is coupled to the outer partition wall 610, a right end of a second rear plate 627 of the inner partition wall 620 may be attached to the second sealing member 619.

The second sealing member 619 may be made of a sponge in the same manner as the first sealing member 618 and may be attached to the first side plate 612.

The second sealing member 619 may be interposed between the outer partition wall 610 and the inner partition wall 620 to seal a joint between the rear end of the outer partition wall 610 and the rear end of the inner partition wall 620.

The inner partition wall 620 may be coupled to the outer partition wall 610 thus configured.

The inner partition wall 620 may be coupled to the outer partition wall 610 so that the thermal insulation material accommodating space 601, into which the thermal insulation material 110 injected into the space portion 102 from the outside of the main body 10 can be injected, is provided between the inner partition wall 620 and the outer partition wall 610.

The inner partition wall 620 may be coupled to the inside of the outer partition wall 610 and may be configured to form the lower inner surface and the right inner surface of the ice making compartment 60. The inner partition wall 620 may include a second lower plate 621, a second side plate 622 extending upward over an entire right end of the second lower plate 621, a first fitting portion 623 formed at an upper end of the second side plate 622, a second coupling plate 624 extending downward over an entire left end of the second lower plate 621, a second fitting portion 625 extending to the right over an entire lower end of the second coupling plate 624, a second front plate 626 integrally formed at front ends of the second lower plate 621, the second side plate 622, the first fitting portion 623, the second coupling plate 624, and the second fitting portion 625, and a second rear plate 627 integrally formed at rear ends of the second lower plate 621, the second side plate 622, the first fitting portion 623, the second coupling plate 624, and the second fitting portion 625.

The second lower plate 621 may be configured to form an inner bottom of the ice making compartment 60 and may be formed to elongate in the front-rear direction. Fourth fastening portions 6211 may be formed on the left and right sides of the rear end of the second lower plate 621, respectively.

The two fourth fastening portions 6211 may be fastened to the evaporator case 1000 to be described later.

The second side plate 622 may be integrally formed at the right end of the second lower plate 621.

The second side plate 622 may be formed to elongate in the front-rear direction. The second side plate 622 may have a vertically standing shape by extending upward from the right end of the second lower plate 621.

An upper central portion of the second side plate 622 may elongate in the front-rear direction and protrude to the left.

A fifth fastening portion 6221 and a first ice maker support portion 6222 may be formed on the left side of the upper end of the second side plate 622, i.e., on the left side of a protruding portion of the second side plate 622.

The first ice maker support portion 6222 may be configured to support one side of the ice maker 700 to be described later. The two first ice maker support portions 6222 may be spaced apart from each other in the front-rear direction.

A sixth fastening portion 6223 may be formed at the rear end of the second side plate 622.

The sixth fastening portion 6223 may be configured to fasten the evaporator case 1000 to be described later along with the fourth fastening portion 6211. The sixth fastening portion 6223 may be positioned directly on the fourth fastening portion 6211 formed at the right rear end of the second lower plate 621.

The first fitting portion 623 may be integrally formed at the upper end of the second side plate 622.

The first fitting portion 623 may be formed to extend to the right from the top of the protruding portion of the second side plate 622. A right central portion of the first fitting portion 623 elongates and is cut in the front-rear direction, and is penetrated in the up-down direction and at the same time is opened to the right.

Uncut front and rear portions of the first fitting portion 623 may protrude more to the right than the second side plate 622.

The first fitting portion 623 may be formed such that the front end is higher than the rear. The first fitting portion 623 may be formed such that the rear is more concave downward than the front end. The first fitting portion 623 may be coupled correspondingly to the first concave portion 6131 when coupled to the outer partition wall 610.

The second coupling plate 624 may be integrally formed at the left end of the second lower plate 621.

The second coupling plate 624 may be formed to elongate in the front-rear direction. The second coupling plate 624 may be formed to extend downward from the left end of the second lower plate 621.

The second concave portion 6241 matched with the second bead portion 220 of the inner case 200 may be formed on the second coupling plate 624.

The second concave portion 6241 may be formed in a concave shape to the right at the second coupling plate 624 so that the second bead portion 220 can be accommodated and matched. The second concave portion 6241 may be formed to elongate in the front-rear direction.

When the second concave portion 6241 couples the partition wall 600 to the inner case 200 together with the first concave portion 6131, the second concave portion 6241 allows the partition wall 600 to be assembled to a correct position through the match with the second bead portion 220.

The second concave portion 6241 may be formed such that the end surface at the front is inclined from right to left at it goes from the rear side to the front side, so as to correspond to the second bead portion 220. Hence, the second concave portion 6241 can be easily matched with the second bead portion 220.

A seventh fastening portion 6242 and a fifth insertion hole 6243 may be formed in the second concave portion 6241.

The second fitting portion 625 may be integrally formed at the lower end of the second coupling plate 624.

The second fitting portion 625 may be formed to extend to the right from the lower end of the second coupling plate 624. A right central portion of the second fitting part 625 elongates and is cut in the front-rear direction, and is penetrated in the up-down direction and at the same time is opened to the right.

Uncut front and rear portions of the second fitting portion 625 may protrude more to the right than the second side plate 622.

In addition, the right ends of the uncut front and rear portions of the second fitting portion 625 may be positioned on the same vertical line as the right ends of the uncut front and rear portions of the first fitting portion 623.

The second front plate 626 may be integrally formed at the front ends of the second lower plate 621, the second side plate 622, the first fitting portion 623, the second coupling plate 624, and the second fitting portion 625. The second rear plate 627 may be integrally formed at the rear ends of the second lower plate 621, the second side plate 622, the first fitting portion 623, the second coupling plate 624, and the second fitting portion 625.

The outer partition wall 610 and the inner partition wall 620 may be coupled to form the partition wall 600 while providing the thermal insulation material accommodating space 601 therein. The partition wall 600 may be fastened to the inner case 200 to form the ice making compartment 60 such that the first concave portion 6131 is fitted to and matched with the first bead portion 210, and the second concave portion 6241 is fitted to and matched with the second bead portion 220.

A first protrusion 6136 having a first through hole 6136a may be formed on one of the first bead portion 210 and the first concave portion 6131, and a first inlet port 210a into which the first protrusion 6136 is inserted may be formed on the other. A second protrusion 6244 having a second through hole 6244a may be formed on one of the second bead portion 220 and the second concave portion 6241, and a second inlet port 220a into which the second protrusion 6244 is inserted may be formed on the other.

For example, the first inlet port 210a may be formed in the first bead portion 210, and the second inlet port 220a may be formed in the second bead portion 220. The first protrusion 6136 may be formed in the first concave portion 6131, and the second protrusion 6244 may be formed in the second concave portion 6241.

The first inlet port 210a may be formed in the first bead portion 210.

The first inlet port 210a may be a rectangular hole penetrating vertically the first bead portion 210. Two first inlet ports 210a may be positioned to be spaced apart from each other at the front and rear. The number of first inlet ports 210a may vary, if necessary.

The first inlet port 210a is disposed between the space portion 102 between the upper wall of the outer case 100 and the upper wall of the inner case 200 and the thermal insulation material accommodating space 601 of the partition wall 600 to communicate the space portion 102 and the thermal insulation material accommodating space 601.

The second inlet port 220a may be formed in the second bead portion 220.

The second inlet port 220a may be a rectangular hole penetrating horizontally the second bead portion 220. Two second inlet ports 220a may be positioned to be spaced apart from each other at the front and rear. The number of second inlet ports 220a may vary in the same manner as the first inlet port 210a, if necessary.

The second inlet port 220a is disposed between the space portion 102 between the left wall of the outer case 100 and the left wall of the inner case 200 and the thermal insulation material accommodating space 601 of the partition wall 600 to communicate the space portion 102 and the thermal insulation material accommodating space 601.

The first protrusion 6136 inserted into the first inlet port 210a may be integrally formed in the first concave portion 6131.

The first protrusion 6136 may be formed to protrude upward from the first concave portion 6131. The two first protrusions 6136 may be formed to be spaced apart back and forth to correspond to the number of first inlet ports 210a. The number of first protrusions 6136 may change in response to changes in the number of first inlet ports 210a.

Two first ribs 6137 that is spaced apart side to side may be integrally formed on the front surface of the first protrusion 6136 to reinforce the first protrusion 6136.

A first through hole 6136a penetrating vertically may be formed inside the first protrusion 6136.

The first through hole 6136a may communicate with the internal space of the partition wall 600, that is, the thermal insulation material accommodating space 601 between the first side plate 612 and the second side plate 622.

The first through hole 6136a may serve to communicate the space portion 102 between the upper wall of the outer case 100 and the upper wall of the inner case 200 with the thermal insulation material accommodating space 601 between the first side plate 612 and the second side plate 622 of the partition wall 600, in the same manner as the first inlet port 210a.

When the first bead portion 210 and the first concave portion 6131 are matched, the respective first protrusions 6136 may be inserted into the corresponding first inlet ports 210a. The space portion 102 between the upper wall of the outer case 100 and the upper wall of the inner case 200 may communicate with the thermal insulation material accommodating space 601 between the first side plate 612 and the second side plate 622 through the first inlet port 210a and the first through hole 6136a.

The second protrusion 6244 inserted into the second inlet port 220a may be integrally formed in the second concave portion 6241.

The second protrusion 6244 may be formed to protrude to the left from the second concave portion 6241. The two second protrusions 6244 may be formed to be spaced apart back and forth to correspond to the number of second inlet ports 220a. The number of second protrusions 6244 may change in response to changes in the number of second inlet ports 220a.

Two second ribs 6245 that is spaced apart up and down may be integrally formed on the front surface of the second protrusion 6244 to reinforce the second protrusion 6244.

A second through hole 6244a penetrating horizontally may be formed inside the second protrusion 6244.

The second through hole 6244a may communicate with the internal space of the partition wall 600, that is, the thermal insulation material accommodating space 601 between the first lower plate 611 and the second lower plate 621.

The second through hole 6244a may serve to communicate the space portion 102 between the left wall of the outer case 100 and the left wall of the inner case 200 with the thermal insulation material accommodating space 601 between the first lower plate 611 and the second lower plate 621 of the partition wall 600, in the same manner as the second inlet port 220a.

When the second bead portion 220 and the second concave portion 6241 are matched, the respective second protrusions 6244 may be inserted into the corresponding second inlet ports 220a. The space portion 102 between the left wall of the outer case 100 and the left wall of the inner case 200 may communicate with the thermal insulation material accommodating space 601 between the first lower plate 611 and the second lower plate 621 through the second inlet port 220a and the second through hole 6244a.

A first coupling hole 212 may be formed in the first bead portion 210.

The first coupling hole 212 may be a hole formed to pass through the first bead portion 210 in the up-down direction. A total of four first coupling holes 212 may be formed in the first bead portion 210 for fastening between the inner case 200 and the partition wall 600. The first coupling holes 212 may be disposed one at a time on the front and rear sides of each first inlet port 210a.

A second coupling hole 222 may be formed in the second bead portion 220.

The second coupling hole 222 may be a hole formed to pass through the second bead portion 220 in the left-right direction. A total of four second coupling holes 222 may be formed in the second bead portion 220 for fastening between the inner case 200, the partition wall 600, and the installation wall 640 to be described later. The second coupling holes 222 may be disposed one at a time on the front and rear sides of each second inlet port 220a.

A third coupling hole 213 may be formed in the upper wall of the inner case 200.

The third coupling hole 213 may be a hole formed to penetrate in the up-down direction. One third coupling hole 213 may be provided in the upper wall of the inner case 200 so that it is positioned on the front side of the first bead portion 210 for fastening between the inner case 200, the entrance wall 630 to be described later, and an installation wall to be described later.

A fourth coupling hole 223 may be formed in the left wall of the inner case 200.

The fourth coupling hole 223 may be a hole formed to penetrate in the left-right direction. Two fourth coupling hole 223 may be positioned to be vertically spaced apart on the upper left wall of the inner case 200 for fastening between the inner case 200, the entrance wall 630 to be described later, and an installation wall to be described later.

A first ice making water inlet hole 214 may be formed in a rear left portion of the upper wall of the inner case 200.

The first ice making water inlet hole 214 may be formed to pass through the upper wall of the inner case 200 in the up-down direction to allow an ice making water supplied from the water supply tank (not shown) to flow into the ice maker 700 to be described later.

A harness housing installation hole 224 may be formed in the left wall of the inner case 200.

The harness housing installation hole 224 may be a hole in which a harness housing 205 is mounted. It may be formed on the rear side of the fourth coupling hole 223.

The entrance wall 630 may be coupled to the front portion of the partition wall 600.

The entrance wall 630 may be configured to form an entrance portion of the ice making compartment 60. The entrance wall 630 may be formed in a rectangular parallelepiped shape as a whole. The inlet wall 630 may have a second opening 6301 that passe through the central portion in the front-rear direction.

The entrance wall 630 may be coupled between the first front plate 614 of the outer partition wall 610 and the second front plate 626 of the inner partition wall 620.

The entrance wall 630 may include a peripheral plate 631, a front edge plate 632 formed at a front end of the peripheral plate 631, and a rear edge plate 633 formed at a rear end of the peripheral plate 631.

The peripheral plate 631 may be formed in a rectangular parallelepiped box shape that is penetrated in the front-rear direction as a whole.

The peripheral plate 631 may be formed in a stepped shape in which a front peripheral surface protrudes outward.

A first connection plate 6311 connecting a rear surface of the front edge plate 632 and a front surface of the rear edge plate 633 may be integrally formed on an upper surface of an upper wall of the peripheral plate 631. A second connection plate 6312 connecting an upper end of the front edge plate 632 and an upper end of the rear edge plate 633 may be integrally formed at an upper end of the first connection plate 6311.

The first connection plate 6311 may be formed in a vertically standing state on an upper surface of the upper part of the peripheral plate 631. The second connection plate 6312 may be formed to extend to the right from the upper end of the first connection plate 6311.

The second connection plate 6312 may be spaced apart from the upper part of the peripheral plate 631 in the up-down direction.

A first fitting piece 6313 may be formed at a front end of the upper surface of the second connection plate 6312. A second fitting piece 6314 may be formed at a front end of a left outer surface of the peripheral plate 631.

A third fitting piece 6315 may be formed in the center of the upper surface of the second connection plate 6312. A fourth fastening hole 6318 may be formed on the left side of the third fitting piece 6315.

An eighth fastening portion 6316 may be formed on the upper surface of the second connection plate 6312. A ninth fastening part 6317 may be formed on the left surface of the left side of the peripheral plate 631.

An ice guide portion 6319 protruding downward may be formed on the lower surface of the lower side of the peripheral plate 631.

A lower end of the ice guide portion 6319 may be formed to have the same inclination as the inclination plate 6111 of the first lower plate 611.

As the inside of the ice guide portion 6319 is penetrated in the up-down direction, an upper end of the ice guide portion 6319 may communicate with the second opening 6301, and a lower end of the ice guide portion 6319 may communicate with the ice discharge port 6113.

When the entrance wall 630 is coupled to the partition wall 600, the lower end of the ice guide portion 6319 may be inserted into the ice discharge port 6113 of the partition wall 600.

The front edge plate 632 may be integrally formed at the front end of the peripheral plate 631.

The front edge plate 632 may be formed to extend outward along the perimeter of the front end of the peripheral plate 631 from the front end of the peripheral plate 631.

The front edge plate 632 may be formed in a shape bent outward with respect to the peripheral plate 631.

A magnet accommodating groove 6321 may be formed on the front surface of the front edge plate 632.

The magnet accommodating groove 6321 may be a groove formed concavely from the front side to the rear side of the front edge plate 632. A magnet may be provided inside the magnet accommodating groove 6321.

When the entrance wall 630 is coupled to the partition wall 600, the front border plate 632 may be in close contact with and fixed to the rear surface of the first front plate 614 of the partition wall 600 while having a magnet (not shown) in the magnet accommodating groove 6321.

The magnet included in the magnet accommodating groove 6321 may allow the ice making compartment door 810 of the ice storage bucket 800 to be easily attached to the first front plate 614 by attraction with a magnet included in the ice making compartment door 810 of the ice storage bucket 800 to be described later.

The rear edge plate 633 may be integrally formed at the rear end of the peripheral plate 631.

The rear edge plate 633 may be formed to extend outward along the perimeter of the rear end of the peripheral plate 631 from the rear end of the peripheral plate 631.

The rear edge plate 633 may be formed in a shape bent outward with respect to the peripheral plate 631.

A thermal insulation material insertion space 6302 may be formed between the front edge plate 632 and the rear edge plate 633.

The thermal insulation material insertion space 6302 may be a space into which an entrance wall thermal insulation material 634 for thermal insulation of the front side of the ice making compartment 60 is inserted before the entrance wall 630 is coupled to the installation wall 640 to be described later. The thermal insulation material insertion space 6302 may be formed along an outer peripheral surface of the peripheral plate 631.

The entrance wall thermal insulation material 634 may be inserted into the thermal insulation material insertion space 6302 so as to cover the entire outer peripheral surface of the peripheral plate 631.

When the first fitting piece 6313 of the entrance wall 630 is inserted into the first fitting hole 6143 of the partition wall 600 and the entrance wall 630 is fixed to the partition wall 600, the front surface of the front edge plate 632 and the rear surface of the rear edge plate 633 may be in close contact with and fixed to the rear surface of the first front plate 614 and the front surface of the second front plate 626, respectively.

The installation wall 640 may be coupled to the partition wall 600 and the entrance wall 630 coupled to each other.

The installation wall 640 may be a configuration for installation of harnesses connected to various drivers, guides for the draw in and out of the ice storage bucket 800, and installation of the ice maker 700. The installation wall 640 may be fastened and coupled to the inner surface of the upper wall and the inner surface of the left wall of the inner case 200 while being coupled to the partition wall 600.

One side of the installation wall 640 may be disposed to cover one side of the partition wall 600 and one side of the entrance wall 630. The other side of the installation wall 640 may be disposed to cover the other side of the partition wall 600 and the other side of the entrance wall 630.

The installation wall 640 may include an upper installation plate 641 coupled to the inner surface of the upper wall of the inner case 200, and a side installation plate 643 extending downward from a left end of the upper installation plate 641.

The upper installation plate 641 may be a plate elongating in the front-rear direction. The upper installation plate 641 may be installed to cover the first coupling plate 613 of the partition wall 600 and cover the upper part of the entrance wall 630.

In this case, the first concave portion 6131 of the partition wall 600 may not be covered by the upper installation plate 641.

A protruding plate 642 protruding to the right may be integrally formed at a front right end of the upper installation plate 641.

A second fitting hole 6421 having a rectangular shape penetrated in the up-down direction may be formed in the center of the protruding plate 642. A sixth insertion hole 6422 may be formed at the front left side of the second fitting hole 6421.

The second fitting hole 6421 may have a configuration in which the third fitting piece 6315 of the inlet wall 630 coupled to the partition wall 600 is fitted. The second fitting hole 6421 may serve to accurately set a fastening position of the installation wall 640 before the installation wall 640 is fastened to the partition wall 600 and the entrance wall 630.

A seventh insertion hole 6411 may have a configuration in which the insertion protrusion 6133 of the partition wall 600 is inserted from the lower side to the upper side. The seventh insertion hole 6411 may perform the same function as the second fitting hole 6421.

A second ice making water inlet hole 6413 may be formed in the rear left portion of the upper installation plate 641.

The second ice making water inlet hole 6413 may be formed to pass through the upper installation plate 641 in the up-down direction so as to communicate with the first ice making water inlet hole 214 and may allow an ice making water supplied from the water supply tank (not shown) to flow into the ice maker 700 to be described later.

An ice maker mounting groove 6414 may be formed on the front side of the upper installation plate 641.

The ice maker mounting groove 6414 may have a component in which an elastic piece 713 included in the ice maker 700 is inserted and mounted when the ice maker 700 to be described later is installed in the ice making compartment 60.

The side installation plate 643 may be integrally formed at the left end of the upper installation plate 641.

The side installation plate 643 may be a plate elongating in the front-rear direction. The side installation plate 643 may extend downward from the left end of the upper installation plate 641.

The side installation plate 643 may be installed to cover the second coupling plate 624 of the partition wall 600 and to cover the left side of the entrance wall 630 at the same time.

The side installation plate 643 includes the second concave portion 6241 of the partition wall 600 and may be disposed to cover the entire second coupling plate 624.

An intervening portion 6431 may be formed at the lower end of the side installation plate 643.

The intervening portion 6431 may be interposed between the second bead portion 220 and the second concave portion 6241 when the second bead portion 220 and the second concave portion 6241 are matched. The intervening portion 6431 may be concave when viewed from the left side. The intervening portion 6431 may be convex when viewed from the right side. The left side of the intervening portion 6431 may be matched with the second bead portion 220, and at the same time, the right side of the intervening portion 6431 may be matched with the second concave portion 6241.

The intervening portion 6431 may include an intervening hole 6431a having the same shape as the second inlet port 220a of the inner case 200. Two intervening holes 6431a may be spaced apart from each other in the front-rear direction to correspond to the second inlet ports 220a.

The intervening portion 6431 may include a ninth insertion hole 6432 and a tenth insertion hole 6433.

An eleventh insertion hole 6434 may be formed at the lower front end of the side installation plate 643.

A twelfth insertion hole 6435 may be formed in the side installation plate 643 to be disposed on the upper rear side of the eleventh insertion hole 6434.

A second ice maker support portion (not shown) may be formed in an upper central portion of the side installation plate 643.

The second ice maker support portion (not shown) may be configured to support other side of the ice maker 700 to be described later. The two second ice maker support portion (not shown) may be formed to protrude from the right side of the side installation plate 643 to the right and may be spaced apart from each other in the front-rear direction.

A harness installation hole 6437 may be formed in the central portion of the side installation plate 643.

The harness installation hole 6437 may be a hole for installing a harness of the respective components in the ice making compartment 60 that requires the electrical connection.

A harness cover 644 may be provided in the harness installation hole 6437.

The harness cover 644 may serve to close the harness installation hole 6437, and at the same time guide the forward and backward sliding movement of the ice storage bucket 800 that is drawn into and drawn out of the ice making compartment 60.

One side of the harness cover 644 may be supported by hanging on the left side of the side installation plate 643 behind the harness installation hole 6437, and the other side of the harness cover 644 may be fixed to the installation wall 640 by being fastened to the right side of the side installation plate 643 in front of the harness installation hole 6437.

The installation wall 640 may be coupled to the inner case 200 while being coupled to the partition wall 600 and the entrance wall 630 to form the ice making compartment 60. The partition wall 600, the entrance wall 630, and the installation wall 640 that are coupled to each other may be provided with the third sealing member 650 before being coupled to the inner case 200, and then may be coupled to the inner case 200.

The third sealing member 650 may be disposed over the upper surface of the installation wall 640, the upper surface of the partition wall 600, the rear surface of the partition wall 600, and the left side of the installation wall 640.

The third sealing member 650 may be made of a sponge and may be provided in a state in which it is attached to the partition wall 600 and the installation wall 640.

The third sealing member 650 may be disposed in a state of being interposed between the partition wall 600 and the inner case 200 and between the installation wall 640 and the inner case 200 and may be in close contact with an upper wall inner surface, a rear wall inner surface, and a left wall inner surface in the inner case 200. Hence, the third sealing member 650 can serve to seal a joint between the partition wall 600, the installation wall 640, and the inner case 200 that are coupled to each other.

In addition, the third sealing member 650 may be disposed in a state of being interposed between the partition wall 600 and the inner case 200 and between the installation wall 640 and the inner case 200 while surrounding the first protrusion 6136 and the second protrusion 6244, and may perform the sealing operation. Therefore, the third sealing member 650 can prevent the thermal insulation material 110, that is injected into the space portion 102 from the outside of the main body 10 and then is injected into the thermal insulation material accommodating space 601 through the first through hole 6136a of the first protrusion 6136 and the second through hole 6244a of the second protrusion 6244, from leaking.

A method of manufacturing the ice making compartment by assembling the inner case 200, the outer partition wall 610, the inner partition wall 620, the entrance wall 630, and the installation wall 640 may be as follows.

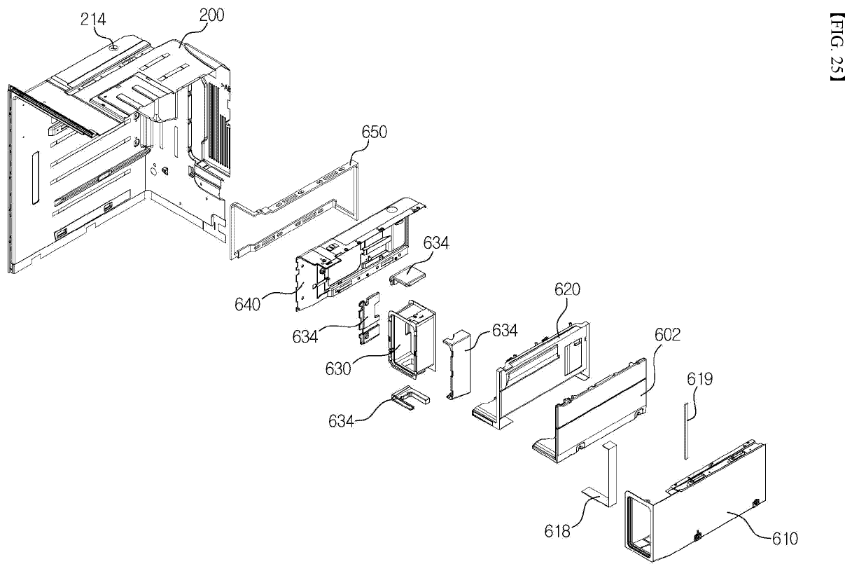

Referring to FIGS. 25 to 30, the partition wall 600 may be provided by temporarily fixing the outer partition wall 610 and the inner partition wall 620 to each other.

In this instance, a partition wall thermal insulation material 602, the first sealing member 618, and the second sealing member 619 may be provided by being previously attached to the outer partition wall 610 before temporarily fixing the outer partition wall 610 and the inner partition wall 620. Afterwards, the first fitting portion 623 of the inner partition wall 620 may be fitted into the first fitting groove 6123 of the outer partition wall 610. The second fitting portion 625 of the inner partition wall 620 may be fitted into the second fitting groove 6118 of the outer partition wall 610. The fifth fastening portion 6221 of the inner partition wall 620 may be fitted into the fourth insertion hole 6134 of the outer partition wall 610. The right side of the fifth insertion hole 6243 of the inner partition wall 620 may be in close contact with the left side of the first fastening portion 6116 of the outer partition wall 610.

As described above, the partition wall 600 may be formed in a state in which before the outer partition wall 610 and the inner partition wall 620 are temporarily fixed.

Next, the entrance wall thermal insulation material 634 may be provided on the entrance wall 630. The entrance wall 630 with the entrance wall thermal insulation material 634 may be temporarily fixed to the outer partition wall 610 and the inner partition wall 620 that are temporarily fixed to each other.

In this instance, the entrance wall thermal insulation material 634 may be inserted into the thermal insulation material insertion space 6302 formed in the entrance wall 630 along the outer peripheral surface of the entrance wall 630. Thereafter, the first fitting piece 6313 of the entrance wall 630 may be fitted into the first fitting hole 6143 formed at the upper side of the first front plate 614 of the outer partition wall 610. The second fitting piece 6314 of the entrance wall 630 may be fitted into the first fitting hole 6143 formed on the left side of the first front plate 614 of the outer partition wall 610. In this way, the entrance wall 630 can be temporarily fixed to the front side of the partition wall 600.

Next, the installation wall 640 may be temporarily fixed to the outer partition wall 610, the inner partition wall 620, and the entrance wall 630 that are temporarily fixed to each other.

In this instance, the seventh insertion hole 6411 of the installation wall 640 may be fitted into the insertion protrusion 6133 of the outer partition wall 610. The tenth insertion hole 6433 of the installation wall 640 may be fitted into the seventh fastening portion 6242 of the inner partition wall 620. The sixth insertion hole 6422 of the installation wall 640 may be fitted into the eighth fastening portion 6316 of the entrance wall 630. The second fitting hole 6421 of the installation wall 640 may be fitted into the third fitting piece 6315 of the entrance wall 630. The twelfth insertion hole 6435 of the installation wall 640 may be fitted into the ninth fastening portion 6317 of the entrance wall 630. In this way, the installation wall 640 can be temporarily fixed to the outer partition wall 610, the inner partition wall 620, and the entrance wall 630 that are temporarily fixed to each other.

Next, the outer partition wall 610, the inner partition wall 620, the entrance wall 630, and the installation wall 640 that are temporarily fixed to each other can be fastened and fixed using a fastening member.

In this instance, a fastening member may be inserted into the ninth insertion hole 6432 of the installation wall 640 and fastened to the first fastening portion 6116 of the outer partition wall 610 through the fifth insertion hole 6243 of the inner partition wall 620. A fastening member may be inserted into an eighth insertion hole 6412 of the installation wall 640 and fastened to the fifth fastening portion 6221 of the inner partition wall 620 inserted into the fourth insertion hole 6134 of the outer partition wall 610 and the fourth fastening hole 6318 of the entrance wall 630. A fastening member may be inserted into the eleventh insertion hole 6434 of the installation wall 640 and fastened to the fastening piece 6144 of the outer partition wall 610. In this way, the outer partition wall 610, the inner partition wall 620, the entrance wall 630, and the installation wall 640 that are temporarily fixed to each other can be fixed to each other.

The outer partition wall 610, the inner partition wall 620, the entrance wall 630, and the installation wall 640 fixed to each other in this way may be provided in an opened rectangular parallelepiped shape in the front-rear direction as a whole.

Next, the first concave portion 6131 of the partition wall 600 may be disposed by being matched with the first bead portion 210 of the inner case 200 of the main body 10, and the intervening portion 6431 of the installation wall 640 and the second concave portion 6241 of the partition wall 600 may be disposed by being matched with the first bead portion 210 of the inner case 200, thereby setting the exact assembly position. And then, the outer partition wall 610, the inner partition wall 620, the entrance wall 630, and the installation wall 640 fixed to each other may be fastened and fixed to the inner case 200 by means of the fastening members.

In this instance, the third sealing member 650 may be interposed between the inner case 200 and the partition wall 600 and between the inner case 200 and the installation wall 640. A fastening member may be inserted into the first coupling hole 212 of the inner case 200 and fastened to the third coupling hole 6135 of the outer partition wall 610. A fastening member may be inserted into the second coupling hole 222 of the inner case 200 and fastened to the seventh fastening portion 6242 of the inner partition wall 620 through the tenth insertion hole 6433 of the installation wall 640. A fastening member may be inserted into the third coupling hole 213 of the inner case 200 and fastened to the eighth fastening portion 6316 of the inlet wall 630 through the sixth insertion hole 6422 of the installation wall 640. A fastening member may be inserted into the fourth coupling hole 223 of the inner case 200 and fastened to the ninth fastening portion 6317 of the inlet wall 630 through the twelfth insertion hole 6435 of the installation wall 640. In this way, the outer partition wall 610, the inner partition wall 620, the entrance wall 630, and the installation wall 640 fixed to each other can be fastened and fixed to the inner case 200.

As described above, the first bead portion 210 and the first concave portion 6131 may be fixed to the inner case 200 while they are matched with each other, and the second bead portion 220 and the second concave portion 6241 may be fixed to the inner case 200 while they are matched with each other. The intervening portion 6431 may be interposed between the second bead portion 220 and the second concave portion 6241 and may be fixed to the inner case 200 while it is matched with the second bead portion 220 and the second concave portion 6241.

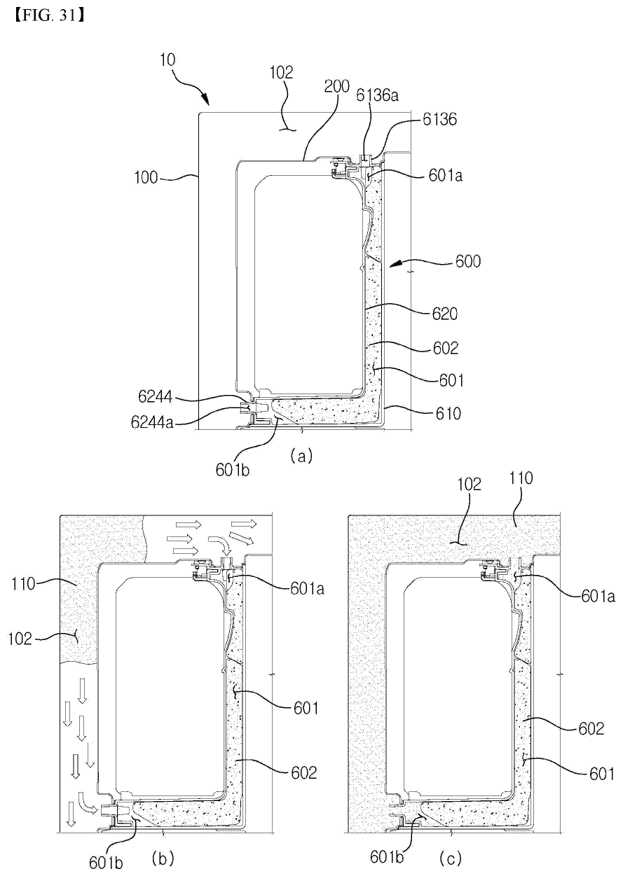

Next, as illustrated in (b) of FIG. 31, the thermal insulation material 110 may be injected into the space portion 102 between the outer case 100 and the inner case 200.

In this instance, the thermal insulation material 110 may be supplied from the outside of the main body 10 and injected into the space portion 102. The thermal insulation material 110 injected into the space portion 102 may flow in the space portion 102.

Next, as illustrated in (c) of FIG. 31, the thermal insulation material 110 flowing in the space portion 102 may be injected into the thermal insulation material accommodating space 601 of the partition wall 600 through the first inlet port 210a and the first through hole 6136a and may be injected into the thermal insulation material accommodating space 601 of the partition wall 600 through the second inlet port 220a and the second through hole 6244a.

Next, an integral foaming process of the thermal insulation material 110 is performed, and thus the thermal insulation material 110 may expand and harden.

In this instance, the thermal insulation material 110 may be integrally foamed into the space portion 102 and the thermal insulation material accommodating space 601 and may serve to integrally fix the main body 10 and the partition wall 600. After integrally foaming the thermal insulation material 110, the partition wall 600 may be inseparable from the main body 10.

Through the above-described process, the partition wall 600, the entrance wall 630, and the installation wall 640 may be fastened and fixed to the inner case 200 by means of the fastening members. The partition wall 600, the entrance wall 630, and the installation wall 640 that are fixed and installed to the inner case 200 as described above may form the ice making compartment 60 partitioned as a thermal insulation space separate from the refrigerator compartment 11 at the upper left corner of the inner case 200.

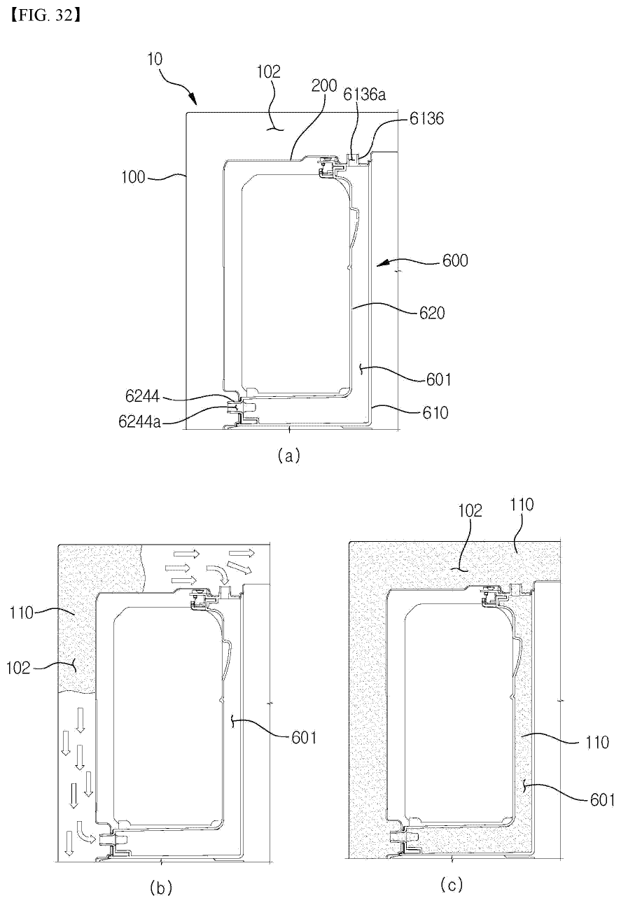

As illustrated in FIGS. 31 and 32, the thermal insulation material 110 may be injected and integrally foamed between the outer case 100 and the inner case 200 and at least a portion of the partition wall 600.

The thermal insulation material 110 may be injected into the space portion 102 of the main body 10 from the outside of the main body 10, i.e., the space portion 102 between the outer case 100 and the inner case 200. The thermal insulation material 110 injected into the space portion 102 may flow through the space portion 102 and may be injected into at least a portion of the thermal insulation material accommodating space 601 inside the partition wall 600. Then, the thermal insulation material 110 injected into the space portion 102 and the thermal insulation material accommodating space 601 may be integrally foamed.

As described above, the partition wall 600 may be assembled to the inner case 200 by the fastening members so that the first concave portion 6131 and the second concave portion 6241 are respectively matched with the first bead portion 210 and the second bead portion 220.

The first protrusion 6136 and the second protrusion 6244 may inserted into the first inlet port 210a and the second inlet port 220a, respectively.

In such a state, the thermal insulation material 110, that is a liquid foaming liquid such as urethane, may be injected into the space portion 102 of the main body 10 from the outside of the main body 10 for the thermal insulation between the inside (e.g., the ice making compartment, the refrigerator compartment, the freezer compartment, and the specialized compartment) of the inner case 200 and the outside (e.g., the outside of the main body) of the outer case 100.

In this way, the thermal insulation material 110 injected into the space portion 102 of the main body 10 may flow along the space portion 102 and may be injected into the thermal insulation material accommodating space 601 between the first side plate 612 and the second side plate 622 through the first inlet port 210a and the first through hole 6136a. Further, the thermal insulation material 110 may be injected into the thermal insulation material accommodating space 601 between the first lower plate 611 and the second lower plate 621 through the second inlet port 220a and the second through hole 6244a, and thus may be injected into at least a portion of the thermal insulation material accommodating space 601 of the partition wall 600.

In such a state, as the thermal insulation material 110 is integrally foamed and expands, the thermal insulation material 110 may integrally harden and fill from the space portion 102 between the outer case 100 and the inner case 200 to at least a part of the thermal insulation material accommodating space 601 of the partition wall 600. Hence, the partition wall 600 may be in an integral state that is inseparable from the main body 10, so that the ice making compartment 60 can be partitioned into a thermal insulation space separate from the refrigerator compartment 11.

Referring to FIG. 31, the partition wall thermal insulation material 602 may be previously inserted into a portion of the thermal insulation material accommodating space 601 of the partition wall 600 before the thermal insulation material 110 is injected. For example, the partition wall thermal insulation material 602 may be previously inserted before the outer partition wall 610 and the inner partition wall 620 are coupled.

The partition wall thermal insulation material 602 may be inserted while leaving a predetermined space, in which the thermal insulation material 110 is to be injected in the thermal insulation material accommodating space 601, empty. For example, the partition wall thermal insulation material 602 may be provided including the lower right corner of the partition wall 600 in the thermal insulation material accommodating space 601.

As illustrated in (a) of FIG. 31, before the partition wall 600 is fastened to the inner case 200, the partition wall thermal insulation material 602 may be previously inserted into the thermal insulation material accommodating space 601, so that the partition wall 600 includes a first blank area 601a that communicates with the first through hole 6136a in a state of emptying a portion of the upper end between the first side plate 612 and the second side plate 622 in the thermal insulation material accommodating space 601, and a second blank area 601b that communicates with the second through hole 6244a in a state of emptying a portion of the left end between the first lower plate 611 and the second lower plate 621 in the thermal insulation material accommodating space 601.

That is, the partition wall 600 may include the first blank area 601a and the second blank area 601b that are spaces in which the partition wall thermal insulation material 602 is not present in the thermal insulation material accommodating space 601.

Next, as illustrated in (b) of FIG. 31, the partition wall 600 may be fastened to the inner case 200 while including the partition wall thermal insulation material 602 therein. In a state in which the partition wall 600 is fastened to the inner case 200, the thermal insulation material 110 may be injected into the space portion 102 of the main body 10 from the outside of the main body 10. The thermal insulation material 110 injected into the space portion 102 may flow through the space portion 102.

Next, as illustrated in (c) of FIG. 31, the thermal insulation material 110 injected into the space portion 102 of the main body 10 may flow through the space portion 102 and may be injected into the first blank area 601a through the first through hole 6136a of the first protrusion 6136 inserted into the first inlet port 210a. As illustrated in (c) of FIG. 31, the thermal insulation material 110 injected into the space portion 102 of the main body 10 may flow through the space portion 102 and may be injected into the second blank area 601b through the second through hole 6244a of the second protrusion 6244 inserted into the second inlet port 220a.

Next, by integrally foaming the thermal insulation material 110 injected into the space portion 102, the first blank area 601a, and the second blank area 601b, the partition wall thermal insulation material 602 can be provided in the thermal insulation material accommodating space 601, and the thermal insulation material 110 can also be integrally provided in the space portion 102 and the thermal insulation material accommodating space 601.

Referring to FIG. 32, the thermal insulation material accommodating space 601 of the partition wall 600 may be completely filled with only the thermal insulation material 110 injected into the space portion 102 from the outside of the main body 10 without the partition wall thermal insulation material 602 that has been previously inserted.

As illustrated in (a) of FIG. 32, the partition wall 600 before being fastened to the inner case 200 may be in a state in which the thermal insulation material accommodating space 601 is all empty.

That is, the thermal insulation material accommodating space 601 may be an empty space in which the partition wall thermal insulation material 602 is not present.

Next, as illustrated in (b) of FIG. 32, the partition wall 600 may be fastened to the inner case 200. In this state, the thermal insulation material 110 may be injected into the space portion 102 of the main body 10 from the outside of the main body 10 and flow.

Next, as illustrated in (c) of FIG. 32, the thermal insulation material 110 injected into the space portion 102 of the main body 10 may flow through the space portion 102 and may be injected into the thermal insulation material accommodating space 601 through the first through hole 6136a of the first protrusion 6136 inserted into the first inlet port 210a and through the second through hole 6244a of the second protrusion 6244 inserted into the second inlet port 220a. Hence, the thermal insulation material accommodating space 601 can be filled with the thermal insulation material 110.

In this instance, considering that the thermal insulation material 110 injected into the thermal insulation material accommodating space 601 is foamed later, the thermal insulation material 110 expanded after foaming may be injected in an appropriate amount only enough to fill all the thermal insulation material accommodating space 601.

Afterwards, the thermal insulation material 110 injected into the space portion 102 and the thermal insulation material accommodating space 601 is integrally foamed, and thus the thermal insulation material 110 can be integrally provided in all the space portion 102 and the thermal insulation material accommodating space 601.

The shelves 230, 240 and 250 may be provided inside the storage compartment.

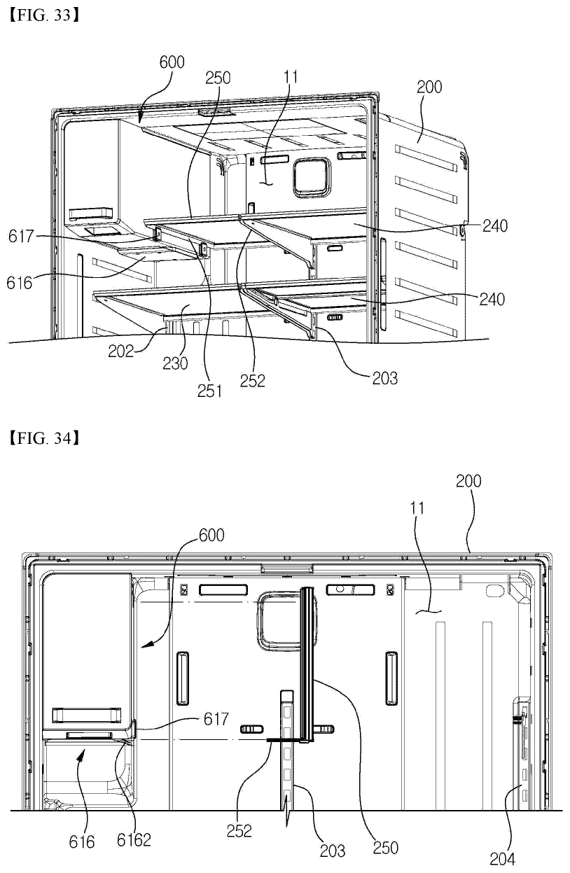

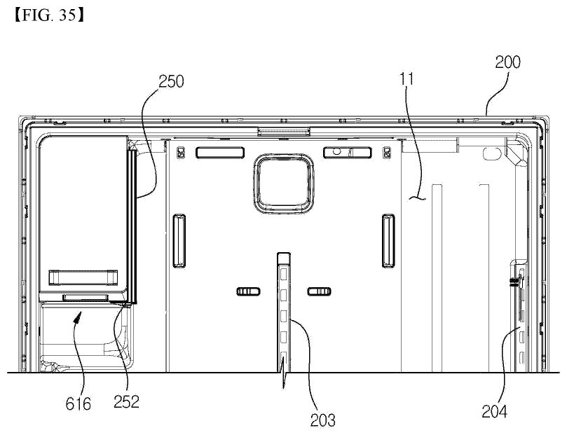

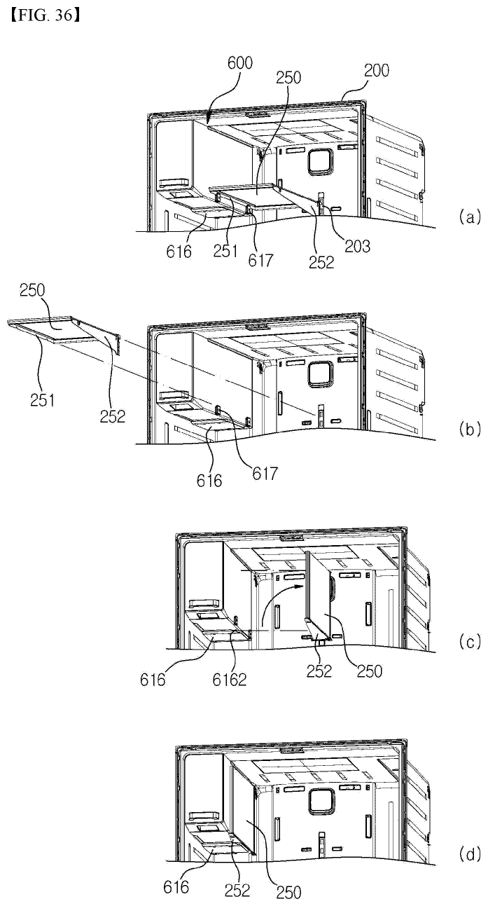

Referring to FIGS. 33 to 36, for example, the shelves 230, 240 and 250 may be provided in the refrigerator compartment 11 of the storage compartment. A plurality of shelves 230, 240 and 250 may be provided inside the refrigerator compartment 11.

A left bracket holder 202, a central bracket holder 203, and a right bracket holder 204 may be provided at each of left, central and right portions of the inner rear surface of the main body 10. The shelves 230, 240 and 250 may be provided with a hanger bracket that is coupled and hung thereto and may be fixedly installed.

These shelves 230, 240 and 250 may include, for example, a left shelf 230, a right shelf 240, and an ice making compartment shelf 250 adjacent to the ice making compartment 60.

One of the ice making compartment shelf 250 may be mounted on a shelf support piece 617 installed on the right side of the partition wall 600, and the other side thereof may be mounted on the central bracket holder 203 and provided on the left side of the refrigerator compartment 11 inside the main body 10.

The mounting and mounting structure of the ice making compartment shelf 250 are described in detail below.

More specifically, the ice making compartment shelf 250 may include a first hanger bracket 251 at a left end, and a second hanger bracket 252 at a right end.

When the ice making compartment shelf 250 is used, it may be horizontally mounted on the side of the ice making compartment 60 by the first hanger bracket 251 and the second hanger bracket 252. In addition, in the case of removing the ice making compartment shelf 250, the ice making compartment shelf 250 may be mounted in a standing state by detaching the ice making compartment shelf 250 and fitting and coupling the first hanger bracket 251 to the clearance space 6162 of a shelf holder 616 provided at the lower surface of the ice making compartment 60. Hence, it is possible to form a space capable of storing a bottle, etc. with a high height in the upper part of the left shelf 230 positioned under the ice making compartment shelf 250.

The ice maker 700 and the ice storage bucket 800 may be provided in the ice making compartment 60.

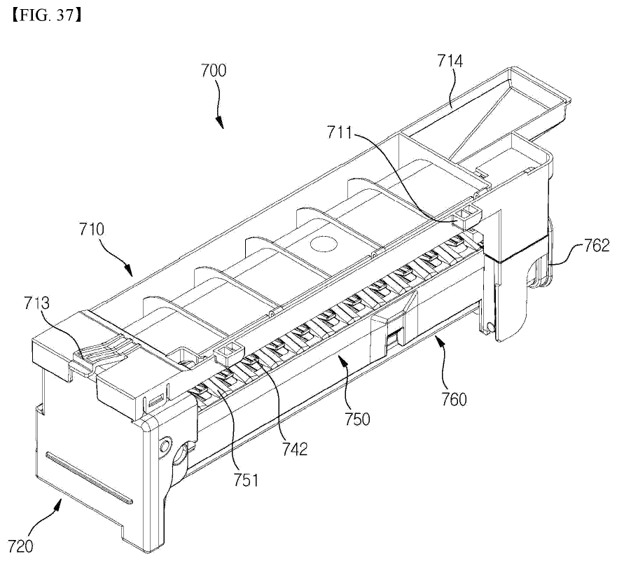

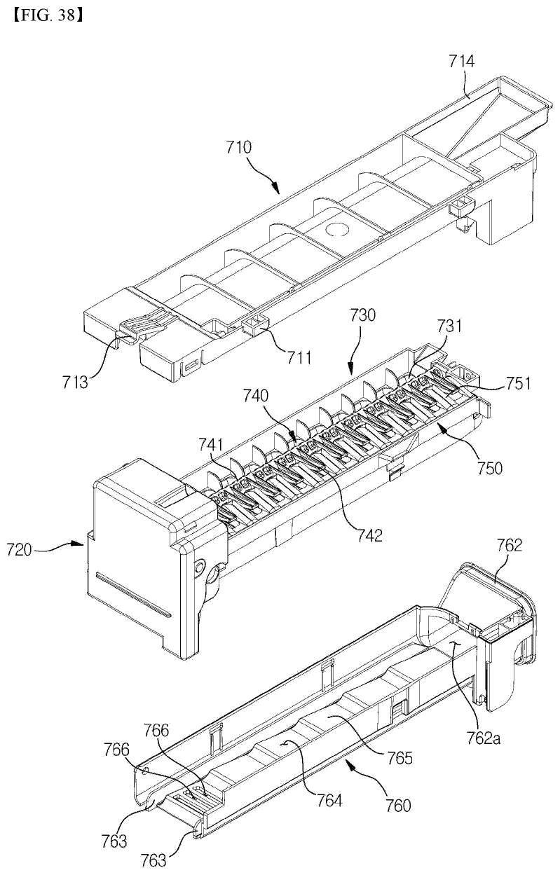

Referring to FIGS. 14 to 17, FIG. 37, FIG. 38, and FIG. 44, the ice maker 700 may be configured to generate ice. The ice maker 700 may be installed on the ice making compartment 60.

The ice maker 700 may include an upper housing 710, a driving device 720, an ice making mold 730, an ejector 740, a guider 750, a deicing heater (not shown), and a lower housing 760.

The upper housing 710 may be installed on the upper part inside the ice making compartment 60 such that a first mounting piece 711 and a second mounting piece (not shown) are provided and are placed on the first ice maker support portion 6222 and the second ice maker support portion (not shown) of the inner partition wall 620.

The elastic piece 713 may be formed at a front end of the upper housing 710.

The elastic piece 713 may be formed in the form of a hook protruding upward in the center of the front end of the upper housing 710.

The elastic piece 713 may be fitted into the ice maker mounting groove 6414 of the installation wall 640 when the ice maker 700 is installed in the ice making compartment 60, so that the ice maker 700 is fixed to the inside of the ice making compartment 60.

An ice making water guide portion 714 may be formed on the upper rear side of the upper housing 710.

The driving device 720 and the ice making mold 730 integrally formed with each other may be provided at a lower part of the upper housing 710. A front portion of the upper housing 710 may be coupled to the driving device 720, and a rear portion may be hook-coupled to the ice making mold 730.

The driving device 720 may be a device provided with components required to drive the ejector 740 to be described later and control the deicing heater (not shown) to be described later.

The ice making mold 730 may be configured to receive ice making water from a water supply tank (not shown) through the ice making water guide portion 714 and generate ice of a predetermined shape. The ice making mold 730 includes a plurality of unit molds 731 each having a space concave downward.

The ejector 740 may be installed between the driving device 720 and a rear end of the ice making mold 730.

The ejector 740 may be configured to release ice generated in each unit mold 731 of the ice making mold 730. A front end of the ejector 740 may be coupled to the driving device 720, and a rear end may be rotatably coupled to the rear end of the ice making mold 730, so that the ejector 740 can receive a rotational force through the driving device 720.

The ejector 740 includes an ejector shaft 741 and a plurality of ejector pins 742 that are formed on the ejector shaft 741 and correspond to the unit molds 731.

The ejector shaft 741 may be a shaft that is formed to elongate in the front-rear direction to be disposed in the upper center of the ice making mold 730 and rotates according to the operation of the driving device 720. A front end of the ejector shaft 741 may be rotatably coupled to the driving device 720, and a rear end may be rotatably coupled to a rear wall of the ice making mold 730.

When the ejector shaft 741 rotates clockwise, the ejector pin 742 may rotate clockwise together with the ejector shaft 741, and push the ice generated in the unit mold 731 from the unit mold 731 to separate the ice.

The guider 750 may be installed on the right side of the ice making mold 730.

The guider 750 may be coupled to the ice making mold 730 by fitting the lower right wall of the ice guider 750 into the upper right wall of the ice making mold 730.

The guider 750 may include an inclination guide portion 751 that protrudes obliquely from the upper end of the right wall to the upper left portion. The guider 750 may include a plurality of inclination guide portions 751 that are disposed to be spaced apart from each other along the right wall in the front-rear direction.

A separation distance between the two inclination guide portions 751 closest to each other is less than a front-rear width of the ice generated in the unit mold 731, and thus the ice cannot get out between the two inclined guides 751 closest to each other.

Each inclination guide portion 751 is disposed between the ejector pins 742 and does not overlap each ejector pin 742. That is, the inclination guide portion 751 may be disposed so that it does not interfere with the rotational operation of the ejector pin 742.

The inclination guide portion 751 may serve to guide so that ice separated from the unit mold 731 can fall into a bucket portion 830 of the ice storage bucket 800 disposed below the ice maker 700 by a clockwise rotation of the ejector pin 742.

The deicing heater (not shown) may be provided below the ice making mold 730.

The deicing heater (not shown) may be installed along a lower edge of the ice making mold 730 and may serve to heat the ice making mold 730 so that the ice frozen in the ice making mold 730 can be easily separated from the ice making mold 730.

The lower housing 760 may be coupled to a lower part of the ice making mold 730.

The lower housing 760 may be configured to form the lower part of the ice maker 700. The lower housing 760 may be coupled to the lower part of the ice making mold 730 by hook coupling.

A cold air inlet duct 762 may be formed at a rear end of the lower housing 760.

The cold air inlet duct 762 may include a cold air inlet passage 762a therein. The cold air inlet duct 762 may be formed in a shape with a gradually decreasing up-down width as it goes from the rear side to the front side.

In this instance, an upper part of the cold air inlet duct 762 may be formed to be inclined upward as it goes from the front to the rear. A lower part of the cold air inlet duct 762 may be formed in a flat shape.

The cold air inlet duct 762 may be configured to receive a cold air discharged through a cold air discharge duct 930 to be described later into the cold air inlet passage 762a and transfer the cold air to a cold air flow path 764 of the lower housing 760.

On an upper surface of a lower plate of the lower housing 760, that is, on a bottom surface inside the lower housing 760, two blocking walls 763 spaced apart from each other in the left-right direction may protrude upward. The cold air flow path 764 may be provided between both the blocking walls 763.

Both the blocking walls 763 may be formed inside both the side walls of the lower housing 760 to be spaced apart from both the side walls of the lower housing 760.

Upon the operation of the deicing heater (not shown) that is disposed on the upper portion between the left wall and the left blocking wall 763 of the lower housing 760 and on the upper portion between the right wall and the right blocking wall 763 of the lower housing 760, the blocking wall 763 may serve to block the heat of the deicing heater (not shown) from being transferred to the cold air flow path 764.

The cold air flow path 764 is formed between the blocking walls 763 on both sides inside the lower housing 760 and may be a flow path that allows the cold air introduced through the cold air inlet duct 762 to flow from the rear side to the front side. The cold air flow path 764 may be disposed under the ice making mold 730 and freeze ice making water supplied to the ice making mold 730 to generate ice.

The cold air flow path 764 can prevent the cold air from being directly sprayed to the ice making water supplied to the ice making mold 730 by guiding the flow of cold air between the lower surface of the ice making mold 730 and the inner bottom surface of the cold air flow path 764. Hence, the quality of ice generated in the ice making mold 730 can be improved.

A flow blocking portion 765 with a uneven shape may be formed on the inner bottom surface of the cold air flow path 764.

The flow blocking unit 765 may delay the flow of cold air in the cold air flow path 764 by generating a vortex in the flow of cold air flowing in the cold air flow path 764. Hence, the flow blocking unit 765 can allow the cold air to stay in the lower part of the ice making mold 730, and as a result, the ice making water supplied to the ice making mold 730 may be rapidly frozen.

A cold air outlet port 766 may be formed at the front end of the lower plate of the lower housing 760.

The cold air outlet port 766 may be formed at the front end of the inner bottom surface of the cold air flow path 764 and may serve to discharge the cold air flowing from the rear side to the front side of the cold air flow path 764 to the lower side and to guide the cool air to the ice storage bucket 800 disposed below the ice maker 700.

The ice storage bucket 800 may be installed below the ice making compartment 60.

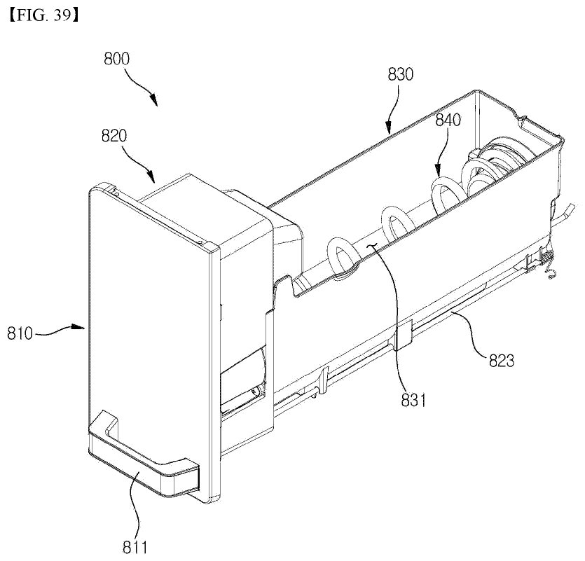

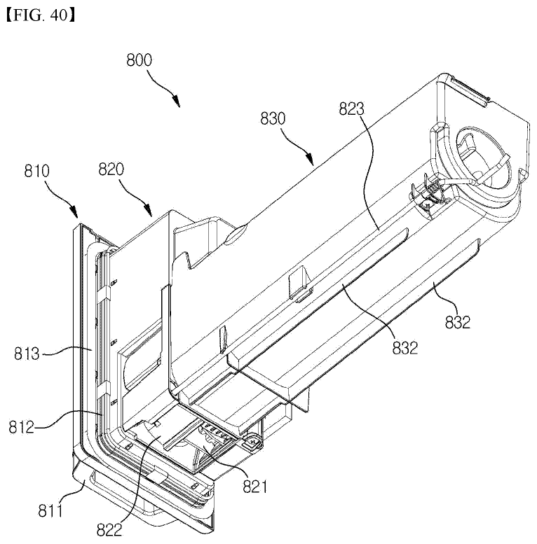

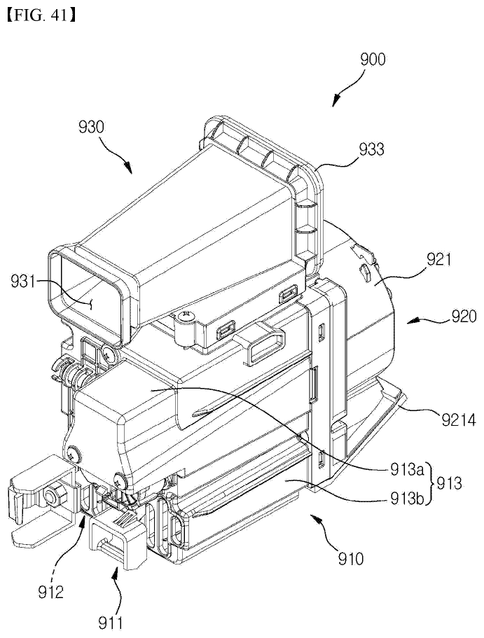

Referring to FIGS. 14 to 17, FIG. 39, FIG. 40, and FIG. 44, the ice storage bucket 800 may be configured to store ice generated by the ice maker 700. The ice storage bucket 800 may be disposed below the ice maker 700 and installed to be draw into and draw out of the ice making compartment 60.

The ice storage bucket 800 may include the ice making compartment door 810, an ice crushing portion 820, the bucket portion 830, and an auger 840.

The ice making compartment door 810 may be configured to selectively open and close the open front surface of the ice making compartment 60 by being detachable from the front surface of the partition wall 600.

When the ice storage bucket 800 is drawn out of the ice making compartment 60, the ice making compartment door 810 may be spaced apart from the front surface of the partition wall 600 to open the front surface of the ice making compartment 60. When the ice storage bucket 800 is completely drawn into the ice making compartment 60, the ice making compartment door 810 may be in close contact with the front surface of the partition wall 600 to close the front surface of the ice making compartment 60.

A handle 811 that the user can grip may be provided in the ice storage bucket 800.

More specifically, the handle 811 may be fixed to the lower part of the front surface of the ice making compartment door 810. When the user takes the ice storage bucket 800 into and out of the ice making compartment 60, the user may use the handle 811 to easily pull or push the ice storage bucket 800.

The related art had a problem in that it is unsanitary and inconvenient because it is necessary to pull or push the ice storage bucket by inserting a hand into an ice discharge port formed on the lower surface of the ice storage bucket in order to take into and out the ice storage bucket.

However, in one embodiment of the present disclosure, since the handle 811 is formed on the ice making compartment door 810, there is no problem that the ice discharge port 6113 is contaminated, and it is easy and simple to take into and out the ice storage bucket 800.

A rectangular ice making compartment door gasket 812 for maintaining airtightness of the ice making compartment 60 may be provided on the rear surface of the ice making compartment door 810.

The ice making compartment door gasket 812 may be installed on the rear surface of the ice making compartment door 810 in the form of surrounding an outer peripheral surface of a front end of the ice crushing portion 820 and may be in close contact with the outer peripheral surface of the ice crushing portion 820.

When the ice making compartment door 810 closes the front surface of the ice making compartment 60, the ice making compartment door gasket 812 may be in close contact with the inner peripheral surface of the stepped first opening 6141 of the partition wall 600 and allow the ice making compartment 60 to maintain the airtightness.

A rectangular ice making compartment door sealing member 813 for maintaining airtightness of the ice making compartment 60 may be further provided on the rear surface of the ice making compartment door 810.

The ice making compartment door sealing member 813 may be installed on the rear surface of the ice making compartment door 810 in a shape surrounding the outer peripheral surface of the front end of the ice making compartment door gasket 812. One side of the ice making compartment door sealing member 813 may be cut off.

An ice making compartment door thermal insulation material 814 may be provided inside the ice making compartment door 810.

The ice making compartment door thermal insulation material 814 may be inserted into the ice making compartment door 810 to insulate the ice making compartment 60 from the outside of the ice making compartment 60.

A magnet (not shown) may be provided inside upper and lower sides of the left end and inside upper and lower sides of the right end of the ice making compartment door 810. When the ice making compartment door 810 closes the front surface of the ice making compartment 60, the front surface of the ice making compartment door 810 may be easily attached to the front surface of the first front plate 614 of the partition wall 600 through interaction with a magnet (not shown) provided at the entrance wall 630.

The ice crushing portion 820 may be coupled to the rear surface of the ice making compartment door 810.

The ice crushing portion 820 may be configured to crush and discharge ice according to a user's selection. The ice crushing portion 820 may be installed on the rear surface of the ice making compartment door 810 to protrude rearward. The ice crushing portion 820 has an open lower portion to communicate with the ice discharge port 6113.

The ice crushing portion 820 may be disposed between the ice making compartment door 810 and the bucket portion 830 to connect the ice making compartment door 810 and the bucket unit 830.

The ice crushing portion 820 may include a crusher 821, a support member 822, and an operating shaft 823.

The bucket portion 830 may be a container in which ice generated by the ice maker 700 is stored. The bucket portion 830 may be provided with an auger 840 for transferring the internal ice to the ice discharge port 6113. The auger 840 may be operated by a second driver 912 to be described later to transport ice. The crusher 821 may be interlocked with the auger 840.

That is, the ice may be transferred to the ice discharge port 6113 by the rotation of the auger 840 and may be taken out by the rotation of the crusher 821. In this instance, depending on whether the support member 822 provided in the ice discharge port 6113 is supported, the original ice or the crushed ice may be taken out by the dispenser 330.

Sliding ribs 832 elongating in the front-rear direction may be formed on the left and right sides of the lower surface of the bucket portion 830, respectively.

The sliding ribs 832 may slide backward and forward along the bottom surface of the ice making compartment 60 when the ice storage bucket 800 is drawn into and drawn out of the ice making compartment 60, thereby stably assisting in drawing into and out the ice storage bucket 800.

The ice making compartment door 810, the ice crushing portion 820, the bucket portion 830, and the auger 840 are coupled to each other as described above, and move together according to the opening and closing of the ice making compartment door 810. Therefore, it may be possible to draw the ice storage bucket 800 into and out of the ice making compartment 60 as a whole.

A driver fan duct assembly 900 may be provided on the rear side of the ice storage bucket 800.

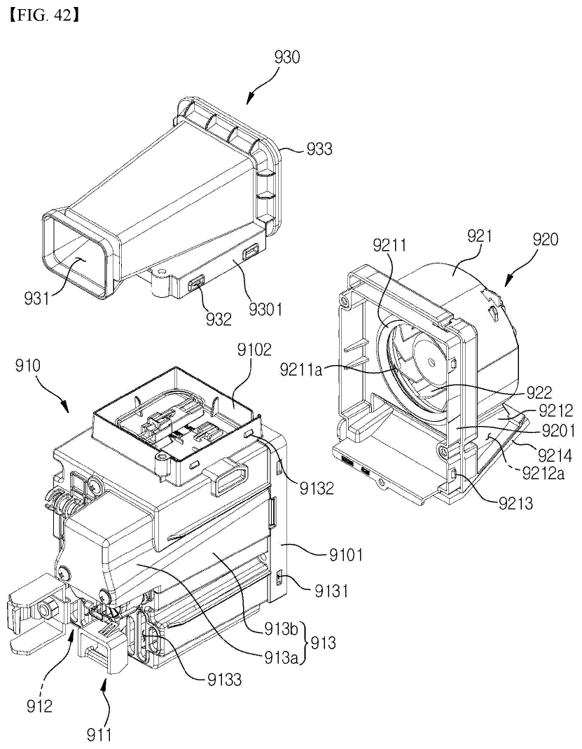

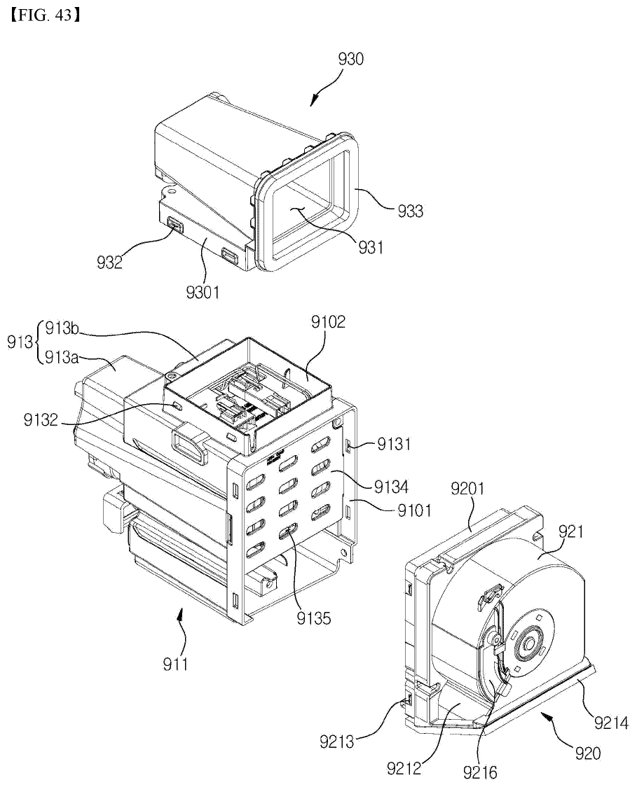

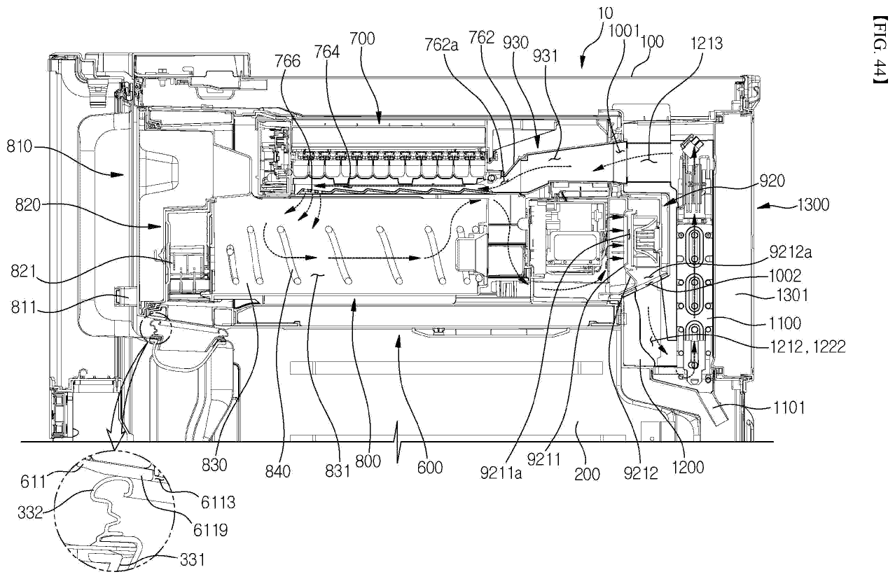

Referring to FIGS. 41 to 44, the driver fan duct assembly 900 may be provided by modularizing a driver assembly 910 that provides a driving force to the ice storage bucket 800 to operate the operating shaft 823 and the auger 840 of the ice storage bucket 800, a fan assembly 920 that is disposed between the ice storage bucket 800 and the evaporator assembly 1100 to be described later and circulates the cold air provided by the evaporator assembly 1100 through a cold air intake port 1002 and a cold air discharge port 1001 of the evaporator case 1000 to be described later, and the cold air discharge duct 930 that receives the cold air discharged through the cold air discharge port 1001 of the evaporator case 1000 to be described later and guides the cold air to the ice maker 700.

The driver fan duct assembly 900 may be modularized such that the fan assembly 920 is coupled to a rear of the driver assembly 910, and the cold air discharge duct 930 is coupled to an upper part of the driver assembly 910.

The driver assembly 910 may include a first driver 911, a second driver 912, and a driver housing 913.

The driver housing 913 may be configured to form an appearance of the driver assembly 910. The driver housing 913 includes a first driver accommodating portion 913a that is formed on its front side and has an opened lower surface, and a second driver accommodating portion 913b integrally formed at a rear end of the first driver accommodating portion 913a.

A quadrangular first coupling flange 9101 may be formed at the rear of the second driver accommodating portion 913b of the driver housing 913, and a rectangular second coupling flange 9102 may be formed at the upper part.

Two first detachable holes 9131 may be formed on each of both sides of a rear end of the second driver accommodating portion 913b, more specifically, the left and right sides of the first coupling flange 9101.

In addition, two first detachable protrusions 9132 may be formed on each of both sides of an upper end of the second driver accommodating portion 913b, more specifically, the left and right sides of the second coupling flange 9102.

The number of first detachable holes 9131 and the number of first detachable protrusions 9132 may be changed, if necessary.

The first detachable hole 9131 can be fitted and coupled to a second detachable protrusion 9213 of the fan assembly 920 to be described later, and thus the fan assembly 920 can be detachably coupled to the driver housing 913.

The first detachable protrusion 9132 can be fitted and coupled to a second detachable hole 932 of the cold air discharge duct 930 to be described later, and thus the cold air discharge duct 930 can be detachably coupled to the driver housing 913.

The second driver accommodating portion 913b of the driver housing 913 may include a plurality of first cold air flow slits 9133 formed on the lower front side, and may have an opened rear side. Fitting plates 9134 having second cold air flow slits 9135 may be fitted and coupled to both inner walls of the opened rear side of the second driver accommodating portion 913b.

The first cold air flow slit 9133 may be a hole that allows the cold air from the ice storage bucket 800 to be introduced into the driver housing 913 when the fan assembly 920 to be described later operates. The second cold air flow slit 9135 may be a hole that allows the cold air introduced into the driver housing 913 to be sucked into the fan assembly 920.

The first driver 911 may be installed at one side of the driver housing 913.

The first driver 911 may be installed at the front of the driver housing 913.

The first driver 911 may be comprised of a solenoid valve that is movable in the up-down direction, and may be accommodated and installed in the first driver accommodating portion 913a protruding to the front right side of the driver housing 913. The first driver 911 may serve to operate the operating shaft 823 and the support member 822 for supporting the ice when crushing the ice.

The second driver 912 may be installed at other side of the driver housing 913.

The second driver 912 may be installed at the rear side of the first driver 911.

The second driver 912 may be comprised of a motor providing a rotational force, and may be accommodated and installed inside the second driver accommodating portion 913b integrally formed at a rear end of the first driver accommodating portion 913a. The second driver 912 may serve to operate the auger 840 for transferring ice stored in an ice storage space 831 of the bucket portion 830 and the crusher 821 for crushing the ice.

The fan assembly 920 may be installed at one side of the driver housing 913.

The fan assembly 920 may be detachably assembled to the rear end of the driver housing 913. The fan assembly 920 may be disposed between the ice making compartment 60 and the evaporator case 1000. The fan assembly 920 may be implemented as a centrifugal fan.

The fan assembly 920 may include a fan housing 921, an impeller 922, and a rotation motor (not shown).

The fan housing 921 may be configured to form an appearance of the fan assembly 920. The fan housing 921 may be integrally provided with a cold air intake duct 9211 in its front center. The fan housing 921 may be integrally provided with a cold air exhaust duct 9212 at its rear lower part.

The cold air intake duct 9211 is provided with a cold air intake passage 9211a communicating with the ice making compartment 60 therein. When the fan assembly 920 operates, the cold air intake duct 9211 may be configured to suck the cold air at the lower front side of the ice making compartment 60, i.e., at from the ice storage bucket 800 through the first cold air flow slit 9133 and the second cold air flow slit 9135

In addition, the cold air exhaust duct 9212 is provided with a cold air exhaust passage 9212a communicating with the installation space 1010 of the evaporator case 1000 to be described later. The cold air exhaust duct 9212 may be configured to discharge the cold air sucked through the cold air intake passage 9211a to the cold air intake port 1002 of the evaporator case 1000.

Since the fan assembly 920 according to the present disclosure can integrally configure the cold air intake duct 9211 and the cold air exhaust duct 9212 by only the fan housing 921 itself, there is an advantage in that a separate duct does not need to be provided in the fan housing 921.

The lower surface of the fan housing 921 may be formed to be inclined upward as it goes from the front to the rear.

A scroll-shaped space may be provided inside the fan housing 921. The scroll-shaped space inside the fan housing 921 may be formed between the cold air intake duct 9211 and the cold air exhaust duct 9212 and communicate with them.

A rectangular third coupling flange 9201 may be formed at the front of the fan housing 921 of the fan assembly 920.

When the fan assembly 920 is coupled to the driver assembly 910, the third coupling flange 9201 may be inserted into and coupled to the first coupling flange 9101 while its outer peripheral surface is close contact with an inner peripheral surface of the first coupling flange 9101. Hence, a loss of the cold air flowing inside the driver assembly 910 and the fan assembly 920 can be prevented by improving the airtightness of the coupled portion.

The first coupling flange 9101 and the third coupling flange 9201 may be fitted and closely attached to each other. The first coupling flange 9101 and the third coupling flange 9201 may be hook-coupled and detachably coupled.

Two second detachable protrusions 9213 may be formed at each of both sides of the front end of the fan housing 921, i.e., at each of the left and right sides of the third coupling flange 9201.

The number of second detachable protrusions 9213 may be changed, if necessary or desired. The second detachable protrusion 9213 may be fitted and coupled to the first detachable hole 9131 of the driver housing 913, and hence the first coupling flange 9101 and the third coupling flange 9201 may be fitted and fixed while being close contact with each other.

In addition, as the second detachable protrusion 9213 is fit-coupled to or released from the first detachable hole 9131 of the driver housing 913, the fan housing 921 may be detached from the driver housing 913.

A first sealing material 9214 and the first sealing material 9214 made of a sponge material may be attached to an edge of the lower surface of the cold air exhaust duct 9212 of the fan housing 921.

When the fan assembly 920 is accommodated in a fan accommodating portion 1020 to be described later, the first sealing material 9214 may be closely attached to an inner lower surface of the fan accommodating portion 1020 to seal a lower joint between the fan assembly 920 and the fan accommodating portion 1020.

A wire guide portion 9216 for guiding wires electrically connected to a rotation motor (not shown) may be provided on the rear surface of the fan housing 921.

The impeller 922 may be installed inside the fan housing 921.

The impeller 922 may be rotatably installed in the scroll-shaped space of the fan housing 921. The impeller 922 rotates by the rotation motor (not shown).

When the impeller 922 rotates by the rotation motor (not shown), the impeller 922 may suck the cold air from the ice storage bucket 800 through the cold air intake passage 9211a of the cold air intake duct 9211, and then discharge the cold air to the cold air intake port 1002 of the evaporator case 1000 to be described later through the cold air exhaust passage 9212a of the cold air exhaust duct 9212.

The impeller 922 may serve to circulate the cold air provided by the evaporator assembly 1100 between the ice making compartment 60 and the evaporator case 1000 through the suction and discharge of the cold air as described above.

A cold air discharge duct 930 may be installed on the other side of the driver housing 913.

The cold air discharge duct 930 may be configured to receive the cold air discharged from the cold air discharge port 1001 of the evaporator case 1000 to be described later and guide the cold air to the cold air inlet duct 762 of the ice maker 700. The cold air discharge duct 930 may be detachably assembled at the upper end of the drive housing 913. The cold air discharge duct 930 may be disposed between the ice maker 700 and the evaporator case 1000.

The front end of the cold air discharge duct 930 may be close contact with a rear end of the cold air inlet duct 762 of the ice maker 700, and a rear end of the cold air discharge duct 930 may be close contact with an edge of the cold air discharge port 1001 of the evaporator case 1000.

The cold air discharge duct 930 may be provided with a cold air discharge passage 931 therein. The cold air discharge duct 930 may be formed in a shape with a gradually decreasing up-down width as it goes from the rear side to the front side. Hence, the cold air discharge passage 931 inside the cold air discharge duct 930 may also be formed in a shape with a gradually decreasing up-down width as it goes from the rear side to the front side.

An upper part of the cold air discharge duct 930 may be formed to be inclined upward as it goes from the front to the rear.

A second sealing material 933 made of a sponge material may be attached to an edge of a rear surface of the cold air discharge duct 930 to seal a joint between the cold air discharge duct 930 and the evaporator case 1000 to be described later.

A quadrangular fourth coupling flange 9301 may be formed at the lower part of the cold air discharge duct 930.

When the cold air discharge duct 930 is coupled to the driver assembly 910, the fourth coupling flange 9301 may be fitted into and coupled to the second coupling flange 9102 while its inner peripheral surface is closely attached to an outer peripheral surface of the second coupling flange 9102.

Two second detachable holes 932 may be formed at each of both sides of the lower end of the cold air discharge duct 930, i.e., at each of the left and right sides of the fourth coupling flange 9301.

The number of second detachable holes 932 may be changed, if necessary or desired. The first detachable protrusion 9132 of the driver housing 913 may be fitted and coupled to the second detachable hole 932, and hence the second coupling flange 9102 and the fourth coupling flange 9301 may be fitted and fixed while being close contact with each other.

In addition, as the first detachable protrusion 9132 of the driver housing 913 is fit-coupled to or released from the second detachable hole 932, the cold air discharge duct 930 may be detached from the driver housing 913.

The second coupling flange 9102 and the fourth coupling flange 9301 may be fitted to and close contact with each other. The second coupling flange 9102 and the fourth coupling flange 9301 may be hook-coupled and detachably coupled.

The driver assembly 910, the fan assembly 920, and the cold air discharge duct 930 described above may be assembled by being fitted and coupled to each other to provide the driver fan duct assembly 900 as one assembly. Hence, the driver assembly 910, the fan assembly 920, and the cold air discharge duct 930 are modularized into one assembly without the need to be individually installed in the ice making compartment 60 to form the driver fan duct assembly 900, and can be installed in the ice making compartment 60 through one installation process.

The driver assembly 910, the fan assembly 920, and the cold air discharge duct 930 constituting the driver fan duct assembly 900 may be fastened by a separate fastening member in addition to fitting-coupling.

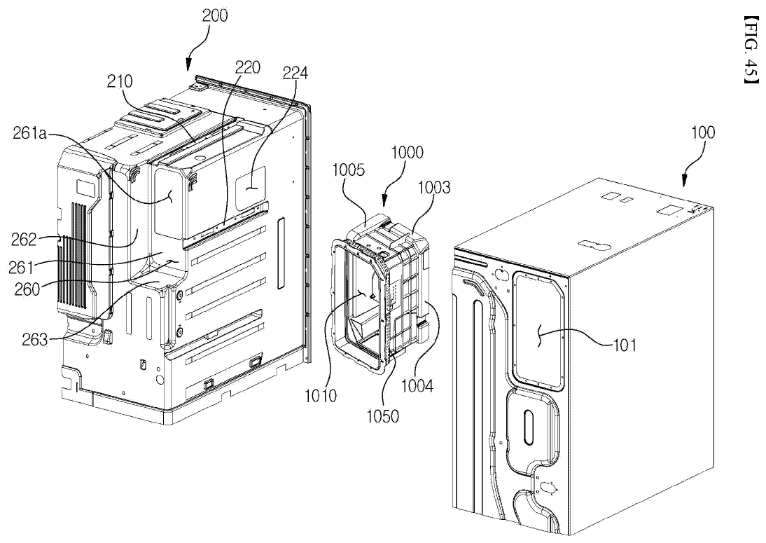

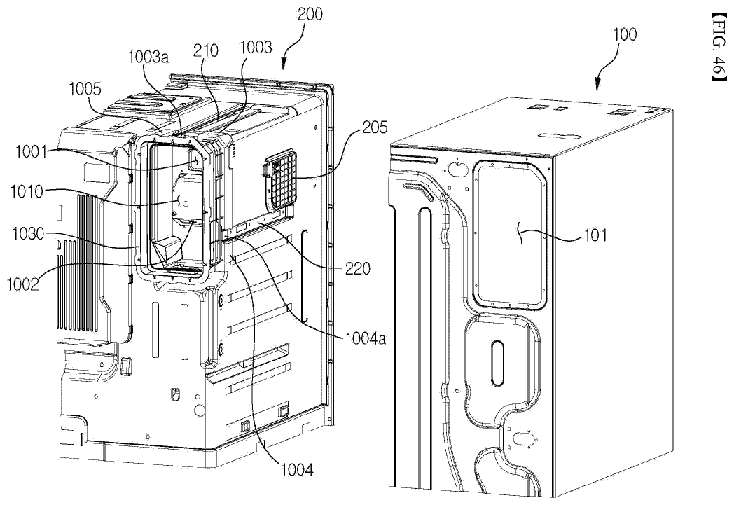

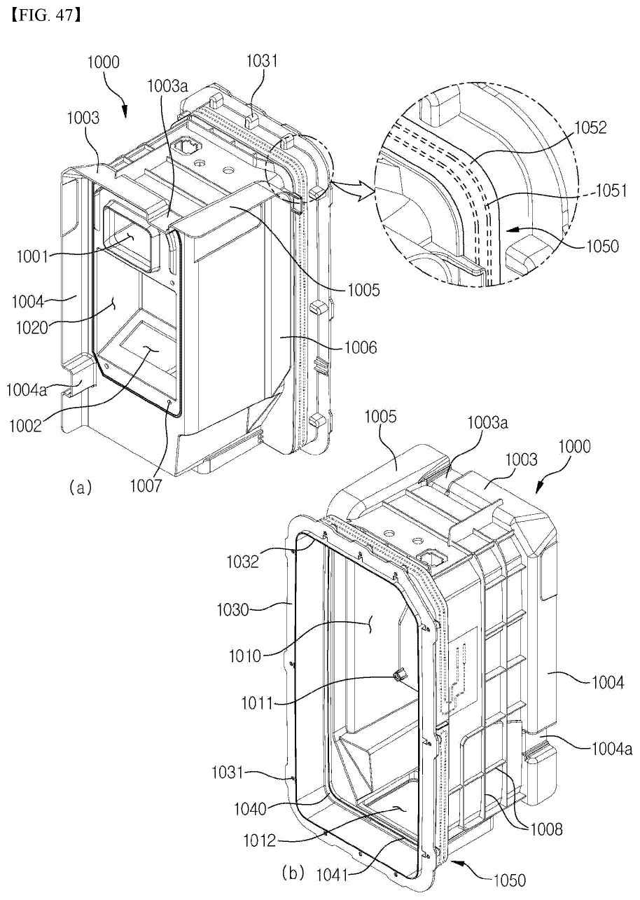

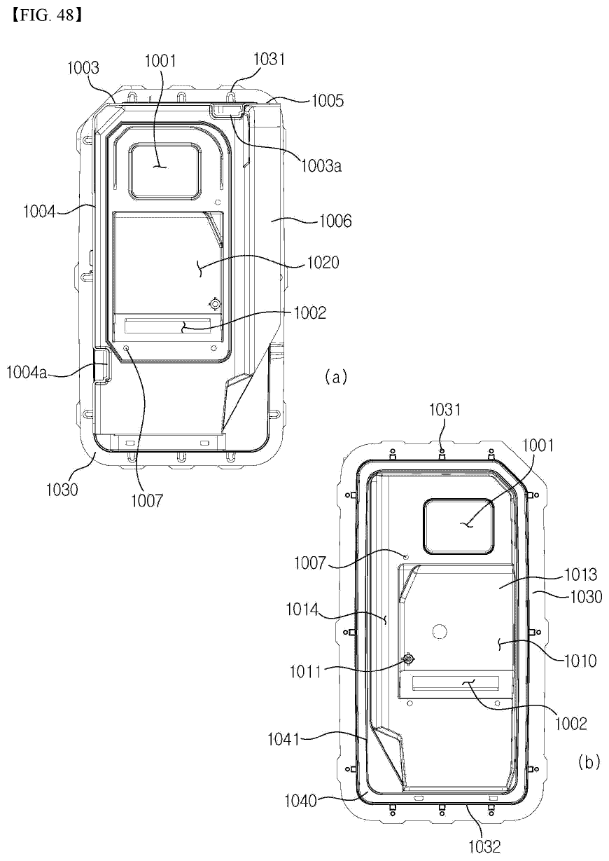

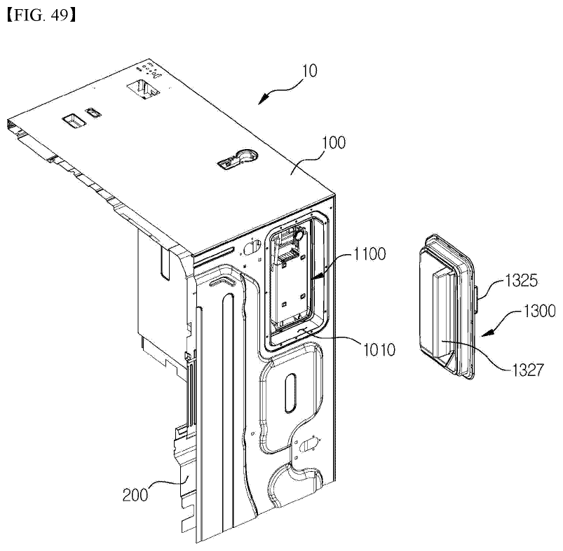

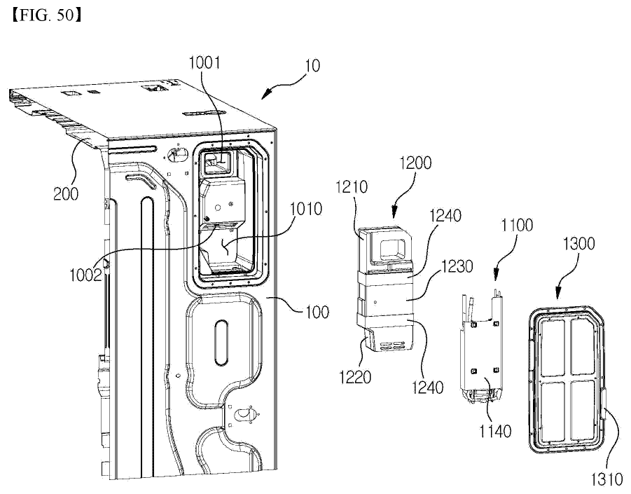

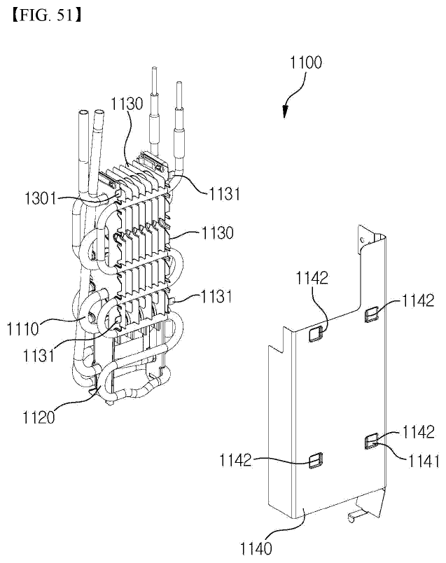

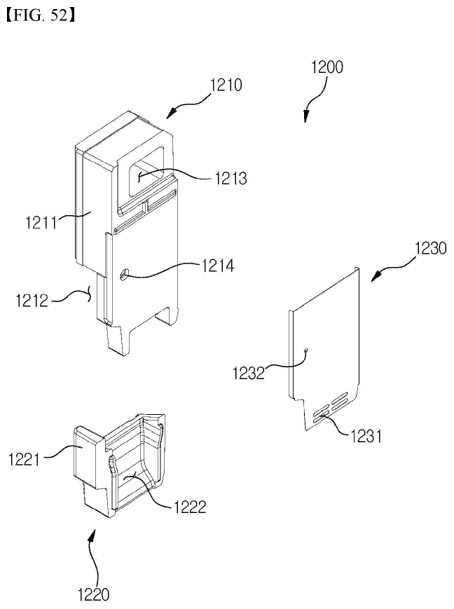

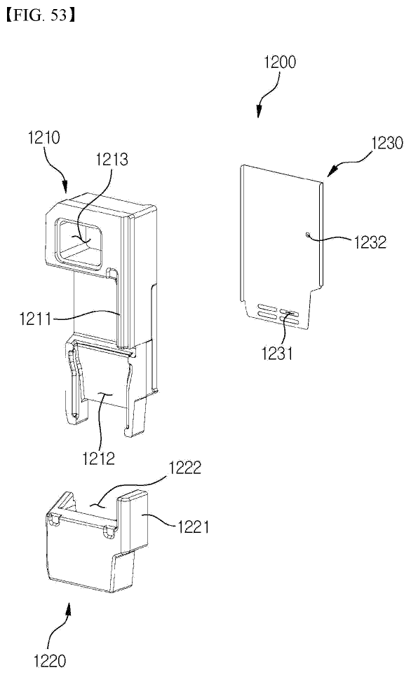

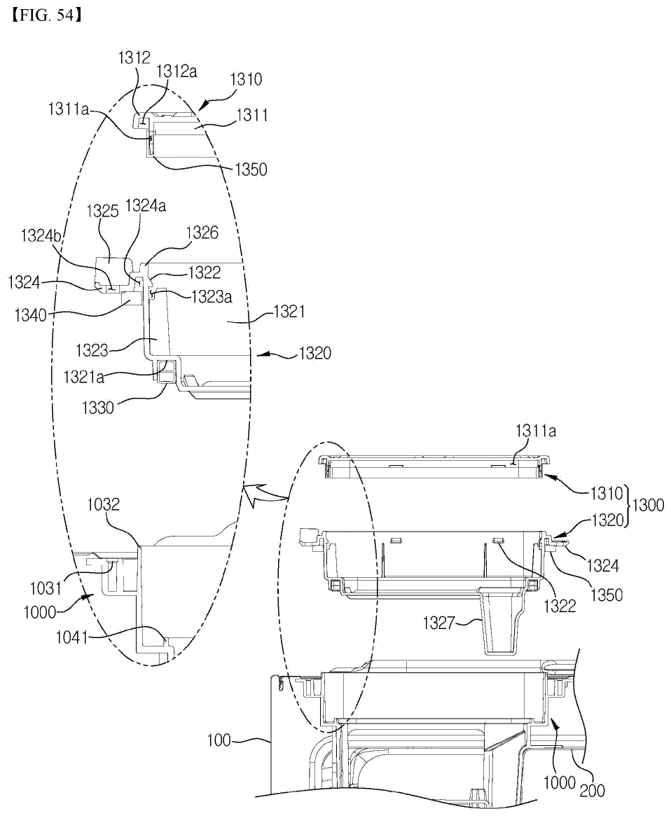

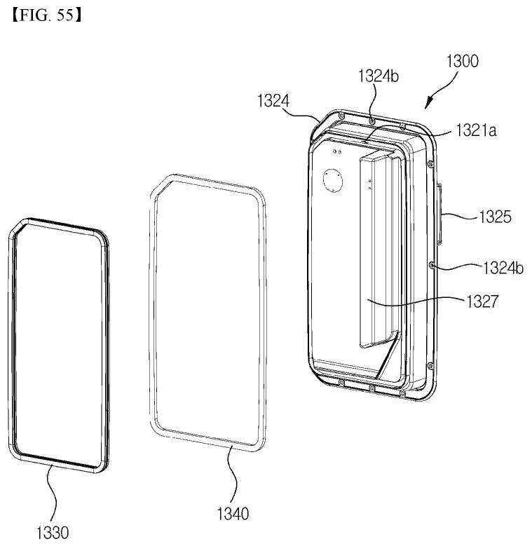

The evaporator case and the configurations related to this are described below with reference to FIGS. 44 to 55.

Referring to FIGS. 44 to 55, the inner case 200 may be provided with a mounting portion 260.

The mounting portion 260 may be a recessed space formed concavely inwardly over the upper wall, the rear wall, and the left wall of the inner case 200. The mounting portion 260 may be formed immediately behind the ice making compartment 60.

That is, the mounting portion 260 may be a space formed by recessing concavely inwardly a rear left corner of the upper part of the inner case 200.

The mounting portion 260 may be a space in which the evaporator case 1000 to be described later is accommodated and mounted. A communication hole 261a penetrated in the front-rear direction may be formed on an inner front surface of the mounting portion 260.

A first mounting surface 261, a second mounting surface 262, and a separation surface 263 may be formed inside the mounting portion 260.

The first mounting surface 261 may be the inner front surface of the mounting portion 260. The second mounting surface 262 may be an inner right side of the mounting portion 260. The separation surface 263 may be an inner bottom surface of the mounting portion 260.

The above-described communication hole 261a may be formed in the first mounting surface 261. The separation surface 263 may have an inclination with a gradually decreasing height as it goes from the front to the rear.

The harness housing 205 for processing various harnesses may be mounted in the harness housing installation hole 224 provided on the side of the inner case 200 on the front side of the mounting portion 260.

The harness housing 205 may be fitted and mounted in the harness housing installation hole 224 to completely cover the harness housing installation hole 224.

The evaporator case 1000 may be provided between the rear wall of the outer case 100 and the rear wall of the inner case 200.

The evaporator case 1000 may be configured to accommodate the evaporator assembly 1100 installed through the opening 101 formed in the rear wall of the outer case 100. The evaporator assembly 1100 may be installed between the rear wall of the outer case 100 and the rear wall of the inner case 200 through the evaporator case 1000. The evaporator assembly 1100 may be installed to be disposed on the rear side of the ice making compartment 60.

The evaporator case 1000 may be mounted such that the front portion is accommodated in the mounting portion 260 formed on the rear wall of the inner case 200. A rear end of the evaporator case 1000 may be fastened to the inner surface of the rear wall of the outer case 100, and thus the evaporator case 1000 may be coupled to the main body 10.

The evaporator case 1000 is described in more detail below.

The evaporator case 1000 may be entirely formed in a shape similar to a rectangular box. An up-down height of the evaporator case 1000 may be less than an up-down height of the mounting portion 260.

A first mounting flange 1003 protruding toward the front side may be formed to elongate in the left-right direction at a front upper end of the evaporator case 1000. A second mounting flange 1004 protruding toward the front side may be formed to elongate in the up-down direction at a front left end of the evaporator case 1000. A third mounting flange 1005 protruding toward the right side may be formed to elongate in the front-rear direction at a right top end of the evaporator case 1000. A fourth mounting flange 1006 protruding toward the right side may be formed to elongate in the up-down direction at the center of the right side of the evaporator case 1000. Each of the first mounting flange 1003, the second mounting flange 1004, the third mounting flange 1005, and the fourth mounting flange 1006 may be supported on the outer surface of the inner case 200.

More specifically, the first mounting flange 1003, the second mounting flange 1004, the third mounting flange 1005, and the fourth mounting flange 1006 may be formed integrally with each other, and at the same time may be provided integrally with the evaporator case 1000. The second mounting flange 1004 may be provided at a left end of the first mounting flange 1003 provided at the front upper end of the evaporator case 1000 in a downward bending shape with respect to the first mounting flange 1003. The third mounting flange 1005 may be provided at a right end of the first mounting flange 1003 provided at the front upper end of the evaporator case 1000 in a rearward bending shape with respect to the first mounting flange 1003. The fourth mounting flange 1006 may be provided at a rear end of the third mounting flange 1005 in downward bending shape with respect to the third mounting flange 1005.

When the evaporator case 1000 is accommodated and mounted in the mounting portion 260, the first mounting flange 1003 may be supported in close contact with the outer surface of the upper wall of the inner case 200 while covering an upper edge of a first mounting surface 261 of the mounting portion 260. The second mounting flange 1004 may be supported in close contact with the outer surface of the left wall of the inner case 200 while covering a left edge of the first mounting surface 261 of the mounting portion 260. The third mounting flange 1005 may be supported in close contact with the outer surface of the upper wall of the inner case 200 while covering an upper edge of a second mounting surface 262 of the mounting portion 260. The fourth mounting flange 1006 may be supported in close contact with the outer surface of the rear wall of the inner case 200 while covering a rear edge of the second mounting surface 262 of the mounting portion 260. Through this, the evaporator case 1000 may be accommodated and mounted in the mounting portion 260.

In this instance, the front surface of the evaporator case 1000 may be in close contact with the first mounting surface 261. The right surface of the evaporator case 1000 may be in close contact with the second mounting surface 262.

A lower end of the evaporator case 1000 may be spaced apart from the separation surface 263 of the mounting portion 260. A drain member 1101 may be coupled to the lower end of the evaporator case 1000.

A first bead corresponding portion 1003a may be formed on the first mounting flange 1003 of the evaporator case 1000. A second bead corresponding portion 1004a may be formed on the second mounting flange 1004 of the evaporator case 1000.

When the evaporator case 1000 is mounted on the mounting portion 260, the first bead corresponding portion 1003a may be fitted and mounted in the first bead portion 210 formed on the upper wall of the inner case 200. When the evaporator case 1000 is mounted on the mounting portion 260, the second bead corresponding portion 1004a may be fitted and mounted in the second bead portion 220 formed on the left wall of the inner case 200. Through this, the evaporator case 1000 can be mounted more firmly.

As described above, the evaporator case 1000 mounted on the mounting portion 260 of the inner case 200 may be fastened to the fourth fastening portion 6211 and the sixth fastening portion 6223 formed on the partition wall 600 by a fastening member inserted through a first screw insertion hole 1007 formed in the front surface of the evaporator case 1000, and thus may be fixed to the inner case 200 and the partition wall 600.

A grid rib 1008 may be formed on a left outer peripheral surface of the evaporator case 1000.

A support flange 1030 extending in a peripheral outward direction may be formed at a rear edge of the evaporator case 1000.

The support flange 1030 may be configured so that the outer case 100 can be in close contact with the rear end of the evaporator case 1000 mounted on the inner case 200. A rear surface of the support flange 1030 may be in close contact with the inner surface of the rear wall of the outer case 100.

Through this, the evaporator case 1000 may be disposed and fixed between the inner case 200 and the outer case 100.

A cover fastening portion 1031 may be formed on the support flange 1030.

The plurality of cover fastening portions 1031 may be formed along the perimeter of the support flange 1030. The cover fastening portion 1031 may be provided so that a fastening member can be fastened from the rear side to the front side.

For example, the three cover fastening portions 1031 may be formed on each of the upper part, the lower part, the left side, and the right side of the support flange 1030. The outer case 100 and a thermal insulation cover 1300 to be described later may be fixed to the evaporator case 1000 through the cover fastening portions 1031.

An outer pressing portion 1032 may be formed on the inner peripheral surface of the support flange 1030 to protrude to the rear of the support flange 1030.

The outer pressing portion 1032 may be formed to protrude rearward over the entire inner peripheral surface of the support flange 1030. When the thermal insulation cover 1300 to be described later is fastened and fixed to the evaporator case 1000, the outer pressing portion 1032 may press a second packing 1340 to be described later to maintain more reliably the airtightness inside the evaporator case 1000.

The outer pressing portion 1032 may be positioned so as to be inserted into the opening 101 of the outer case 100 from the front side to the rear side and protrude to the rear side of the opening 101.

A stepped surface 1040 may be formed on the inner peripheral surface of the evaporator case 1000.

The stepped surface 1040 may be a surface formed in a shape bent inward from the inner peripheral surface of the evaporator case 1000. The stepped surface 1040 may be formed on the entire inner peripheral surface of the evaporator case 1000.

The stepped surface 1040 may be formed to be stepped inward with respect to the support flange 1030.

An inner pressing portion 1041 may be formed on the stepped surface 1040.

The inner pressing portion 1041 may be formed to protrude rearward over the entire perimeter of an inner edge of the stepped surface 1040. When the thermal insulation cover 1300 to be described later is fastened and fixed to the evaporator case 1000, the inner pressing portion 1041 may press a first packing 1330 to maintain more reliably the airtightness inside the evaporator case 1000.

The evaporator case 1000 may include an installation space 1010 and a fan accommodation portion 1020.

The installation space 1010 may be a space in which the evaporator assembly 1100 and a guide portion 1200 to be described later are installed. The installation space 1010 may be provided inside the evaporator case 1000.

The installation space 1010 may have an opened rear surface. A rear opening of the installation space 1010 may be formed in the same shape as the opening 101 of the outer case 100. The installation space 1010 may be positioned directly in front of the opening 101 and communicate with the opening 101.

A drain hole 1012 may be formed in a lower surface inside the installation space 1010. The drain member 1101 may be inserted into the drain hole 1012. A protrusion (not shown) may be formed on the drain member 1101, and the drain member 1101 may be fixed and mounted to the drain hole 1012 by being fitted into a hole (not shown) formed in an inner peripheral surface of the drain hole 1012.

The drain member 1101 may serve to guide defrost water generated by melting the frost formed on the evaporator assembly 1100 by an operation of a defrost heater 1120 to the lower side.

A convex portion 1013 may be formed at the center of the front side inside the installation space 1010 due to the fan accommodating portion 1020 to be described later that is concavely formed from the front side to the rear side.

The left side of the convex portion 1013 may be integrally attached to a left inner surface of the installation space 1010. The right side of the convex portion 1013 may be spaced apart from a right inner surface of the installation space 1010.

A workspace 1014 is provided between the right side of the convex portion 1013 and the right inner surface of the installation space 1010, and thus an operation such as welding of an evaporator 1110 installed inside the installation space 1010 can be easily performed.

A guide fastening portion 1011 may be formed in the convex portion 1013.

The guide fastening portion 1011 may be configured to fasten and fix a guide portion 1200 to be described later to the evaporator case 1000.

The guide portion 1200 to be described later may be accommodated and installed in the inner front side of the installation space 1010. The evaporator assembly 1100 to be described later may be accommodated and installed in the inner rear side of the installation space 1010.

The guide portion 1200 may be assembled in the front portion of the installation space 1010 to guide a flow of the cold air, that is sucked into the installation space 1010 from the ice making compartment 60 through the cold air intake port 1002 to be described later, to the lower end of the evaporator assembly 1100. The evaporator assembly 1100 for providing the cool air to the ice making compartment 60 through heat exchange by a refrigeration cycle may be installed on the rear side of the installation space 1010, i.e., on the rear side of the guide portion 1200.

The evaporator assembly 1100 is installed in the installation space 1010 through the opening 101 formed in the rear wall of the outer case 100, and thus the user can very easily assemble and install the evaporator assembly 1100 in the installation space 1010 without obstacles such as spatial constraints. Accordingly, maintenance of the evaporator assembly 1100 may be very easy.

The evaporator assembly 1100 and the guide portion 1200 installed in the installation space 1010 will be described in more detail later.

The cold air discharge port 1001 and the cold air intake port 1002 that communicate with the ice making compartment 60 through the communication hole 261a formed in the first mounting surface 261 may be formed on the front side of the evaporator case 1000. The fan assembly 920 may be provided on the cold air intake port 1002.

The cold air discharge port 1001 may be formed to pass through the front upper portion of the evaporator case 1000 in the front-rear direction to communicate the installation space 1010 with the ice making compartment 60. The cold air intake port 1002 may be formed to pass through the inclined surface of the front center portion of the evaporator case 1000, i.e., an inclined lower surface inside the fan accommodating portion 1020 to be described later in the up-down direction to communicate the installation space 1010 with the ice making compartment 60.

The cold air discharge port 1001 may be connected to the cold air discharge duct 930 and may be configured to allow the cold air heat-exchanged by the evaporator assembly 1100 of the installation space 1010 to flow to the ice maker 700 installed in the upper part of the ice making compartment 60. The cold air intake port 1002 may be connected to the cold air exhaust duct 9212 and may be configured to allow the cold air that has passed through the ice maker 700 and the ice storage bucket 800 to flow into the installation space 1010 of the evaporator case 1000.

In this instance, the cold air sucked into the installation space 1010 through the cold air intake port 1002 may be guided to the lower side from the vicinity of the central portion of the installation space 1010 according to the guide of the guide portion 1200 to be described later, and may flow from the lower end to the upper end of the evaporator assembly 1100.

The fan accommodating portion 1020 that is recessed to the rear side may be formed in the front center portion of the evaporator case 1000.

The cold air intake port 1002 may be formed in the inclined lower surface inside the fan accommodating portion 1020. The fan accommodating portion 1020 may communicate with the cold air intake port 1002.

The fan assembly 920 may be installed in the fan accommodating portion 1020 so that the fan assembly 920 for circulating the cold air provided by the heat exchange of the evaporator assembly 1100 is disposed on the cold air intake port 1002, more specifically, directly on the cold air intake port 1002.

The cold air exhaust duct 9212 of the fan assembly 920 may be in close contact with the upper end of the cold air intake port 1002, and thus the cold air exhaust passage 9212a and the cold air intake port 1002 may airtightly communicate with each other.

Since the evaporator case 1000 includes both the installation space 1010 in which the evaporator assembly 1100 is installed and the fan accommodating portion 1020 in which the fan assembly 920 is installed, there are advantages in that it is very easy to assembly the evaporator assembly 1100 and the fan assembly 920, and the respective components can be arranged compactly.

A heating means 1050 may be installed in the evaporator case 1000.

The heating means 1050 may be configured to prevent water droplets from forming on the peripheral surfaces of the outer case 100, the thermal insulation cover 1300, and the evaporator case 1000 due to a dew condensation phenomenon. The heating means 1050 may surround the outer peripheral surface of the rear side of the evaporator case 1000.

The heating means 1050 may include a heating wire 1051 and an adhesive member 1052.

The heating wire 1051 may be electrically connected to an external power source and configured to generate heat. The heating wire 1051 may be disposed on the outer peripheral surface of the rear side of the evaporator case 1000.

The heating wire 1051 may be provided along the outer peripheral surface of the rear side of the evaporator case 1000 so that it is positioned on the front side of the cover fastening portion 1031.

The heating wire 1051 may be provided to surround the outer peripheral surface of the evaporator case 1000 so that two wire lines are spaced apart from each other in the front-rear direction. The heating wire 1051 may consist of one wire line or three or more wire lines, if necessary.

The heating wire 1051 provided on the outer peripheral surface of the evaporator case 1000 may be fixed to the outer peripheral surface of the evaporator case 1000 by the adhesive member 1052.

The adhesive member 1052 may be configured to fix the heating wire 1051 so as to prevent the heating wire 1051 from being detached from the outer peripheral surface of the evaporator case 1000.

The adhesive member 1052 may be a tape attached to the outer peripheral surface of the evaporator case 1000 while covering the heating wire 1051.

In order to remove water droplets condensed on the outer case 100, the thermal insulation cover 1300, and the evaporator case 1000 or prevent water droplets from forming on the outer case 100, the thermal insulation cover 1300, and the evaporator case 1000, the heating means 1050 configured as above may operate at all times to generate heat, or may periodically operate according to the user's setting to generate heat, or may sense water droplets condensed on the outer case 100, the thermal insulation cover 1300, and the evaporator case 1000 and automatically operate according to a result of sensing to generate heat.

The evaporator assembly 1100 may be accommodated and installed in the evaporator case 1000.

The evaporator assembly 1100 may be configured to provide the cold air to the ice making compartment 60.

The evaporator assembly 1100 may be accommodated on the rear side of the installation space 1010 of the evaporator case 1000. Before the evaporator assembly 1100 is accommodated in the installation space 1010, the guide portion 1200 to be described later may be previously accommodated and installed in the installation space 1010.

The evaporator assembly 1100 may generate cold air in the installation space 1010 and discharge the cold air to the cold air discharge port 1001 formed in the evaporator case 1000.

The evaporator assembly 1100 may include the evaporator 1110, the defrost heater 1120, fins 1130, and a first conductive plate 1140.

The evaporator 1110 may be a core component of the evaporator assembly 1100. The evaporator 1110 may be assembled and installed in the installation space 1010.

The evaporator 1110 may be configured to form a refrigeration cycle in association with a compressor (not shown), a condenser (not shown), and an expansion means (not shown). Through this refrigerating cycle, the evaporator 1110 may exchange heat between an inner refrigerant and the air around the evaporator 1110 in the installation space 1010 of the evaporator case 1000 to generate cold air.

The defrost heater 1120 may be disposed adjacent to the evaporator 1110.

The defrost heater 1120 may be disposed on the front side and the rear side of the evaporator 1110. The evaporator 1110 may be disposed to be inserted between the front portion and the rear portion of the defrost heater 1120.

The defrost heater 1120 may be configured to melt frost formed in the evaporator 1110 and flow it as defrost water.

The defrost heater 1120 may receive electric power from an external power source to generate heat. This heat may be applied to the evaporator 1110 and may melt the frost formed in the evaporator 1110 to thereby remove the frost formed in the evaporator 1110.

As above, the evaporator 1110 and the defrost heater 1120 may be fitted into the fins 1130 and coupled to each other.

The fins 1130 may be configured to improve a heat exchange performance of the evaporator 1110. The plurality of fins 1130 may be provided to be spaced apart from each other in the left-right direction.

Clip portions 1131 may be formed on the outermost fins of the plurality of fins 1130, i.e., the fins 1130 disposed on the leftmost and rightmost sides.

The clip portion 1131 may be coupled and fixed to the first conductive plate 1140.

The first conductive plate 1140 may be configured to conduct heat generated in the defrost heater 1120 when the defrost heater 1120 operates, and evenly apply the heat to the evaporator 1110. It is preferable that the first conductive plate 1140 is made of a metal material with good thermal conductivity.

A clip accommodating surface 1141 concavely recessed toward the front side may be formed on a rear surface of the first conductive plate 1140.

Two clip accommodating surfaces 1141 may be formed on each of the left and right sides of the first conductive plate 1140 in a symmetrical form in the left-right direction.

Each clip accommodating surface 1141 may include a thin clip hole 1142 formed to elongate in the up-down direction.

The clip hole 1142 may be formed at a right end of each of the two clip accommodating surfaces 1141 disposed on the left side, and may be formed at a left end of each of the two clip accommodating surfaces 1141 disposed on the right side. Thus, the clip holes 1142 may correspond to the clip portions 1131 formed at the fins 1130.

Each corresponding clip portion 1131 may be inserted and fixed to each clip hole 1142.

The cold air generated by the evaporator 1110 of the evaporator assembly 1100 may have a flow circulated by the operation of the fan assembly 920.

The cold air generated by the evaporator 1110 may be discharged from the upper end of the evaporator 1110 through the cold air discharge port 1001 via a discharge guide passage 1213 of the guide portion 1200 to be described later.

The cold air discharged through the cold air discharge port 1001 may be guided to the cold air discharge passage 931 and introduced into the cold air inlet passage 762a.

The cold air introduced into the cold air inlet passage 762a may flow from the rear to the front of the cold air flow path 764 under the ice making mold 730 so that ice is generated in the ice maker 700, and then may flow out downward through the cold air outlet port 766.

The cold air flowing downward through the cold air outlet port 766 may flow toward the rear of the bucket portion 830 via the ice crushing portion 820 and the front of the bucket portion 830.

The cold air flowing toward the rear of the bucket portion 830 may be introduced into the lower part inside the driver housing 913 through the first cold air flow slit 9133. The cold air introduced into the lower part inside the driver housing 913 may flow out of the driver housing 913 through the second cold air flow slit 9135.

The cold air flowing out through the second cold air flow slit 9135 may be sucked into the cold air intake passage 9211a. The cold air sucked into the cold air intake passage 9211a may be discharged through the cold air exhaust passage 9212a.

The cold air discharged through the cold air exhaust passage 9212a may be sucked into intake guide passages 1212 and 1222 of the guide portion 1200 to be described later through the cold air intake port 1002, and may be guided to the lower end of the evaporator 1100 installed inside the installation space 1010 according to the guide of the intake guide passages 1212 and 1222.

The cold air guided to the lower end of the evaporator 1100 passes upward through the evaporator 1110 and flows to the upper end of the evaporator 1110, and thus the cold air circulation can be entirely performed.

The guide portion 1200 may be accommodated and installed in the evaporator case 1000.

The guide portion 1200 may be configured to guide a flow of cold air between the ice making compartment 60 and the installation space 1010 of the evaporator case 1000.

The guide portion 1200 may be accommodated in the front side of the installation space 1010 of the evaporator case 1000 and may be disposed in front of the evaporator assembly 1100. The guide portion 1200 may be previously accommodated and installed in the installation space 1010 before the evaporator assembly 1100 is accommodated in the installation space 1010.

The convex portion 1013 in the installation space 1010 may be inserted into a concave portion formed in the front center of the guide portion 1200. The overall shape of the front side of the installation space 1010 may correspond to the overall shape of the guide portion 1200.

The discharge guide passage 1213 may be formed in the guide portion 1200 to guide the cold air generated by the evaporator 1110 in the installation space 1010 to the ice making compartment 60. The intake guide passages 1212 and 1222 may be formed in the guide portion 1200 to guide the cool air sucked by the fan assembly 920 from the ice making compartment 60 to the inside of the installation space 1010.

The guide portion 1200 is described in detail below.

The guide portion 1200 may include a first guide body 1210, a second guide body 1220, and a second conductive plate 1230.

The first guide body 1210 may be configured to form the upper portion and the rear portion of the guide portion 1200.

A first space blocking wall 1211 may be formed in the right center portion of the first guide body 1210 and fitted in the workspace 1014 provided in the installation space 1010 to fill the workspace 1014.

The discharge guide passage 1213 penetrated in the front-rear direction may be provided on an upper portion of the first guide body 1210.

The discharge guide passage 1213 may be interposed between the rear portion of the installation space 1010, i.e., the space, in which the evaporator assembly 1100 is installed in the installation space 1010, and the cold air discharge port 1001, and may communicate with them.

A front end of the discharge guide passage 1213 may communicate with the cold air discharge port 1001, and a rear end of the discharge guide passage 1213 may be positioned in front of the upper end of the evaporator 1110.

A front edge of the discharge guide passage 1213 may be in close contact with a rear edge of the cold air discharge port 1001, and thus the discharge guide passage 1213 and the cold air discharge port 1001 may airtightly communication with each other. A rear end of the discharge guide passage 1213 may be positioned adjacent to the upper end of the evaporator 1110, and the cool air that flows from the lower side to the upper side of the installation space 1010 and passes through the evaporator 1110 may be introduced into the discharge guide passage 1213.

A lower portion of the first guide body 1210 may be provided with the first intake guide passage 1212 having an open front surface, an open upper surface, an open lower surface, and a partially open rear lower portion.

The first intake guide passage 1212 may constitute the intake guide passages 1212 and 1222 together with the second intake guide passage 1222 to be described later.

A fastening insertion hole 1214 may be formed on the front center right side of the first guide body 1210, and the guide fastening portion 1011 formed in the evaporator case 1000 may be inserted into the fastening insertion hole 1214.

A fastening member inserted through a second screw insertion hole 1232 of the second conductive plate 1230 to be described later may be fastened to the guide fastening portion 1011 inserted into the fastening insertion hole 1214, and thus the guide portion 1200 may be fixed to the evaporator case 1000.

The convex portion 1013 in the installation space 1010 may be accommodated in the central portion of the first guide body 1210.

The second guide body 1220 may be disposed below the first guide body 1210.

The second guide body 1220 may be matched with the lower portion of the first guide body 1210 to constitute the guide portion 1200. The first guide body 1210 and the second guide body 1220 may be matched and accommodated in the front side of the installation space 1010.

The second guide body 1220 may be sandwiched between the convex portion 1013 and the inner lower surface of the installation space 1010.

A second space blocking wall 1221 may be formed in the right upper portion of the second guide body 1220 and may be fitted in the workspace 1014 provided in the installation space 1010 together with the first space blocking wall 1211 to fill the workspace 1014.

The second intake guide passage 1222 having an open upper surface and an open rear surface may be formed in the rear of the second guide body 1220.

As the first guide body 1210 and the second guide body 1220 are matched and coupled, the second intake guide passage 1222 is coupled to the first intake guide passage 1212 to constitute the intake guide passages 1212 and 1222.

When the first guide body 1210 and the second guide body 1220 are matched, the open front surface of the first intake guide passage 1212 may be closed by the front portion of the second guide body 1220, and the open rear surface of the second intake guide passage 1222 may be closed by the rear portion of the first guide body 1210 except a portion of the lower part of the open rear surface.

Through this, the intake guide passages 1212 and 1222 may be provided as a passage that is formed to elongate in the up-down direction, and has an open upper surface and a partially open rear lower part.

The intake guide passages 1212 and 1222 may be a passage having an inclination with a decreasing height as it goes from the front to the rear.

The intake guide passages 1212 and 1222 may be interposed between the rear portion of the installation space 1010, i.e., the space, in which the evaporator assembly 1100 is installed in the installation space 1010, and the cold air intake port 1002, and may communicate with them.

Upper ends of the intake guide passages 1212 and 1222 may communicate with the cold air intake port 1002, and lower ends may be positioned in front of the lower end of the evaporator 1110.

Upper edges of the intake guide passages 1212 and 1222 may be in close contact with a lower edge of the cold air intake port 1002, and thus the intake guide passages 1212 and 1222 and the cold air intake port 1002 may airtightly communication with each other. Lower rear end of the intake guide passages 1212 and 1222 may be positioned adjacent to the lower end of the evaporator 1110, and the intake guide passages 1212 and 1222 may guide so that the cool air introduced into the installation space 1010 passes through the lower end of the evaporator 1110 installed in the installation space 1010 and flows to the upper side.

That is, even if the ice making compartment 60 and the cold air intake port 1002 are positioned higher than the lower end of the evaporator 1110, the cold air can be guided to the lower end of the evaporator 1110 through the intake guide passages 1212 and 1222.

The first guide portion 1200 and the second guide portion 1200 may be made of a Styrofoam material. Hence, the guide portion 1200 may serve to guide the cold air and at the same time serve as a thermal insulation wall between the refrigerator compartment 11 and the ice making compartment 60 and the installation space 1010.

The guide portion 1200 may individually include the first guide body 1210 and the second guide body 1220. When foreign substances are introduced into the intake guide passages 1212 and 1222 or cleaning in the intake guide passages 1212 and 1222 are required, the matched first and second guide bodies 1210 and 1220 may be separated from each other and may easily maintain the first intake guide passage 1212 and the second intake guide passage 1222.

The second conductive plate 1230 may be coupled to the rear surface of the first guide body 1210 matched to the second guide body 1220.

The second conductive plate 1230 may be configured to conduct heat generated in the defrost heater 1120 when the defrost heater 1120 operates, and evenly apply the heat to the evaporator 1110, in the same manner as the first conductive plate 1140. It is preferable that the second conductive plate 1230 is made of a metal material with good thermal conductivity.

The second conductive plate 1230 may be provided in the form of covering from the rear center portion to the lower end of the first guide body 1210. The second conductive plate 1230 may be provided in the form in which a portion of the right side is bent forward to cover a portion of the right side of the first guide body 1210.

A plurality of cold air intake slits 1231 communicating with the rear lower ends of the intake guide passages 1212 and 1222 may be formed at the lower end of the second conductive plate 1230, and the cold air guided through the intake guide passages 1212 and 1222 may be guided to the lower end of the evaporator 1110 via the cold air intake slits 1231.

The first guide body 1210, the second guide body 1220, and the second conductive plate 1230 may be attached and fixed to each other as their upper center portions and lower center portions are surrounded by a separate adhesive tape 1240. Hence, the matched state of the first guide body 1210 and the second guide body 1220 and a state of covering the rear surface of the first guide body 1210 with the second conductive plate 1230 can be maintained, and thus the guide portion 1200 can be entirely formed.

The adhesive tape 1240 may be attached to the guide portion 1200 before the guide portion 1200 is accommodated in the installation space 1010.

The second screw insertion hole 1232 may be formed on the right side of the second conductive plate 1230 and may be penetrated in the front-rear direction.

As described above, as a fastening member inserted through the second screw insertion hole 1232 is fastened to the guide fastening portion 1011 of the evaporator case 1000 inserted into the fastening insertion hole 1214 of the first guide body 1210, the second conductive plate 1230 can be fixed to the first guide body 1210, the second guide body 1220, and the evaporator case 1000.

The thermal insulation cover 1300 matched to the rear of the installation space 1010 may be installed in the opening 101 of the outer case 100.

The thermal insulation cover 1300 may be fastened and coupled to the rear wall of the outer case 100 and the evaporator case 1000 by means of the fastening member, in order to seal the opening 101 of the outer case 100 and the installation space 1010 from the outside of the main body 10.

More specifically, after the fastening member inserted through a third screw insertion hole 1324b to be described later is inserted into a cover fastening hole 101a formed in the outer case 100 along the edge of the opening 101, the thermal insulation cover 1300 may be fastened and fixed to the cover fastening portion 1031 of the evaporator case 1000 in a state in which the outer pressing portion 1032 is fitted to the opening 101.

The plurality of third screw insertion holes 1324b, the plurality of cover fastening holes 101a, and the plurality of cover fastening portions 1031 may be provided so that they correspond to each other.

The thermal insulation cover 1300 is mounted on or removed from the rear wall of the outer case 100, and thus the opening 101 and the installation space 1010 can be opened and closed.

The thermal insulation cover 1300 may include an outer cover 1310 and an inner cover 1320 coupled to the outer cover 1310.

The outer cover 1310 may include an outer cover body 1311 having a side wall protruding forward along the edge at the rear portion of the same shape as the opening 101 and an open rear surface of the installation space 1010, and an outer cover flange 1312 protruding to the outside of an outer peripheral surface along the outer peripheral surface of a rear end of the outer cover body 1311.

A third packing 1350 may be inserted into a side wall of the outer cover body 1311. A compulsory fitting groove 1311a may be provided on an inner peripheral surface of the side wall of the outer cover body 1311. The outer cover flange 1312 may have a protrusion accommodating groove 1312a recessed toward the rear side.

The third packing 1350 may be fitted to the entire perimeter of the side wall of the outer cover body 1311. The plurality of compulsory fitting grooves 1311a may be formed to be spaced apart from each other along the inner peripheral surface of the side wall of the outer cover body 1311. The protrusion accommodating groove 1312a may be formed over the entire perimeter of the outer cover flange 1312, and the front side of the protrusion accommodating groove 1312a may be opened.

The inner cover 1320 may be coupled to the outer cover 1310.

The inner cover 1320 may include an inner cover body 1321 having a side wall protruding rearward along the edge at the front portion of the same shape as the opening 101 and the open rear surface of the installation space 1010, and an inner cover flange 1324 that protrudes to the outside of an outer peripheral surface along the outer peripheral surface of a rear end of the inner cover body 1321 and is formed to be stepped with respect to a front surface of the inner cover body 1321.

A packing groove 1321a having an open front side may be formed at a front edge of the inner cover body 1321 along the front edge of the inner cover body 1321. A first packing 1330 having an empty space therein may be inserted into the packing groove 1321a.

A portion of the first packing 1330 may protrude toward the front side outside the packing groove 1321a. The first packing 1330 may be pressed by the inner pressing portion 1041 when the thermal insulation cover 1300 is coupled to the rear wall of the outer case 100, and may be compressed on both peripheral surfaces inside the packing groove 1321a and the inner rear surface of the packing groove 1321a.

In this instance, the first packing 1330 seals between the stepped surface 1040 of the evaporator case 1000 and a front end of an outer peripheral wall of the packing groove 1321a, and thus can maintain airtightness between the installation space 1010 and the outside of the main body 10.

A compulsory fitting projection 1322 for the fixing with the outer cover 1310 may be formed in the rear of an inner peripheral surface of the inner cover body 1321. A packing insertion rib 1323 may be formed on the inner peripheral surface of the inner cover body 1321 on the front side of the compulsory fitting projection 1322.

The plurality of compulsory fitting projections 1322 and the plurality of packing insertion ribs 1323 may be formed to be spaced apart from each other along the inner peripheral surface of the inner cover body 1321. A packing fitting portion 1323a having an open rear side may be formed at a rear end of the packing insertion rib 1323.

The compulsory fitting projection 1322 may be provided to correspond to the compulsory fitting groove 1311a. The compulsory fitting projection 1322 may be inserted into the compulsory fitting groove 1311a, and the outer cover 1310 and the inner cover 1320 may be fitted and coupled to each other to configure the thermal insulation cover 1300.

In this instance, the third packing 1350 fitted to the side wall of the outer cover body 1311 may be pushed by the compulsory fitting projection 1322 and may be partially inserted into the compulsory fitting groove 1311a together with the compulsory fitting projection 1322. A front portion of the third packing 1350 fitted to the side wall of the outer cover body 1311 may be fitted into a packing fitting portion 1323a together with the side wall of the outer cover body 1311.

A packing adhesion groove 1324a that is recessed toward the rear side and has an open front surface may be formed on the inner side of the front perimeter of the inner cover flange 1324. The second packing 1340 may be inserted into contact with the rear outer peripheral surface of the thermal insulation cover 1300, i.e., the rear outer peripheral surface of the side wall of the inner cover body 1321.

The packing adhesion groove 1324a may be formed over the entire perimeter of the front surface of the inner cover flange 1324. A portion of the second packing 1340 fitted to the side wall of the inner cover body 1321, i.e., an outer perimeter of a rear surface of the second packing 1340 may be in close contact with the front surface of the inner cover flange 1324. A remaining portion of the second packing 1340 fitted to the side wall of the inner cover body 1321, i.e., an inner perimeter of the rear surface of the second packing 1340 may be disposed to cover the open front surface of the packing adhesion groove 1324a.

When the thermal insulation cover 1300 is coupled to the rear wall of the outer case 100, the second packing 1340 may be compressed by the inner cover flange 1324 and the rear wall of the outer case 100 and at the same time pressed by the outer pressing portion 1032, and thus may be forcibly inserted into the packing adhesion groove 1324a. Through this, the second packing 1340 can doubly maintain airtightness between the installation space 1010 and the outside of the main body 10 together with the first packing 1330.

The inner cover flange 1324 may include the third screw insertion hole 1324b penetrated in the front-rear direction.

The third screw insertion hole 1324b may be a hole for fixing the thermal insulation cover 1300 to the outer case 100 and the evaporator case 1000. The plurality of third screw insertion holes 1324b may be formed to be spaced apart from each other along the perimeter of the inner cover flange 1324. The third screw insertion hole 1324b may be provided on the outside of the packing adhesion groove 1324a.

In a state in which the thermal insulation cover 1300 is matched to the installation space 1010 through the opening 101, a fastening member may be inserted into the third screw insertion hole 1324b. The fastening member inserted into the third screw insertion hole 1324b is fastened to the cover fastening portion 1031 of the evaporator case 1000 via the cover fastening hole 101a of the outer case 100, and thus the thermal insulation cover 1300, the outer case 100, and the evaporator case 1000 can be firmly fixed to each other.

The rear surface of the inner cover flange 1324 may be provided with cover handles 1325 that protrude to the rear side and are formed symmetrically at both ends with respect to the center of the thermal insulation cover 1300.

For example, the cover handles 1325 includes a cover handle disposed on the lower left side of the rear surface of the inner cover flange 1324 which is the lower left side of the rear surface of the thermal insulation cover 1300, and a cover handle disposed on the upper right side of the rear surface of the inner cover flange 1324 which is the upper right side of the rear surface of the thermal insulation cover 1300. Hence, when the user opens and closes the thermal insulation cover 1300, the user can easily open and close the thermal insulation cover 1300 while holding the cover handles 1325.

A cover thermal insulation material 1301 is provided inside the thermal insulation cover 1300, i.e., in the space between the outer cover 1310 and the inner cover 1320 coupled to each other, and can perform more effectively the thermal insulation between the installation space 1010 of the evaporator case 1000 and the outside of the main body 10.

A cover protrusion 1326 extending to the rear side may be formed over the entire perimeter of a rear end edge of a side wall of the inner cover body 1321.

The cover protrusion 1326 may be inserted into the protrusion accommodating groove 1312a when the outer cover 1310 and the inner cover 1320 are coupled, and may facilitate the coupling between the outer cover 1310 and the inner cover 1320.

A space blocking part 1327 may be formed on the front right side of the thermal insulation cover 1300.

The space blocking part 1327 may be formed in a shape protruding from the front right side of the inner cover body 1321 to the front side. The space blocking part 1327 may be inserted into the right part of the installation space 1010, which is a remaining portion other than a portion of the installation space 1010 in which the guide portion 1200 and the evaporator assembly 1100 are installed, and may fill an unnecessary space, thereby preventing the cold air from circulating in the unnecessary space.

The thermal insulation cover 1300 configured as above is doubly sealed to the evaporator case 1000 through the first packing 1330 and the second packing 1340, and can maintain more reliably the airtightness of the opening 101 for the outside of the main body 10 and the installation space 1010.

An embodiment of the present disclosure has been described using that the partition wall 600 forming the ice making compartment 60 and the evaporator assembly 1100 installed in the evaporator case 1000 are applied to an upper left edge of the main body 10, as an example. However, conversely, they may be applied to an upper right edge of the main body 10, if necessary or desired.

Although the embodiments have been described with reference to a number of illustrative embodiments thereof, numerous other modifications and embodiments may be devised by those skilled in the art that will fall within the scope of the principles of the present disclosure. In particular, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

[Description of reference numerals]

| | |
|---|---|
| 10: main body | 46: rail assembly |
| 60: ice making compartment | 100: outer case |
| 200: inner case | 300: pivoting door |
| 400: drawer door | 600: partition wall |
| 700: ice maker | 800: ice storage bucket |
| 900: driver fan duct assembly | 1000: evaporator case |
| 1100: evaporator assembly | 1200: guide portion |
| 1300: thermal insulation cover | |

1. A refrigerator comprising:
a main body including an outer case and an inner case provided inside the outer case, wherein an upper part of the inner case provides an ice making compartment and a refrigerator compartment, and a lower part of the inner case provides a freezer compartment; and
a partition wall coupled to the inner case and configured to form the ice making compartment,
wherein a bead portion is formed in the inner case, and
wherein a concave portion matched with the bead portion is formed on the partition wall.

2. The refrigerator of claim 1, wherein the bead portion includes a first bead portion formed on one side of an inner surface of the inner case and a second bead portion formed on other side of the inner surface of the inner case,
wherein the concave portion includes a first concave portion formed on one side of the partition wall and a second concave portion formed on other side of the partition wall, and
wherein the first concave portion is matched with the first bead portion, and the second concave portion is matched with the second bead portion.

3. The refrigerator of claim 2, wherein a first protrusion having a first through hole is formed on one of the first bead portion and the first concave portion, and a first inlet port into which the first protrusion is inserted is formed on the other, and
wherein a second protrusion having a second through hole is formed on one of the second bead portion and the second concave portion, and a second inlet port into which the second protrusion is inserted is formed on the other.

4. The refrigerator of claim 3, wherein a space portion is provided between the outer case and the inner case,
wherein a thermal insulation material accommodating space is provided inside the partition wall, and
wherein a thermal insulation material is injected into the space portion, is injected into the thermal insulation material accommodating space through the first inlet port and the first through hole, and is injected into the thermal insulation material accommodating space through the second inlet port and the second through hole.

5. The refrigerator of claim 4, wherein the thermal insulation material is integrally foamed in the space portion and the thermal insulation material accommodating space such that the ice making compartment is partitioned as a separate thermal insulation space from the refrigerator compartment.

6. The refrigerator of claim 5, further comprising:
an entrance wall fitted and coupled to a front side of the partition wall; and
an installation wall fitted and coupled to one side and other side of the partition wall and the entrance wall,
wherein the partition wall, the entrance wall, and the installation wall that are fitted and coupled to each other are fastened to each other by a fastening member, and then are fastened to one wall and other wall of the inner case by a fastening member.

7. The refrigerator of claim 6, wherein the partition wall includes an outer partition wall and an inner partition wall, and
wherein the outer partition wall and the inner partition wall are fitted and coupled to constitute the partition wall.

8. The refrigerator of claim 6, wherein when the second bead portion and the second concave portion are matched, one side of the installation wall is interposed between the second bead portion and the second concave portion.

9. The refrigerator of claim 1, further comprising:
wherein the partition wall includes an outer partition wall and an inner partition wall,
an entrance wall disposed between the outer partition wall and the inner partition wall;
a first sealing member disposed along a front inner perimeter of the outer partition wall; and
a second sealing member disposed on an inner surface of a rear right side of the outer partition wall to elongate in an up-down direction,
wherein the inner partition wall is coupled to the outer partition wall in a state in which a front end and a rear end of the inner partition wall are in close contact with the first sealing member and the second sealing member, and
wherein the entrance wall is coupled to the outer partition wall in a state in which a rear end of the entrance wall is in close contact with the first sealing member.

10. The refrigerator of claim 9, wherein an installation wall is further coupled to the partition wall, and
wherein the refrigerator further comprises a third sealing member that is disposed on and attached to an upper surface of the installation wall, an upper surface of the partition wall, a rear surface of the partition wall, and a left side surface of the installation wall.

11. The refrigerator of claim 10, wherein the third sealing member is disposed in a state of being interposed between the partition wall and the inner case and between the installation wall and the inner case and is in close contact with an upper wall inner surface, a rear wall inner surface, and a left wall inner surface of the inner case to thereby seal a contact joint between the partition wall, the installation wall, and the inner case that are coupled to each other.

12. The refrigerator of claim 11, wherein the first sealing member, the second sealing member, and the third sealing member are made of a sponge.
